(19) United States
(12) Patent Application Publication
(10) Pub. No.: US 2023/0086191 A1
(43) Pub. Date: Mar. 23, 2023

(54) Systems and Methods for Token Content Unlocking, Biometric Authentication using Privacy-Protecting Tokens, Ownership-Based Limitations of Content Access, Policy-Based Time Capsule Technology, and Content Lock Mechanisms

(71) Applicant: Artema Labs, Inc, Los Angeles, CA (US)

(72) Inventor: Bjorn Markus Jakobsson, Portola Valley, CA (US)

(73) Assignee: Artema Labs, Inc, Los Angeles, CA (US)

(21) Appl. No.: 17/933,659

(22) Filed: Sep. 20, 2022

Related U.S. Application Data
(60) Provisional application No. 63/365,268, filed on May 24, 2022.
(60) Provisional application No. 63/305,998, filed on Feb. 2, 2022.
(60) Provisional application No. 63/283,330, filed on Nov. 26, 2021.
(60) Provisional application No. 63/273,921, filed on Oct. 30, 2021.
(60) Provisional application No. 63/245,976, filed on Sep. 20, 2021.

(51) Int. Cl. G06Q 20/36; G06Q 20/40; H04L 9/08

(52) U.S. Cl. CPC G06Q 20/3672; G06Q 20/401; H04L 9/0866; G06Q 2220/00; H04L 2209/56

(57) ABSTRACT

Non-fungible token (NFT) platforms in accordance with various embodiments of the invention are described. In an embodiment of the NFT includes receiving, at a server system, a notification request associated with at least one NFT from a user device, the notification request including a label data-field and an address data field, determining an occurrence of at least one event associated with the NFT that is recorded on a blockchain, obtaining a record associated with the notification request based on the label data-field, the record stored in a repository and including data to unlock at least one content portion several content portions of the NFT, generating a notification using the address data field included in the notification request, the notification including the data to unlock the at least one content portion of the NFT, and transmitting, based on the address data field, the notification to at least one device.

### CROSS-REFERENCE TO RELATED APPLICATION

This application claims benefit of and priority under 35 U.S.C. 119(e) to U.S. Provisional Patent Application No. 63/245,976, entitled “Token Content Unlocking Method” by Jakobsson, filed Sep. 20, 2021, U.S. Provisional Patent Application No. 63/273,921, entitled “Biometric Authentication using Privacy-Protecting Tokens” by Jakobsson, filed Oct. 30, 2021, U.S. Provisional Patent Application No. 63/283,330, entitled “Ownership-Based Limitations of Content Access” by Jakobsson, filed Nov. 26, 2021, U.S. Provisional Patent Application No. 63/305,998, entitled “Policy-Based Time Capsule Technology” by Jakobsson, filed Feb. 2, 2022, and U.S. Provisional Patent Application No. 63/365,268, entitled “Content Lock Mechanism” by Jakobsson, filed May 24, 2022, the disclosures of which are hereby incorporated by reference in their entirety for all purposes.

### FIELD OF THE INVENTION

This invention relates to tokens including non-fungible tokens (NFTs) in distributed and tokenized environments.

### BACKGROUND

The emergence of Non-Fungible Token (NFT) marketplaces has allowed content creators (e.g., artists, musicians, among others) to reach buyers. However, current systems do not enable the full potential for the marketplaces. For one thing, current marketplaces may allow only purchases of static artwork. Furthermore, the trading of NFTs is becoming increasingly common. In particular, an NFT may be used for assigning a digital representation of ownership for digital items, such as images, but also other physical items. A current holder of an NFT is typically provided asset usage rights for the underlying NFT asset. Different NFTs may be associated with different values, where some tokens may be associated with very high values and some tokens may be associated with more moderate value. Furthermore, as NFTs become increasingly complex, it can be increasingly difficult for content producers to understand, control and anticipate expressed functionality.

### SUMMARY OF THE INVENTION

Systems and methods for providing security features in distributed and tokenized environments in accordance with various embodiments of the invention are described. One embodiments includes a method of processing non-fungible tokens (NFTs) in an NFT platform, including: receiving, at a server system, a notification request associated with at least one NFT from a user device, the notification request includes a label data-field and an address data field; determining an occurrence of at least one event associated with the NFT that is recorded on a blockchain; obtaining a record associated with the notification request based on the label data-field, the record stored in a repository and includes data to unlock at least one content portion of a plurality of content portions of the NFT; generating a notification using the address data field comprised in the notification request, the notification includes the data to unlock the at least one content portion of the NFT; and transmitting, based on the address data field, the notification to at least one device.

In a further embodiment, the data is at least one data selected from the group consisting of: a symmetric key, a private key, and a decryption key associated with an encryption key.

In a further embodiment, the data to unlock the at least one content portion comprises data used to decrypt the at least one content portion.

In a further embodiment, the data to unlock the at least one content portion comprises an access token for verification.

In a further embodiment, the access token comprises a digital signature.

In a further embodiment, further includes receiving an automated payment based on a smart contract associated with the NFT.

In a further embodiment, the repository uses blockchain to store notification requests.

In a further embodiment, the notification request comprises a conditional payment.

In a further embodiment, the notification request comprises a smart contract.

In a further embodiment, the NFT includes a plurality of content portions, each content portion having an access setting from a plurality of accessing settings, wherein the plurality of access settings include a locked content portion and an unlocked content portion.

In a further embodiment, the access settings are determined based on a user specified policy associated with the NFT.

In a further embodiment, the label data field is at least one data selected from the group consisting of a public key, a hash image of a private value, and a unique identifier.

An embodiment includes an event notification service where a first party requests a notification related to a token, includes a second party that performs the actions of: determining at least one event that is recorded on a blockchain; accessing a repository includes a multiplicity of notification requests using the at least one event as a search term; receiving a record corresponding to the notification request in response to the access; and generating a notification to an address comprised in the notification request, the notification includes data associated with the at least one event, said data being usable to unlock content associated with the token.

An embodiment includes a non-fungible token (NFT) platform for processing biometric inputs in a distributed computing environment, includes: a network interface; memory; and at least one processor executing on at least one computing unit from a plurality of computing units in a distributed computing environment, wherein a processor is configured to: receive a biometric input with a plurality of aspects; generate an array B with the plurality of aspects; obtain an encrypted mask array C from a biometric token; combine the encrypted mask array C with the array B to generate an encrypted result that is an encrypted function of the biometric input and is an encryption of a masked version of array B; transmit the encrypted result to at least one computing entity that decrypts the encrypted result and generates a response; receive the response from the at least one computing entity; and perform an action based on the response.

In a further embodiment, an action includes at least one action selected from the group consisting of: generate a key from the response and decrypt the biometric token, unlock a device, decrypt an encrypted log file, perform a login based on the response, decrypt a ciphertext associated with the biometric token, use the response to decrypt an encrypted key X to generate the key X, and determine a mask value.

In a further embodiment, generating the encrypted mask C comprises determining a mask M that selects robust entries of the array B by selecting a first mask value with a first ciphertext and suppress non-robust entries of the array B by selecting a second mask value with a second ciphertext.

In a further embodiment, the first ciphertext is an ElGamal encryption of a representation of the first mask value.

In a further embodiment, the first ciphertext and the second ciphertext are stored in a non-fungible token (NFT).

In a further embodiment, the combining includes performing item-wise modifications of elements of the encrypted mask array C using items of array B resulting in the encryption of the masked version of array B.

An embodiment includes a system for processing biometric inputs, includes: receiving a first biometric input; determining, based on the first biometric input, at least a first mask value and a second mask value; representing the first mask value with a first ciphertext; representing the second mask value with a second ciphertext; causing the first ciphertext and the second ciphertext to be stored; receiving a second biometric input; generating a validator based on the first ciphertext, the second ciphertext and the second biometric input; conditional on validator, perform an action.

In a further embodiment, the first ciphertext is an ElGamal encryption of a representation of the first mask value.

In a further embodiment, the ElGamal encryption uses modular arithmetic.

In a further embodiment, the ElGamal encryption uses elliptic curve cryptography.

In a further embodiment, the first ciphertext and the second ciphertext are stored in a token.

In a further embodiment, the token is a non-fungible token (NFT).

In a further embodiment, the second biometric input is received by a wallet executing on a client device.

In a further embodiment, the validator includes the first ciphertext modified by a first biometric value and the second ciphertext modified by a second biometric value.

In a further embodiment, the first biometric value represents a classification generated based on comparing a function of the second biometric input with at least a first threshold value.

In a further embodiment, the second biometric value represents a classification generated based on comparing a function of the second biometric input with at least a second threshold value.

In a further embodiment, the modification of the first ciphertext corresponds to exponentiating the first ciphertext with the first biometric value.

In a further embodiment, the validator is decrypted.

In a further embodiment, the decrypted validator is used to determine a cryptographic key.

In a further embodiment, the cryptographic key is a symmetric key

In a further embodiment, the cryptographic key is an asymmetric key.

In a further embodiment, the cryptographic key is used to perform the action.

In a further embodiment, the action is the decryption of encrypted data stored in a token.

In a further embodiment, the token is a non-fungible token (NFT).

In a further embodiment, the action is a login.

In a further embodiment, the action is the determination of at least one of the first mask value and the second mask value.

In a further embodiment, the action is the decryption of an encrypted log file.

In a further embodiment, the action includes the unlocking of a device.

In a further embodiment, the device is at least one of a laptop, a desktop, a phone, a tablet and a wearable device.

An embodiment includes a non-fungible token (NFT) platform providing digital rights management for content associated with tokens in a distributed computing environment, includes: a network interface; memory; and at least one processor executing on at least one computing unit from a plurality of computing units in a distributed computing environment, wherein at least one processor is configured to: receive a request for content associated with at least one policy set for at least one NFT; filter the request based on the at least one policy; determine an action from a plurality of actions based on the filtering, wherein a first action from the plurality of actions includes blocking the request for content and a second action from the plurality of actions includes allowing access to the content.

In a further embodiment, a third action from the plurality of actions includes updating the policy associated with the at least one NFT.

In a further embodiment, the policy includes a plurality of rules, wherein at least one rule from the plurality of rules is selected from the group consisting of a heuristic rule, a reference to a whitelist specifying unblocked elements, a reference to a blocklist specifying blocked elements, a reference to an access control list (ACL), and a reference to a token.

In a further embodiment, the at least one computing unit is a computing unit selected from the group consisting of a digital wallet on a user device, a component of an operating system, a component of a web-browser, a web-browser plugin, a search engine, a hosting service, and an application.

In a further embodiment, a third action from the plurality of actions includes transmitting feedback to at least one computational unit that updates settings associated with the filter and the at least one policy.

In a further embodiment, a fourth action from the plurality of actions includes associated the content with a notification.

An embodiment includes a non-fungible token (NFT) platform providing digital rights management for content associated with tokens in a distributed computing environment, includes: a network interface; memory; and at least one processor executing on at least one computing unit from a plurality of computing units in a distributed computing environment and configured to: receive a request for content associated with at least one non-fungible token (NFT); access a release record associated with the at least one NFT, the release record includes a plurality of data-fields with data including a first data-field includes a first ciphertext associated with a decryption key and a plaintext content element, a second data-field includes a second ciphertext that includes in obfuscated format the decryption key for the first ciphertext, a third data-field includes data regarding a recipient designator, a fourth data-field includes data providing a service provider identifier and a fifth data-field includes data regarding at least one trigger condition associated with a policy for the NFT; detect occurrence of the at least one trigger condition associated with the at least one NFT based on data from the fifth data-field regarding the at least one triggering condition; and generate an output based on data from the second data-field indicating the decryption key and data in the third data field indicating designation of the recipient.

In a further embodiment, the first ciphertext is generated from, and includes in obfuscated format, the content element.

In a further embodiment, the plaintext content element is generated from the first ciphertext using the decryption key.

In a further embodiment, the second ciphertext is generated from and includes in obfuscated format, the decryption key for the first ciphertext.

In a further embodiment, the decryption key for the first ciphertext is generated from the second ciphertext using a private key associated with the service provider indicated by the fourth data-field data.

In a further embodiment, the policy sets conditions on when the service provider indicated by the service provider identifier in the fourth data-field is to process the second ciphertext to facilitate access to the decryption key for the first ciphertext to at least one user associated with the data from the fourth data-field regarding the recipient designator.

In a further embodiment, the release record includes a sixth data-field includes proof data providing proof of knowledge of the second ciphertext that is publicly verifiable.

In a further embodiment, the proof data is generated using a digital signature process.

In a further embodiment, the output is decrypted using a private key corresponding to the recipient to yield the decryption key.

In a further embodiment, the output includes the decryption key.

In a further embodiment, the output includes the decryption key encrypted using the second data-field.

In a further embodiment, the decryption key is a symmetric key.

In a further embodiment, the decryption key is an asymmetric key.

In a further embodiment, the service provider is a distributed party.

In a further embodiment, the service provider uses (k,n) secret sharing to determine shares of the private key corresponding to the fourth data-field.

In a further embodiment, the plaintext data content is content selected from the group consisting of: text, an audio element, a video element, a token, and a script.

In a further embodiment, the token represents the ability to transfer funds.

In a further embodiment, the plaintext content element is associated with an indication of origination that references a biometric element includes a token associated with a physical person.

An embodiment includes a method for processing a release record, includes: receiving a release record, the release record includes first data indicating a ciphertext associated with a decryption key and a plaintext content element, second data indicating designation of a recipient, third data indicating the decryption key and the designation of the recipient, fourth data indicating a service provider, fifth data indicating a triggering condition, accessing the fifth data; determining a triggering condition being satisfied based on the fifth data; and generating an output that is based on the second data and the third data.

An embodiment includes a method for transferring ownership of a token, the token being associated with a compliance statement, the compliance statement of the token specifying constraint(s) on a platform or marketplace involved in the transfer of ownership of the token, the method includes: determining the constraint(s) specified in the compliance statement of the token, fulfilling the determined constraint(s), and performing the transfer of ownership of the token only when the determined constraint(s) have been fulfilled.

In a further embodiment, the determining of the constraint(s) includes one or more of identifying the constraint(s) in a policy that is referenced by the token, or which may be comprised in the token, accessing code in contract data of the token, or in meta-data associated with the token.

In a further embodiment, the constraints are one or more of: a royalty requirement that indicates that only marketplaces that are in compliance, or fulfill the constraints may transfer ownership of the token by collecting and/or paying the due royalty, a Terms of Service (ToS) requirement that indicates that only marketplaces that are in compliance may transfer ownership of the token by fulfilling the ToS, a tax collecting requirement that indicates that only marketplaces that collect and/or report appropriate taxes, such as sales taxes may transfer the ownership of the token after collecting any current and prior taxes due.

In a further embodiment, fulfilling the determined constraint(s) includes one or more of paying a required royalty, paying any previously omitted fees and/or royalties, ascertaining that the ToS is agreed upon by the parties involved, obtaining an verification from a seller of the token that the prior use of the token has respected the ToS, collecting taxes due to the transfer of the ownership of the token and/or due to previous action(s) wherein due taxes were not paid.

In a further embodiment, further includes receiving a complaint associated with a token, where such a complaint provides an indication or some evidence of use of the token that is in breach with terms of service, and blocking the performing of the transfer of ownership of the token until the complaint has been resolved.

In a further embodiment, the blocking of the performing of the transfer of ownership of the token includes one or more of: (a) overwriting a URL in the token to a dummy value, (b) recording the token in a database of blocked tokens, which database can only be edited by certified entities, the database being accessible to everyone, (c) updating a dedicated field in the token identifying the token as not eligible for trading, (d) informing a creator of the token enabling the creator to block access to a website to which the token gives access, (e) informing an appropriate authority of the evidence of use of the token that is in breach with terms of service, (f) updating a list accessible to marketplaces with an entry that the token is blocked, thereby enabling any platform or marketplace to check the list before engaging in any trading of the token, the entry only being editable by the platform or marketplace that created the entry, (g) transferring ownership of the token to an entity, the entity being obliged to return the ownership of the token once any remedy or penalty for the use of the token that is in breach with terms of service have been settled.

An embodiment includes a method for transferring ownership of a token, the token being associated with a compliance statement, the compliance statement of the token specifying constraints on a platform or marketplace involved in the transfer of ownership of the token, the method includes: receiving a sell order or transfer request of the token from a seller, the sell order identifying the token to be sold, processing the order or transfer request with compliance, wherein the processing provides the constraints on the platform or marketplace, and triggering or performing the transfer of ownership of the token without regarding the constraints on the platform or marketplace.

An embodiment includes a method performed by a device for transferring ownership of a digital asset, the method includes: receiving a request for the transfer of ownership of the digital asset, the request being associated with a transfer agreement, the transfer agreement includes at least two public keys identifying individual entities such as marketplaces or third parties, being authorized to perform the transfer of ownership of the digital asset, and when the device is an authorized entity to perform the transfer: performing the transfer of the digital asset using a private key associated with the public key.

In a further embodiment, the entities being authorized are previously selected by (a) a seller of the digital asset, (b) a buyer of the digital asset, or (c) both a seller and a buyer of the digital asset.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permission-less blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention.

FIGS. 10-12 depicts various devices that can be utilized alongside an NFT platform in accordance with various embodiments of the invention.

FIG. 13 depicts a media wallet application configuration in accordance with an embodiment of the invention.

FIGS. 14A-14C depicts user interfaces of various media wallet applications in accordance with a number of embodiments of the invention.

FIG. 15 illustrates an NFT ledger entry corresponding to an NFT identifier.

FIGS. 16A-16B illustrate an NFT arrangement relationship with corresponding physical content in accordance with an embodiment of the invention.

FIG. 17 illustrates a process for establishing a relationship between an NFT and corresponding physical content.

FIG. 18 illustrates a token with lock access in accordance with an embodiment of the invention.

FIG. 19 illustrates a notification request in accordance with an embodiment of the invention.

FIG. 20 illustrates a notification transmitted by a sender to a recipient associated with an address in accordance with an embodiment of the invention.

FIG. 21 illustrates a process of encrypting biometric data in accordance with an embodiment of the invention.

FIG. 22 illustrates generation of encrypted mask arrays in accordance with an embodiment of the invention.

FIG. 23 illustrates an architecture of a client device in accordance with an embodiment of the invention.

FIG. 24 illustrates a process of generating an array using biometric input in accordance with an embodiment of the invention.

FIG. 25 illustrates generation of an array from a biometric input in accordance with an embodiment of the invention.

FIG. 26 illustrates masking of an array in accordance with an embodiment of the invention.

FIG. 27 illustrates a process of authentication using biometric tokens in accordance with an embodiment of the invention.

FIG. 28 illustrates a process of determining whether to enable or block content rendering in accordance with an embodiment of the invention.

FIG. 29 illustrates an architecture of an NFT security platform in accordance with an embodiment of the invention.

FIG. 30 illustrates a release record in accordance in accordance with an embodiment of the invention.

FIG. 31 illustrates a process of encryption using ciphertexts by a service provider in accordance with an embodiment of the invention.

FIG. 32 illustrates a process of authenticating a transaction in accordance with an embodiment of the invention.

FIG. 33 illustrates a process of using a public key executing on multiple devices in accordance with an embodiment of the invention.

FIG. 34 illustrates a process of transferring ownership of a token associated with a compliance state in accordance with an embodiment of the invention.

FIG. 35 illustrates a process of processing a transaction that is transferring ownership of a token associated with a compliance statement where the compliance statement of the token includes constraints on a platform involved in the transfer of ownership of the token.

FIG. 36 illustrates a process of transferring a digital asset in accordance with an embodiment of the invention.

FIG. 37 illustrates a system architecture of a device that performs transactions on tokens associated with compliance statements in accordance with an embodiment of the invention.

### DETAILED DESCRIPTION

Turning now to the drawings, systems and methods for implementing blockchain-based Non-Fungible Token (NFT) that can generate conditional tokens in accordance with various embodiments of the invention are illustrated. In several embodiments, a blockchain-based NFT security platform is provided that generates NFTs that enable content creators to issue, mint, and/or transfer NFTs that can include content that can have different security features, including locked and unlocked content, based on different triggering events.

In a number of embodiments, content creators can issue evolving NFTs to users within the NFT evolution platforms. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFT security platforms in accordance with many embodiments of the invention generate tokens that include security features that provides conditional locking/unlocking of content based on triggering events, among numerous security features that protect content from unauthorized access. Conditional locking/unlocking of content can be beneficial for many different users and applications, including, for example, artists and other creative content developers, who may wish to distribute a token with a first functionality to a large number of users, e.g., by renting out the token and/or providing it for free, and when a given condition is satisfied (e.g., a user purchases a token), an author of the content may wish for additional content associated with the token to be accessible to a user in possession of the token, providing an evolving token functionality that can provide different features for different triggering events (e.g., high resolution content, different content, among many other features).

In many embodiments of NFT security platforms, tokens can be generated that include conditional security features within the tokens by partitioning content for a token into different portions, where access to a particular portion of content can be governed by a policy associated with that portion. Different portions of content can provide different accessibility rights, including private portions that may not be accessible, and may become accessible by for example, a triggering event and public portions that can be visible. Different policy conditions can be specified for different portions of the content, including accessibility conditions that includes whether content can be read, edited, requiring that content be read within a particular environment, providing access to content based at a particular date, among various other policies that can be specified by users as appropriate to the requirements of different applications in accordance with embodiments of the invention.

In particular, NFT security platforms can generate NFTs with different content portions, with each content portion can be associated with a particular policy that can provide limitations on accessibility to the content portion. As such, an NFT can include N content portions with 0 to N (or more) different content policies that determine access to a corresponding content portion, where for example, a first content portion may specify a policy that it may be permissible to be read by a party with access to the NFT, corresponding to an absence of a limiting policy.

NFT security platforms in accordance with many embodiments of the invention can include biometric authentication with remote authentication using cryptographic keys, where cryptographic keys can be derived from data stored in biometric tokens. In several embodiments, cryptographic keys can be derived from data provided by biometric inputs. NFT security platforms in accordance with many embodiments of the invention can use of cryptographic keys to minimize various security risks, including in particular, risks associated with brute-force attacks where attackers may have access to tokens among other types of attacks.

NFT security platforms in accordance with several embodiments of the invention can utilize throttling which can be useful in situations that use low-entropy biometrics. NFT security platforms in accordance with many embodiments of the invention can use biometric authentication that is robust against potential fuzziness associated with measured biometric data, including modifications, losses and/or distortions to biometric data. In many embodiments of the NFT platforms, an array (e.g., array B) of biometric measurements can be generated that can be derived from a biometric input, where elements of the array can be derived using techniques that can minimize fuzziness.

NFT security platforms in accordance with many embodiments of the invention can use masks for selection, including to address fuzziness for dimensions where there may be a weak signal, as certain techniques may not address fuzziness for dimensions where there may be a weak signal. NFT security platforms in accordance with many embodiments of the invention can secure masks (e.g., encrypt masks among other security measures) to avoid exposure of a mask using encrypted masking processes. In particular, efficient processing of an encrypted contents can be difficult. Accordingly, the use of encrypted masks can provide protection of data that would otherwise, if exposed, help attackers perform illegal activities (e.g., brute-force attacks), which can be a risk associated with distributed settings. Accordingly, NFT security platforms in accordance with many embodiments of the invention can use biometric authentication in distributed settings providing many benefits for token-based applications and corresponding distributed settings.

In many embodiments, NFT security platforms can generate filters that perform digital rights management of content, including legacy content and new content, based on detection of known protected assets. NFT security platforms in accordance with many embodiments of the invention can generate filters that may be part of client-side applications (e.g., web browser), and/or be part of server-side infrastructure (e.g., as part of code in a search engine, social network, among other applications). NFT security platforms in accordance with many embodiments of the invention can work with compliant applications to limit access to proprietary content (e.g., content that has not been listed as being public). NFT security platforms can generate filters that limit content that does not match filtering terms, which can identify content that is not acceptable to be rendered for various reasons, including private, illegal, immoral, out of compliance, unsafe, among various other categories of unacceptable content.

In several embodiments, NFT security platforms can provide entities and/or users with the ability to set filtering terms for filters. Entities can include for example, a jurisdiction, a company, a family, a resolution made by a user, among others. NFT security platforms in accordance with many embodiments of the invention can utilize a combination of different processes, including using filters along with whitelist/blacklist databases, among other processes to determine a status of content (e.g., content is public vs. private and/or including whether content is acceptable, among other determinations).

In certain embodiments, NFT security platforms can include security features that can suppress the use of screen shots and/or recording of digital information using compliant processes. In particular, a bad actor wishing to circumvent protections (e.g., by filming a screen, taking a screenshot etc.), may have content having a degradation of quality.

NFT security platforms in accordance with many embodiments of the invention can generate compliance statements that can take the form of certificates, where a party with access to a private key associated with a compliance statement can be able to perform a particular action associated with the private key, and where a party without access to such a private key is unable to perform the particular action. Parties with access to private key can be referred to as parties in compliance.

In many embodiments, NFT security platforms can associate tokens with compliance statement which can thereby associate a requirement and/or constraint with the token. In many embodiments of the NFT security platforms, tokens can be generated and utilized that can reference a policy and requirements can be identified within the policy. A token can include a policy and/or may reference a policy external to the token. Requirements can be expressed by encoding the requirement in contract data of a token. In certain embodiments of the NFT security platforms, requirements can be encoded in meta-data associated with a token. Requirements can include various different types of rules that can be specified by users. For example, requirements can include royalty requirements that indicate that marketplaces that are inv compliance and/or fulfill various constraints may transfer ownership of a token. NFT security platforms in accordance with many embodiments of the invention can generate tokens that set out requirements that can include a terms of service (ToS) requirement that indicates that only marketplaces that are in compliance may transfer ownership of a token. Requirements can specify that transactions may be performed after parties have verified that the prior use of a token has respected the terms of service.

### Non-Fungible Token (NFT) Platforms

Turning now to the drawings, systems and methods for implementing blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators can issue NFTs to users within the NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFTs minted using NFT platforms in accordance with various embodiments of the invention can have multifunctional programmable use cases including rewards, private access to premium content and experiences, as discounts toward the purchase of goods, among many other value-added use cases.

In many embodiments, each NFT can have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs can be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In many embodiments, the NFT platform can include media wallet applications that enable users to securely store NFTs and/or other tokens on their devices. Furthermore, media wallets (also referred to as “digital wallets”) can enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users can download and install media wallet applications to store NFTs on the same computing devices used to consume streamed and/or downloaded content. Media wallet applications and NFTs can disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

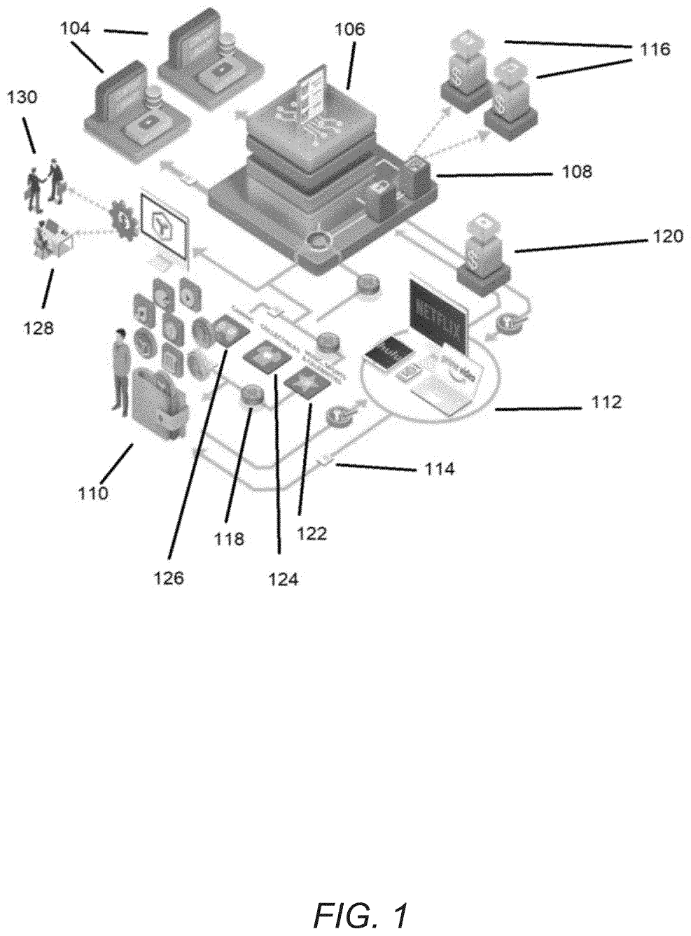

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users can be content creators that are vetted by an administrator of networks that may be responsible for deploying and maintaining the NFT blockchain. Once the NFTs are minted, users can obtain and conduct transactions with the NFTs. In several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens can be fully converted into fiat currency and/or other cryptocurrency. In several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users. In addition, content creators can directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the user. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications can request authentication of the NFT directly based upon the public key of the content creator and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platforms Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain can be in the form of distributed ledgers, while the blockchain may alternatively be centralized in a single entity.

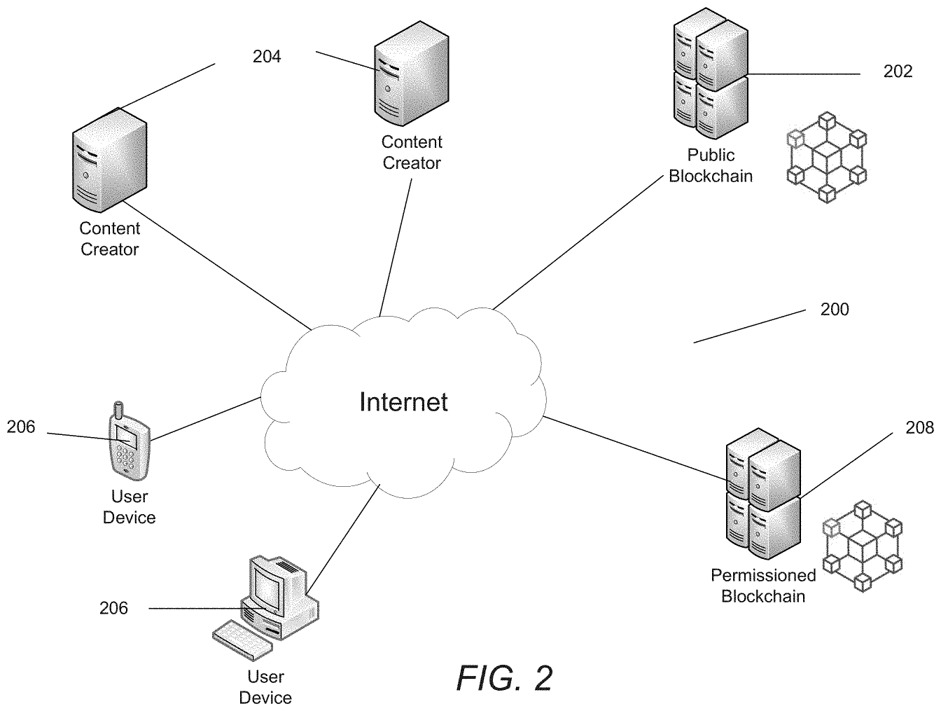

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data can be accessed by the media wallet application. In this way, users control access to entries in the permissioned blockchain 208 describing the user's NFT transaction. In several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users can utilize a media wallet application to modify permissions granted by way of the access control list. In many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In several embodiments, the access to the data is determined by computer systems that implement permission-based data access services.

In many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

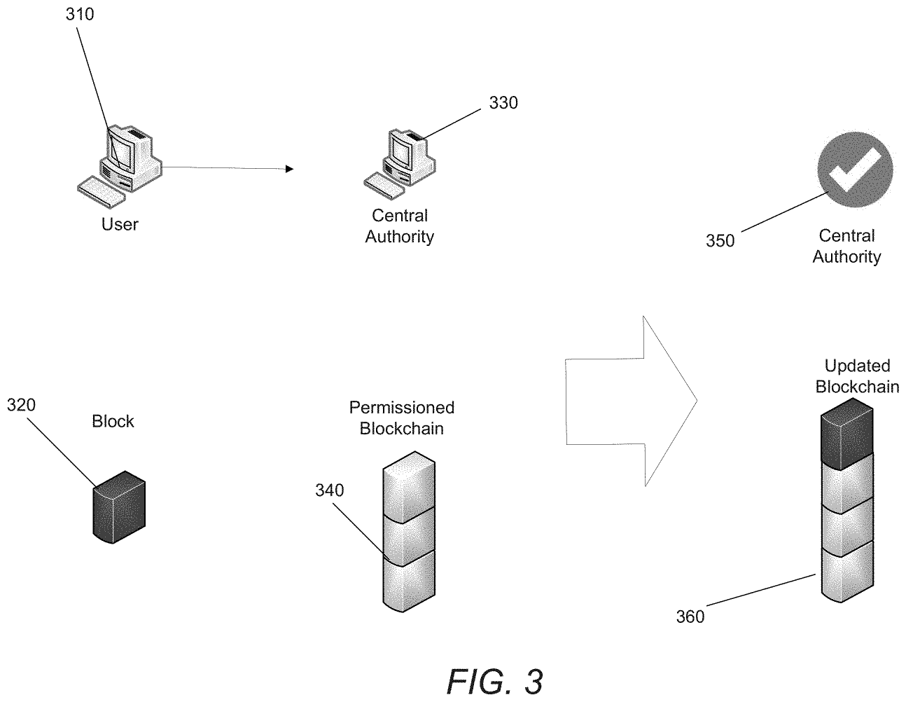

An implementation of permissioned (or private) blockchains in accordance with some embodiments of the invention is illustrated in FIG. 3. Permissioned blockchains 340 can typically function as closed computing systems in which each participant is well defined. In several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

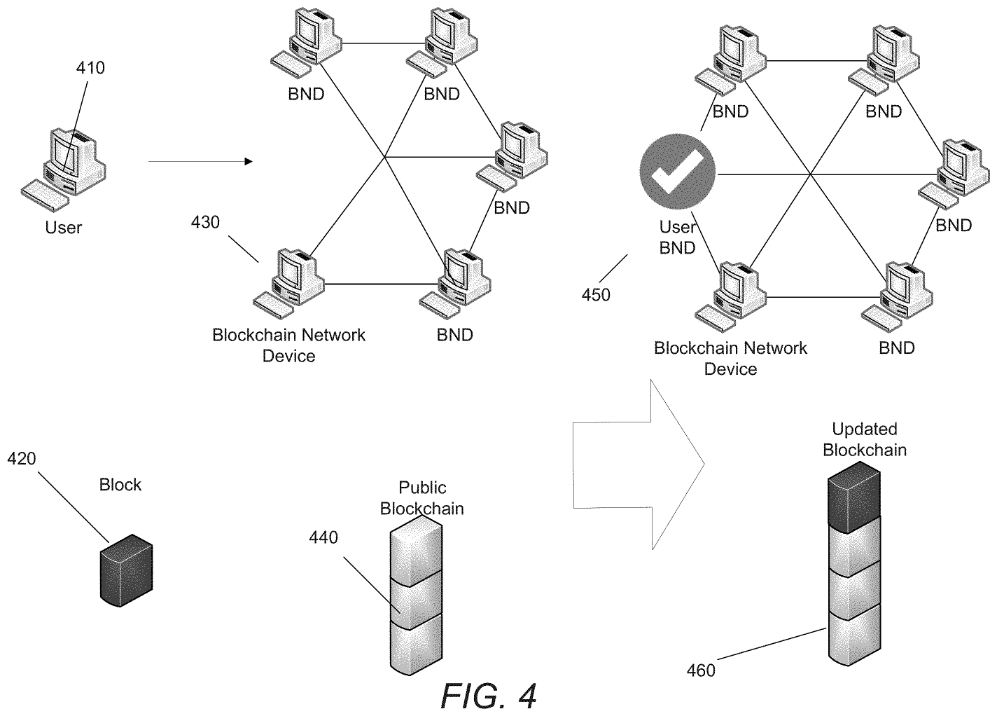

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

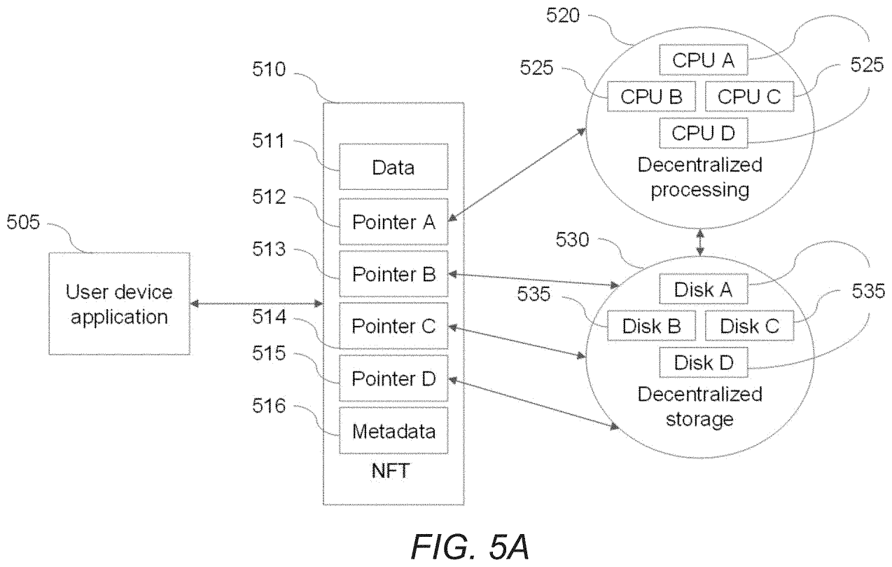

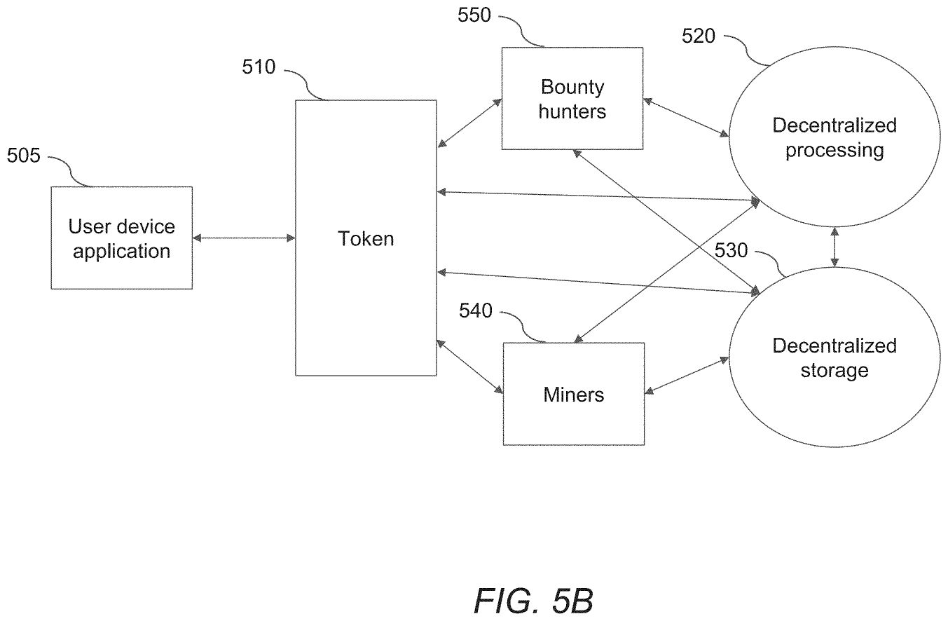

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platforms Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

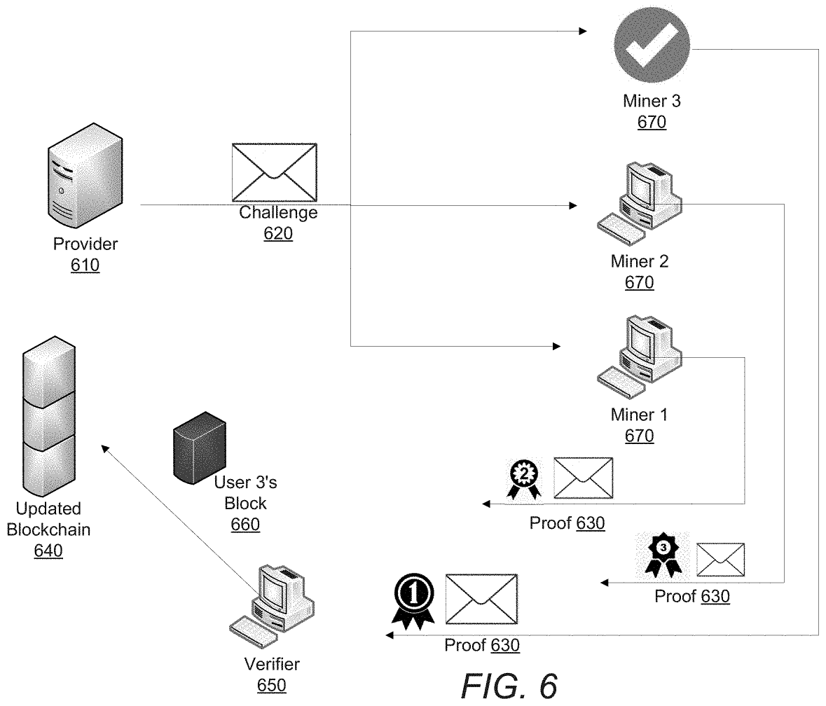

An example of Proof of Work consensus mechanisms that may be implemented in decentralized blockchains, in accordance with a number of embodiments of the invention, is conceptually illustrated in FIG. 6. The example disclosed in this figure is a challenge—response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

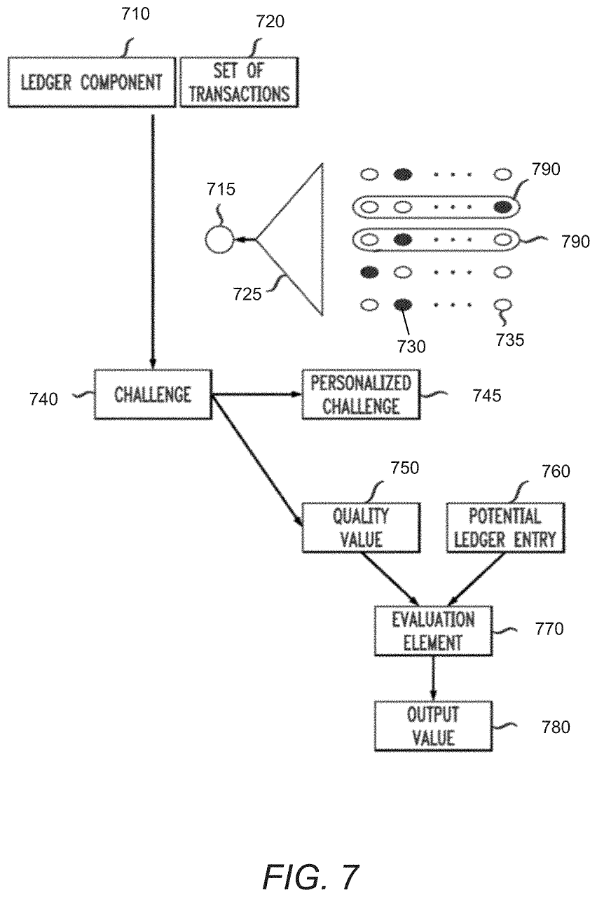

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 can also correspond to public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

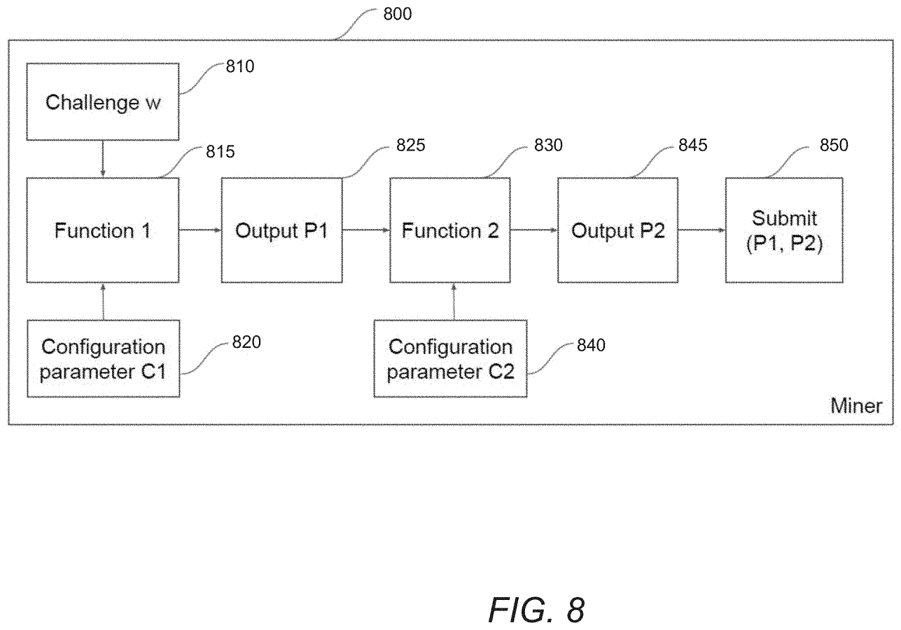

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

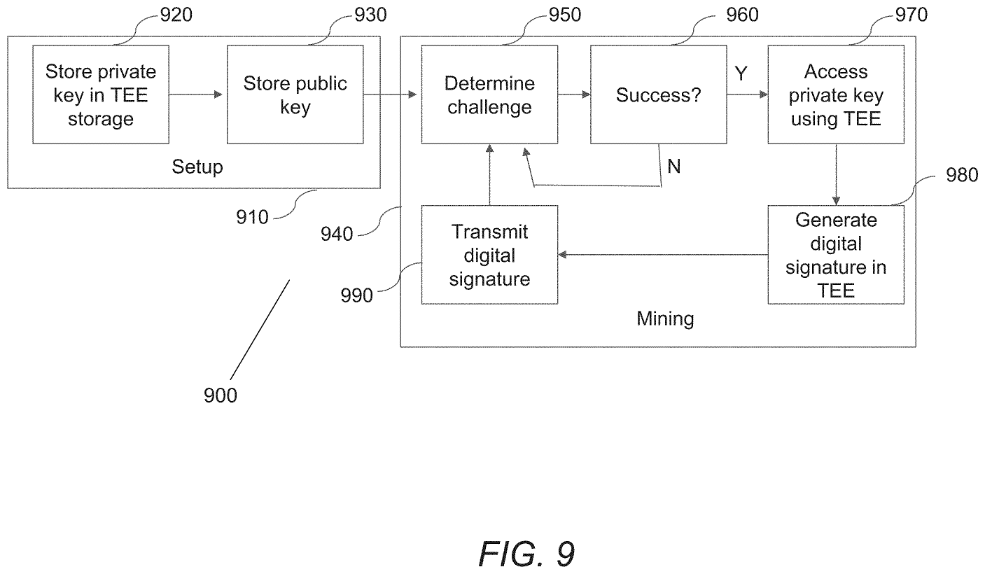

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

NFT Platforms Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

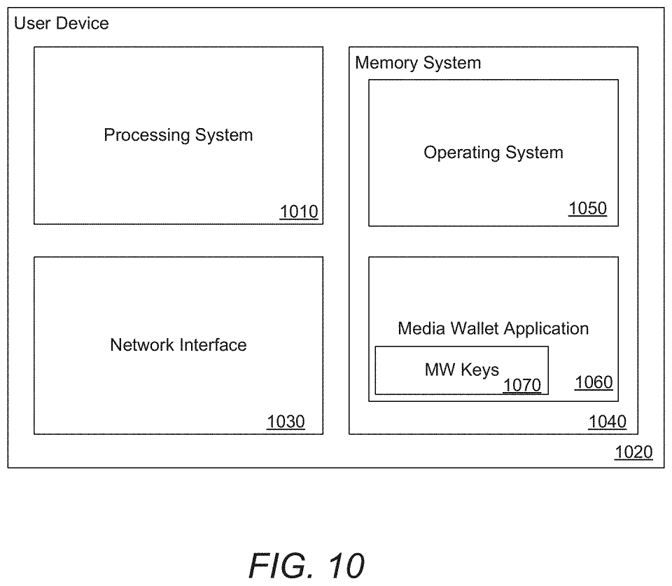

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

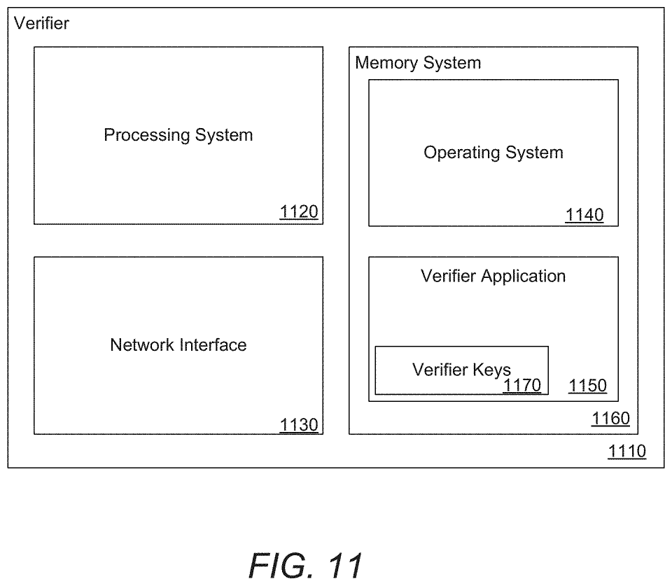

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

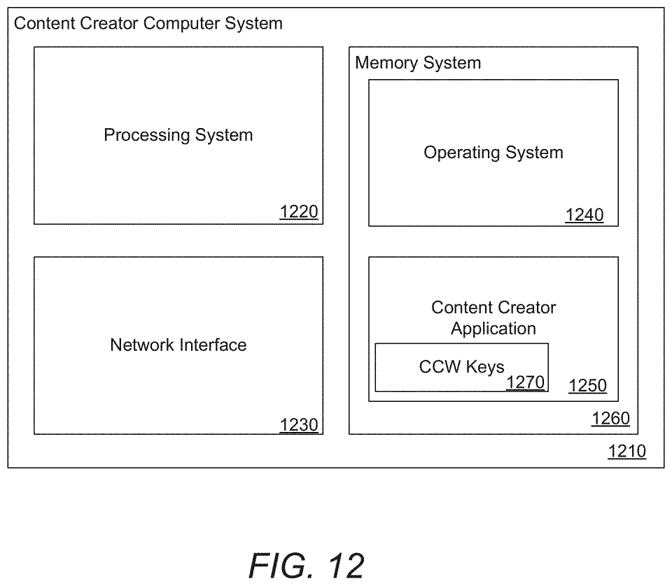

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

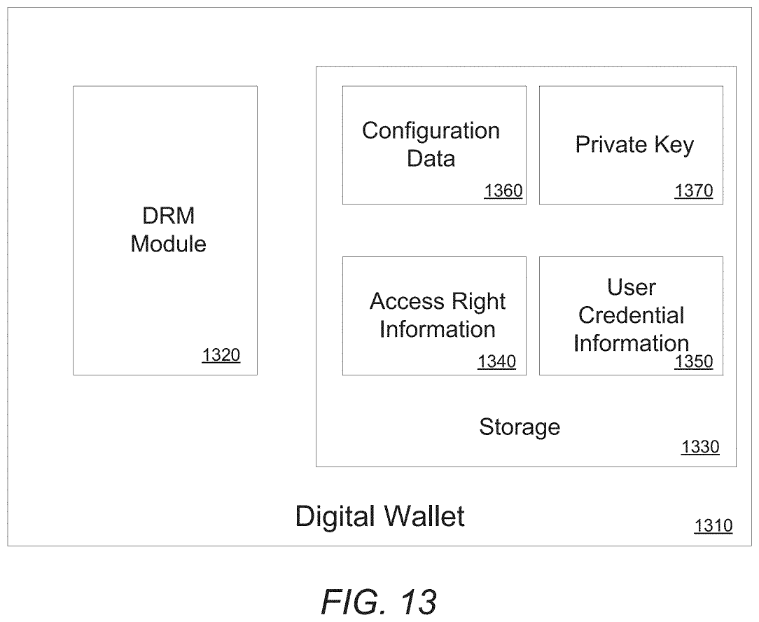

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

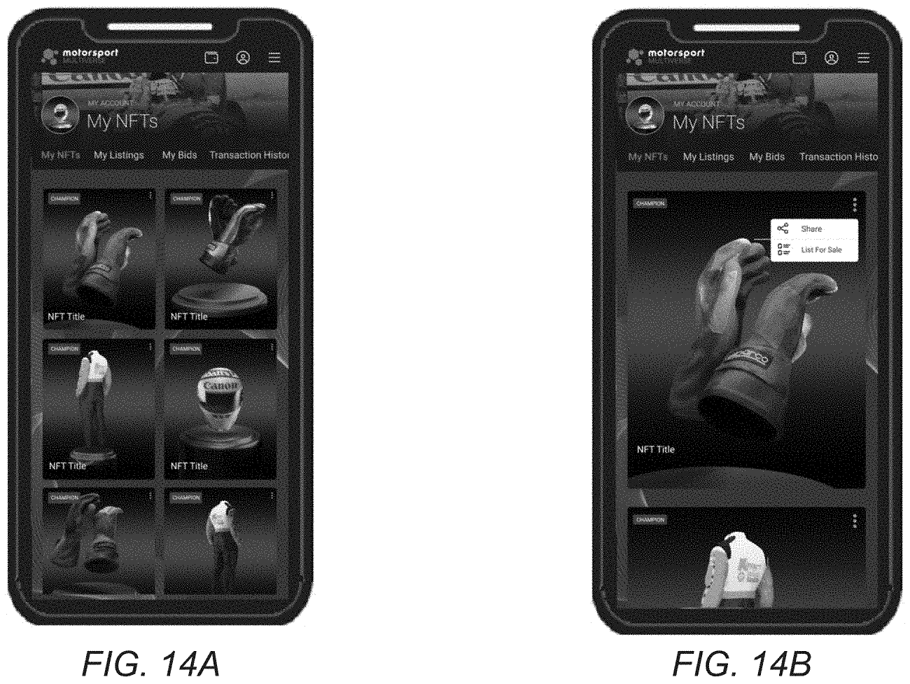

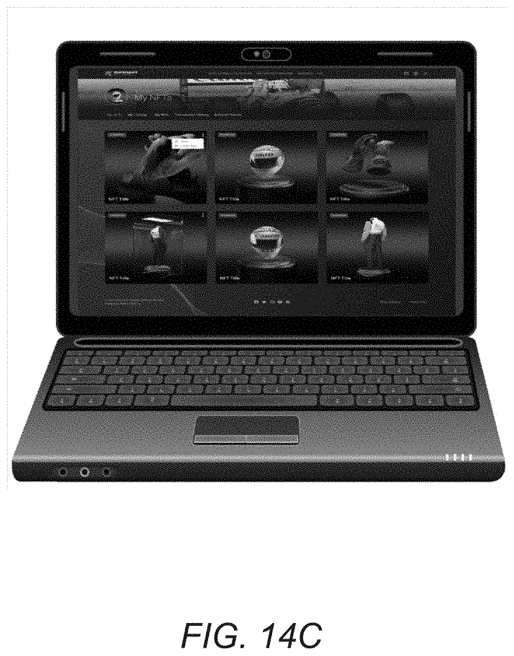

Operation of media wallet applications implemented in accordance with some embodiments of the invention is conceptually illustrated by way of the user interfaces shown in FIGS. 14A-14C. In many embodiments, media wallet applications can refer to applications that are installed upon user devices such as (but not limited to) mobile phones and tablet computers running the iOS, Android and/or similar operating systems. Launching media wallet applications can provide a number of user interface contexts. In many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In several embodiments, a first user interface context is a dashboard (see, FIGS. 14A, 14C) that can include a gallery view of NFTs owned by the user. In several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14C can be utilized within any of the NFT platforms described above.

### NFT Platforms NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

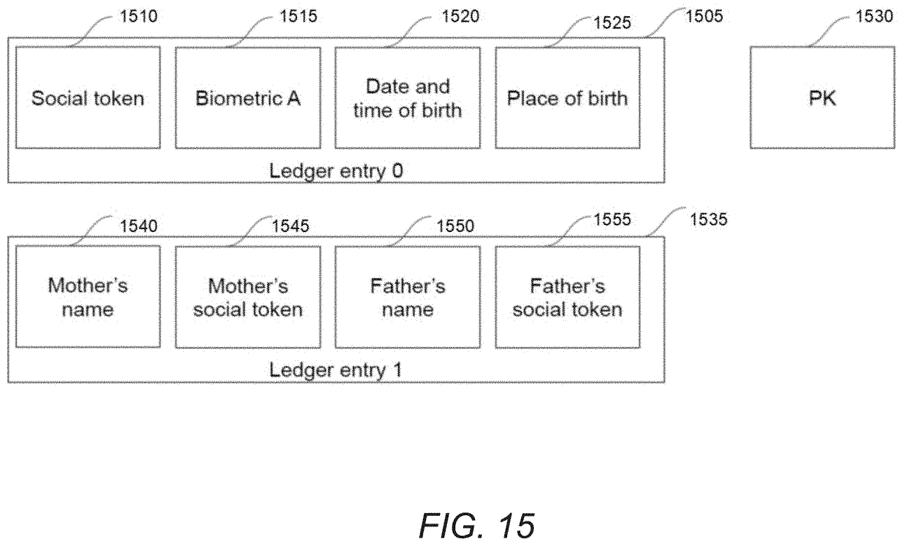

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

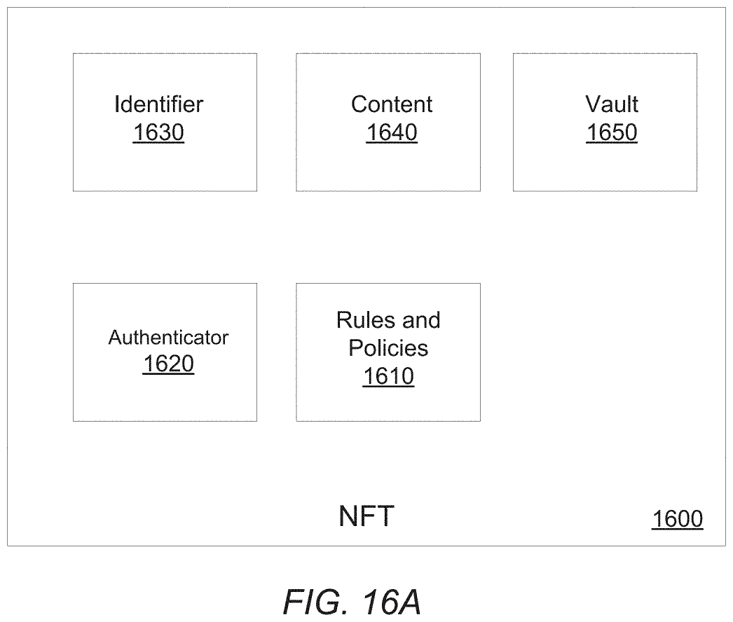

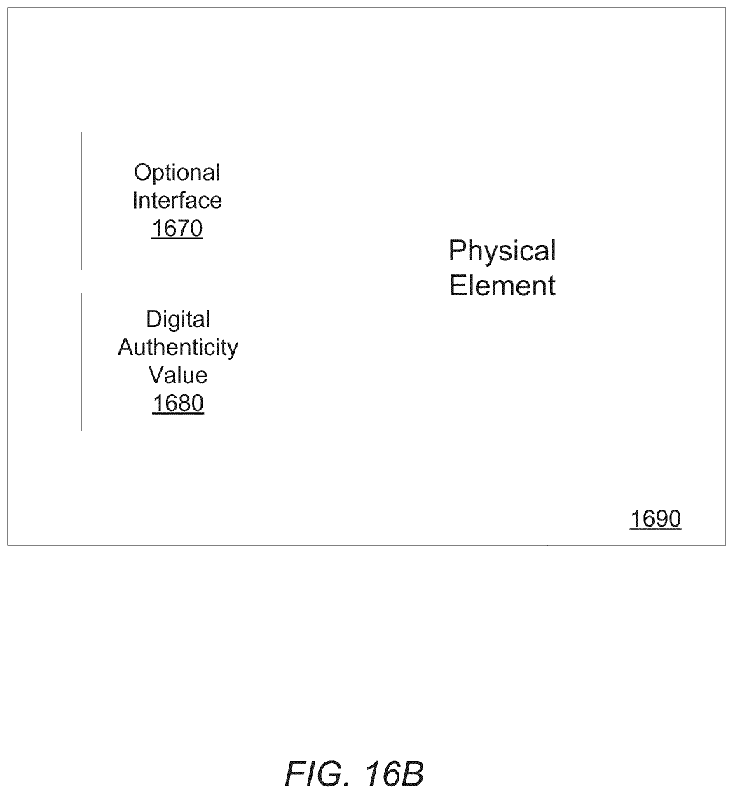

An example NFT which may be associated with specific content in accordance with several embodiments of the invention is illustrated in FIG. 16. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

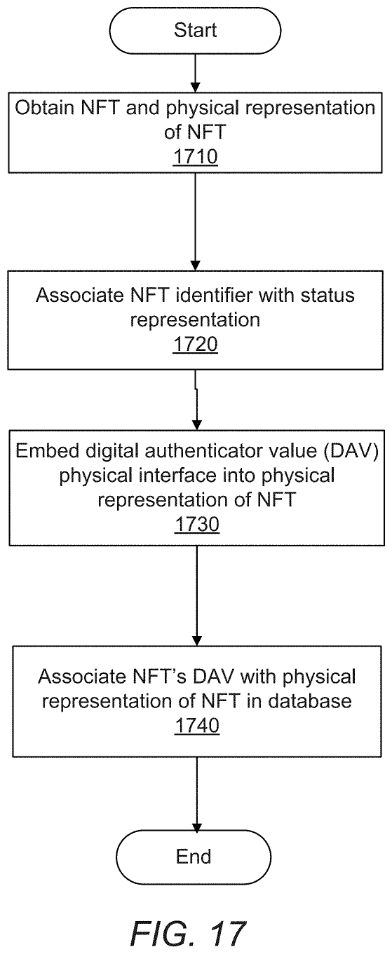

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

### Unlocking Token Content

Existing token technologies, including non-fungible tokens (NFTs), permit a user and/or entity with access to a token with the ability to use content (e.g., viewing images, listening to music, among other actions) associated with the token. Thus, any content associated with a token can be used by any party with access to a token. This unlimited and/or uncontrolled access can limit many potential applications of tokens and thus can make many desirable uses not possible. For example, a person's “Last Will”, which is a highly private and personal document, may be encoded in a token. However, if the Last Will is encoded using existing token technology, the Last Will can be accessible to any user with access to the token, which would not be in line with the privacy expectations demanded for such a highly personal document. Rather, a user drafting a highly confidential document, such as a Last Will, may prefer that the content of the document be only accessible under some specified conditions, which may include a “triggering event” (e.g., passaged of a certain date, a confirmation of a person passing away for a Last Will to be accessible, among various other limitations as appropriate for the particular applications and which can be specified by users).

Accordingly, NFT security platforms in accordance with many embodiments of the invention generate tokens that include security features that provides conditional locking/unlocking of content based on triggering events, among numerous security features that protect content from unauthorized access. Conditional locking/unlocking of content can be beneficial for many different users and applications, including, for example, artists and other creative content developers, who may wish to distribute a token with a first functionality to a large number of users, e.g., by renting out the token and/or providing it for free, and when a given condition is satisfied (e.g., a user purchases a token), an author of the content may wish for additional content associated with the token to be accessible to a user in possession of the token, providing an evolving token functionality that can provide different features for different triggering events (e.g., high resolution content, different content, among many other features).

NFT security platforms in accordance with many embodiments of the invention can generate tokens that include conditional security features within the tokens by partitioning content for a token into different portions, where access to a particular portion of content can be governed by a policy associated with that portion. Different portions of content can provide different accessibility rights, including private portions that may not be accessible, and may become accessible by for example, a triggering event and public portions that can be visible. Different policy conditions can be specified for different portions of the content, including accessibility conditions that includes whether content can be read, edited, requiring that content be read within a particular environment, providing access to content based at a particular date, among various other policies that can be specified by users as appropriate to the requirements of different applications in accordance with embodiments of the invention.

In particular, NFT security platforms can generate NFTs with different content portions, with each content portion can be associated with a particular policy that can provide limitations on accessibility to the content portion. As such, an NFT can include N content portions with 0 to N (or more) different content policies that determine access to a corresponding content portion, where for example, a first content portion may specify a policy that it may be permissible to be read by a party with access to the NFT, corresponding to an absence of a limiting policy. An NFT can include a second content portion that is associated with a second policy, where the second policy may provide a different limitation (e.g., such as the second content portion may be permissible to read only in a pre-specified computational environment such as a digital rights management (DRM) environment with a certification provided by a trusted authority). The NFT can include a third content portion with a third different policy (e.g., the third policy may state that it may be permissible to read only after a pre-specified date, for example, read only after as Jul. 1, 2025). An NFT can include a fourth content portion with a fourth policy (e.g., the fourth content portion may be permissible to read only after a key unlocking its contents is received). The NFT can include a fifth content portion with a fifth limiting policy (e.g., fifth policy may state that it may be permissible to read only after an event has been logged as having taken place, for example, by the recording of the event on a blockchain by a trusted party). The NFT can include a sixth content portion with a sixth limiting policy (e.g., the sixth content portion may be permissible to read only after a user has advanced to level 4 of a game, where the token references the game and receives information from the game using an application programming interface (API)). A seventh content portion may be permissible to read based on a seventh limiting policy (e.g., only after the owner of the token also acquires ownership of another token, as indicated by an inventory associated with a secure wallet storing the token). Accordingly, NFTs in accordance with many embodiments of the invention can include different content portions associated with different policies that can provide different accessibilities and limitations on accessibility, where access to a particular content portion can be determined based on many different types of policies, including having a particular token, DRM certification, access upon a trigger date/time such as a pre-specified date, access after obtaining a particular key, access based on events that can be logged on a blockchain by a trusted party, access upon achieving an objective with respect to a gaming environment, access based on transactions associated with a token, among various other policies that can be specified as appropriate to the requirements of particular applications.

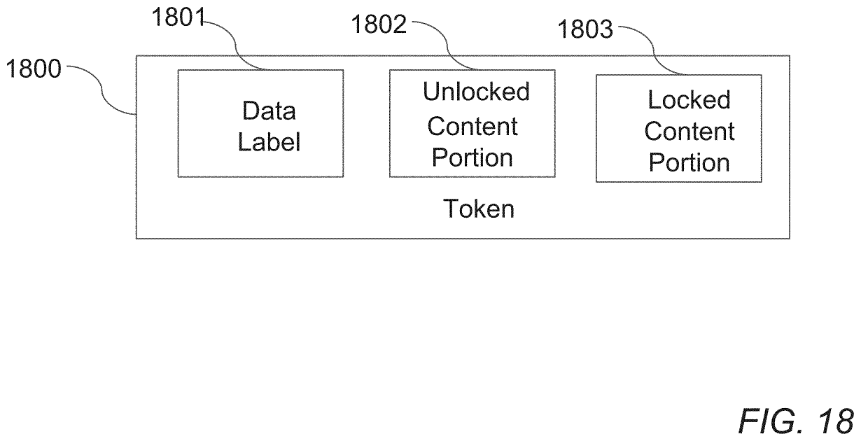

In many embodiments, tokens can be utilized that provide access to different content portions based on access control setting provided for the content portions, where a locked content may require a key in order to unlock a content. A token with lock access in accordance with an embodiment of the invention is illustrated in FIG. 18. The token 1800 can include a data label 1801, and several content portions, including an unlocked (e.g., accessible) content portion 1802 and a locked content portion 1803. In many embodiments a key and/or access token can be needed to unlock the locked content portion 1803. In several embodiments, a decryption key can be provided by a certified trusted entity to a user that requests access to the token 1800. In certain embodiments, the token 1800 may include in the locked content portion 1803 a pointer to locked content that is stored off-chain, in circumstances where the content is stored off-chain. Although FIG. 18 illustrates a token with different content portions with locked and unlocked (e.g., accessible) content, any of a variety of architectures can be utilized for tokens providing conditional access control as appropriate to the requirements of specific applications in accordance with an embodiment of the invention is illustrated in FIG. 18.

NFT security platforms in accordance with several embodiments of the invention can use various different types of computing structure to generate NFTs that provide access control to content portions associated with the NFTs, including trusted execution environments (TEE), DRM applications including secure digital wallets, environments that can use encryption/decryption keys for use to lock/unlock content portions, and/or any combination of different computing environments as appropriate to the requirements of specific applications in accordance with embodiments of the invention.

NFT security platforms in accordance with many embodiments of the invention can generate tokens that include decryption keys, which may specify that the decryption keys can only be accessed in a secure application, including, for example, a DRM-enabled digital wallet running in a TEE, where the decryption keys may allow unlocking of content of a token and/or content of another token. Decryption keys can be distributed to users by trusted parties (e.g., a government-certified entity, a marketplace authority, among others). For example, in situations where an NFT of a highly confidential document (e.g., a person's Last Will) is to be accessible by decryption, a decryption key can be provided by a certified entity, (e.g., government-certified hospital where a person deceased, law firm representing a deceased, among others) per request. Decryption keys can be distributed by content originators. In many embodiments, content originators can continuously generate new content that can be locked, and decryption keys can be distributed periodically by publishing new decryption keys and/or including them in new content they distribute in order to unlock the new content. Decryption keys may be algorithmically generated by computational entities in a manner that may require a large computational effort, where the size of the large computational effort can be governed using difficulty parameters. A delay function can be used to compute such keys. Delay functions that can be used in NFT security platforms in accordance with many embodiments are disclosed in U.S. patent application Ser. No. 17/806,060 entitled “Composite Cryptographic Systems with Variable Configuration Parameters and Memory Bound Functions” filed Jun. 8, 2022, by Markus Jakobsson, which is herein incorporated by reference in its entirety.

In many embodiments, NFTs can include a location indicator that provides a location of a content and/or a decryption key to decrypt content. In particular, NFT security platforms in accordance with many embodiments of the invention can generate NFTs that incorporate and/or associate at least one location reference, where a location reference can specify an address that identifies where a decryption key can be obtained. In many embodiments, a location reference can reference a location of a source of content, including a URL, URI, private database, public database, among many other sources that can include content. In many embodiments, a location reference can be an indicator of a blockchain where a decryption key may be posted and can include a label identifying an entry of a particular blockchain that includes the decryption key.

NFT security platforms in accordance with many embodiments of the invention can provide notifications regarding availability of decryption keys, which can be useful in particular situations where a key may not be available at a given time, and thus a user with access to a location reference may subscribe to notifications from a service provider to be notified when a decryption key becomes available.

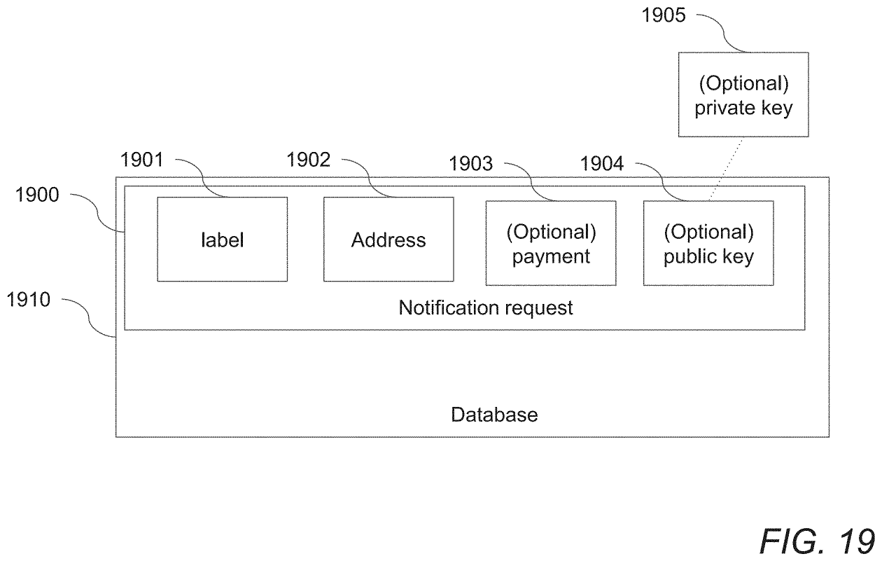

A notification request in accordance with an embodiment of the invention is illustrated in FIG. 19. In particular, FIG. 19 illustrates a notification request 1900 that can include several data fields, including a label data field 1901 that can be associated with a label data field of a particular token (e.g., data label 1801 illustrated in FIG. 18) and an address 1902. The address can include a location to which notifications should be sent. The notification request 1900 can be stored in a database 1910. A notification request 1900 can include a payment data field 1903 that can provide for a payment, and can include a public key. The public key 1904 can correspond to a private key (e.g., private key 1905 illustrated in FIG. 19 and which is not part of notification request 1900). Although FIG. 19 illustrates a particular configuration of a notification request that includes several data fields, any of a variety of configurations that include additional and/or different data fields to request notifications for tokens can be utilized as appropriate to the requirements of specific applications in accordance with embodiments of the invention. Notification requests can be requested by different types of service providers, including different types of users e.g., bounty hunters who can be paid to monitor at least one location and generate notifications.

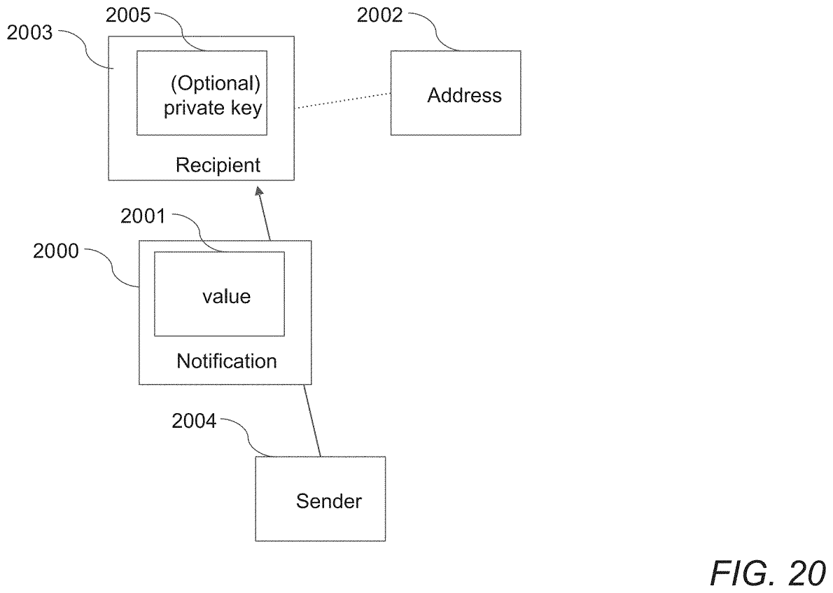

FIG. 20 illustrates a notification 2000 transmitted by a sender 2004 to a recipient 2003 associated with an address 2002. The sender 2004 can be a third-party system to whom a recipient device 2003 has requested notifications. The notification 2000 can include a value data field 2001. The value data field 2001 can include a key that can be used to unlock locked content associated with an NFT. In many embodiments, a key can be a decryption key. In certain embodiments, a key can be a private key associated with a public key. In several embodiments, value 2001 can be an access token that can be used to unlock locked content associated with an NFT. In certain embodiments, value 2001 may be a ciphertext that can be generated by encrypting a plaintext value using a public key (e.g., optional public key 1904 illustrated in FIG. 19). In certain embodiments, value 2001 may be a decryption key and/or an access token. In several embodiments, value 2001 can be a pointer to a location that can be used to obtain access control data, including obtaining a key, a decryption key, a private key, an access token, among other types of access control data. In many embodiments, value 2001 can include data that corresponds to previously received a notification request provided by a recipient (e.g., notification request 1900 illustrated in FIG. 20). Although FIG. 20 illustrates a particular configuration of a notification transmitted by a sender to a recipient that can be used to unlock content by a recipient, any of a variety of configurations can be utilized to provide notifications, including providing notifications that include pointers to locations where decryption keys, access tokens, private keys, among other types of access control data can be obtained as appropriate to the requirements of specific applications in accordance with embodiments of the invention.

An encryption/decryption key can be a private key with which there is a public key associated. A smart contract with a user (e.g., bounty hunter) may provide for a reward that can be possible to unlock using a private key with which a public key is associated. A type of smart contract can be generated by a user that subscribes to notifications who has access to the public key for which it wishes to learn the private key. A miner and/or verifier scrutinizing content incorporated in a blockchain, and/or being submitted to a mempool, can perform the duties of such bounty hunters. Multiple users (e.g., bounty hunters) can be competing for a same award, where an award may be conditional on having access to the private key and performing a (e.g., medium-size) delay function, where a subscriber can provide an answer to a delay function in response to receiving a notification that includes the private key. This can create an incentive for a user (e.g., bounty hunters) to compete to provide notifications, as opposed to solving the delay function on their own. A delay function may, for example, correspond to an effort that typically takes a time period (e.g., 1 hour) to solve.

NFT security platforms in accordance with many embodiments of the invention can provide subscriptions to notifications that may identify posts that should initiate a notification using a data label, where a data label can be associated with a key. For example, a creator of content can generate a data label, such as a public key, a hash image of a value that it keeps secret, or another unique identifier, and publish the label, e.g., by incorporating it in a token. Doing so can provide users with an alert that a content originator may provide material related to the token, e.g., future updates of content. A creator of content may not know what users are interested in this material, and/or may not be able to locate them. Therefore, parties who are interested in a material can subscribe to notifications related to the label. Such requests can specify that any related material is relevant, e.g., anybody using the label in a post can result in a notification of the party requesting the notification receiving a message that includes at least part of such post. A request may be specific to parties that provide a proof relative to the label, such as providing a digital signature using a public key corresponding to the label, by providing the value that is the preimage of the hash value used as a label, and/or by providing a private key that corresponds to a public key from which the label was generated. Subscribers may specify conditions for when notifications are to be sent, e.g., only if a policy is satisfied, and/or only at a given time of the day which may cause a collection of observed events to be transmitted in one and the same notification, among many other conditions that can be specified as appropriate.

NFT security platforms in accordance with many embodiments of the invention can associate a notification subscription with a reward provided to a user generating the notification, where this reward may be committed by the recipient of the notification when generating the notification request. In certain embodiments, a notification may be associated with a reward provided by a third party. For example, a user executing a game may cause a notification request related to updates of the game to be generated, when available, where a reward for performing notifications is provided by the creator of the game and/or a sponsor of the game, such as an in-app advertiser that wishes to distribute a new advertisement to be rendered in the game. In yet another example use, no explicit reward is provided for performing a notification, but the act of generating a notification as appropriate is part of a network functionality. An example of such an action is a situation in which a miner closing a ledger is required to notify all users with subscriptions for notifications where any such subscriptions correspond to labels in entries on the ledger processed by the miner. Miners could be assumed to perform this task, and if it is found that they consistently fail to do so, they could be penalized. The failure to perform the act could be detected using bounty hunters, for example, and the deterrence could include a refusal to accept transcripts from such a non-compliant miner for a set duration of time. This is a type of deterrence that may be meted out using a consensus mechanism.

NFT security platforms in accordance with many embodiments of the invention can include notification subscriptions that can include at least one data field for a label, a data field of an address to which to send notifications, and a data field for an optional policy associated with when a notification is to be generated. A notification subscription may include a smart contract that is associated with a conditional payment such as a claim for a reward, the conditional payment being performed in response to a reporting entity, such as a bounty hunter or a miner, being the first to report a value corresponding to the notification subscription. A reward claim may be received from a subscriber in response to the subscriber receiving the notification. It may also be generated by the notifying entity, e.g., using a delay function that takes as input a value in the record being reported. A value can include a private key corresponding to a public key that is used as a label, and/or used to generate a label. A value can be a digital signature generated using a private key.

NFT security platforms in accordance with many embodiments of the invention can provide notification requests that are associated with a policy that can include one or more conditions. A condition can specify that a content of a post match a label that is associated with a notification subscription request. For example, the condition may be that the post and/or portions thereof be digitally signed by an authority, whether a pre-specified such authority and/or an authority of a pre-specified type. Authorities can include different types of users, including an originator of a token relative to which a notification subscription is made, a party responsible for security updates of software utilized by a requester of the notification subscription, a third party that has a contractual relationship with a content provider (e.g., an advertisement platform that sells advertisements to be displayed along with content related to a token with which the notification subscription is related), among various other users.

NFT security platforms in accordance with many embodiments of the invention can generate policies that may require that a post satisfies at least one computational condition. Different types of computations can be specified, including computing hash values for keys, matching private/public keys, verifying digital signatures, among others.

For example, a post that includes a label that is a public key, and/or where the label is derived from a public key such as by hashing the public key, a condition may be that the post include a private key that matches the public key, that the post include a digital signature that is verified using the public key, and/or that the post include information that identifies the token with which the notification request is associated. For example, such information may specify a hash of the token, the originator identifier and a serial number of the token, and/or reference an identifier included in the token, among other identifiers.

NFT security platforms in accordance with many embodiments of the invention can generate requests that a miner identify matches with content on mempool being incorporated on a ledger that match a notification subscription.

NFT security platforms in accordance with many embodiments of the invention can generate and/or utilize tokens that include different data fields. In particular, NFT security platforms in accordance with many embodiments can generate tokens that can include a data field that includes identification information, a data field for a label, and an encrypted payload element. For example, for a highly confidential document (e.g., a person's “Last Will” document), the document may be a token that includes an identifier of the token contents, including a person's identification information (e.g., name, date of birth, among other identifying information), a label, and an encrypted payload element. In many embodiments, an encrypted payload element may be digitally signed by a trusted entity (e.g., trusted third party, such as a digital notary). A trusted entity (e.g., digital notary) may use information regarding a plaintext payload corresponding to the encrypted payload element to perform a certification. In many embodiments of the NFT security platforms, an encrypted payload element of an NFT can be a plaintext payload that can be accessed by a user who holds an NFT and has access to a decryption key associated with the NFT. In many embodiments, a label can be computed using various different processes. In several embodiments of the NFT security platforms, a label of an NFT may be a hash of a public key corresponding to a decryption key, where asymmetric crypto is used. In certain embodiments of the NFT security platforms, a label of an NFT may be a hash of a symmetric decryption key where symmetric key crypto is used. A plaintext payload can include several layers of encryption e.g., using a key that has been pre-distributed to a set of users (e.g., other users associated with a “Last Will” document, such as family/friends/attorneys etc.).

NFT security platforms in accordance with many embodiments of the invention can provide enhanced security that can prevent a full decryption of an encrypted payload element of an NFT by requiring that different layers be decrypted and removed using different decryption keys in order to fully decrypt a payload element of an NFT. In particular, full decryption of a payload element of an NFT may require removal of one or more layers and/or up to N layers of encryption. In particular, a user with access to an additional-layer decryption key may not be able to obtain a full decryption of a payload element, as a first layer of encryption (e.g., up to N layers of encryption) may first need to be removed.

NFT security platforms in accordance with many embodiments of the invention can generate NFTs with several layers of encryption that enables privileged parties to access content upon an triggering event (e.g., after a public release of an associated first-layer decryption key), but that can block unauthorized users (e.g., bounty hunters, miners, among other users) from accessing potentially sensitive information as the unauthorized users may not have access to the additional-layer decryption keys. NFTs can include several layers, each encrypted with a different encryption keys, and different decryption keys for different layers can be provided to different users based on various triggering events associated with each particular layer. In many embodiments of the NFT security platforms, a plaintext payload of an NFT can be digitally signed and can include a timestamp, e.g., by John Doe, at a time they produced a document such as a Last Will, and/or by a representative such as a lawyer of John Doe.

NFT security platforms in accordance with many embodiments of the invention can utilize NFTs that include evolving content (e.g., artwork, music, among other types of content and/or rich media), where an evolution of a content can correspond to triggering events (transactions associated with an NFT, policies set for an NFT, among others) such as partly to an increased access to content that was previously inaccessible (e.g., content included in an encrypted container in a NFT). As decryption keys are obtained, content can be selectively made accessible and can change the nature of the content (e.g., for artwork there can be addition of new images, new audio, new rules governing the use and/or rendering of the content, among others). In particular, decryption keys can be used to unlock new content and/or features of an NFT.

NFT security platforms in accordance with many embodiments of the invention can provide a user (e.g., an author of content, artist, among others) with many access control functionalities for content as they may not know at a particular time when they make additional content accessible as part of an evolution of a content, and/or what users are in possession of and/or have access to the NFT. For example, a user that is an author of an NFT can keep their identity private and thus another user who purchases the NFT (e.g., owner of the NFT) may not be able to identify the author of an NFT. Likewise, a user with rights to an NFT (e.g., owner) can keep their identity private, and still subscribe to notifications. A notification subscription can be done via intermediaries, whether to consolidate notifications, to avoid exposing a number of subscribers to the notification, and/or to keep private subscriber identification information.

NFT security platforms in accordance with many embodiments of the invention can generate NFTs that represent an access right to content, where the content is external to the NFT, which can be referred to as an access token. As described, an NFT content may be text (e.g., a magazine), audio (e.g., music produced by a pianist), among many different types of media. As new content is created, this may be distributed to a user with access rights to a previous content, e.g., by transmitting updates. A user may have the right to access a certain amount of content (e.g., twelve issues of a magazine, five year's worth of piano solos, etc.).

NFT security platforms in accordance with many embodiments of the invention can distribute content in an encrypted form in tokens, where an access token can enable a generation of subscription requests and can include at least one decryption master key that is associated with a time period of access, and which can be used to decrypt session keys with which individual content updates can be encrypted. Access tokens can include session keys that can be used to encrypt content.

NFT security platforms in accordance with many embodiments of the invention can provide notification services, where notifications can include labels and where a notification can include decryption keys that can be used to decrypt content in a token associated with a label, and the label can be used to determine the notification request. A notification may include an access token, which may include a value that can be digitally signed and/or authenticated by an authority.

NFT security platforms in accordance with many embodiments of the invention can utilize various authorities/entities of different types to facilitate transactions, including a DRM entity, a TEE environment, and/or a secure application such as a digital wallet, among many other types of entities as appropriate to the requirements of specific applications in accordance with embodiments of the invention. NFT security platforms in accordance with many embodiments of the invention can use an authority to implement various security features, including a validity of a digital signature relative to a list of accepted authorities, among others. NFT security platforms in accordance with many embodiments of the invention can use digital signatures, where a digitally signed value may be verified, e.g., to determine that it corresponds to a request, to a token, and/or a combination of these.

NFT security platforms in accordance with many embodiments of the invention can use access tokens to allow access to otherwise locked NFT content by verifying that a digital signature is valid and/or validating a digitally signed value. NFT security platforms can perform verifications at different intervals, including, among others, each time a locked content is requested, only a first time a locked content is requested, among various other conditions that can be specified by a user. In many embodiments of the NFT security platforms, a flag of an NFT can be set to allow continued access. Continued access may be conditioned on a context, for example, such as the ownership not changing and/or the identity of the party accessing and/or rendering content does not change. Access to content may be for different time periods, e.g., ephemeral, only once, only for a day, and/or based on a local state (e.g., in the wallet), among various other requirements that can be specified by a user.

NFT security platforms in accordance with many embodiments of the invention can provide that an access request may include a payment (e.g., a conditional payment related to the completion of a reporting action). In many embodiments of the NFT security platforms, access requests can be expressed using a smart contract, an executable element capable of providing access to funds, and/or as an encrypted payment that can be decrypted using a same key that is requested in a notification request. Notification requests can be used to obtain data used to unlock content. Notification requests can be used to obtain access to content of information matching criteria specified in a notification request. Criteria can correspond to a form of label, and may be expressed in the form of a policy, a rule, and/or a topic identifier that can be encoded and/or identified by the label.

Biometric Authentication using Privacy-Protecting Tokens

Biometrics can have an important role in authentication. However, biometric data is traditionally verified by comparing it to templates, which due to their sensitive nature are typically stored in secure storage areas. In a distributed setting, a requirement that information be stored in secure storage may at times be too limiting and problematic to adhere to. For less sensitive content, traditional content protection techniques may still be acceptable to use, such as traditional encryption and traditional access control measures, but for highly sensitive data such as biometric templates, using traditional techniques may pose serious security risks which may present user reluctance to accept these associated risks, thereby presenting a lack of technology adoption.

NFT security platforms in accordance with many embodiments of the invention can include biometric authentication with remote authentication using cryptographic keys, where cryptographic keys can be derived from data stored in biometric tokens. In several embodiments, cryptographic keys can be derived from data provided by biometric inputs. NFT security platforms in accordance with many embodiments of the invention can use of cryptographic keys to minimize various security risks, including in particular, risks associated with brute-force attacks where attackers may have access to tokens, among other types of attacks.

NFT security platforms in accordance with many embodiments of the invention can utilize throttling which can be useful in situations that use low-entropy biometrics. Many embodiments provide biometric authentication that is robust against potential fuzziness associated with measured biometric data, including modifications, losses and/or distortions to biometric data. In many embodiments, an array (e.g., array B) of biometric measurements can be generated that can be derived from a biometric input, where elements of the array can be derived using techniques that can minimize fuzziness.

NFT security platforms in accordance with many embodiments of the invention can use masks for selection, including to address fuzziness for dimensions where there may be a weak signal, as certain techniques may not address fuzziness for dimensions where there may be a weak signal. Many embodiments of the NFT platforms can generate secure masks (e.g., encrypt masks among other security measures) to avoid exposure of a mask using encrypted masking processes. In particular, efficient processing of an encrypted contents can be difficult. Accordingly, the use of encrypted masks can provide protection of data that would otherwise, if exposed, help attackers perform illegal activities (e.g., brute-force attacks), which can be a risk associated with distributed settings. Accordingly, NFT security platforms in accordance with many embodiments of the invention can use biometric authentication in distributed settings providing many benefits for token-based applications and corresponding distributed settings.

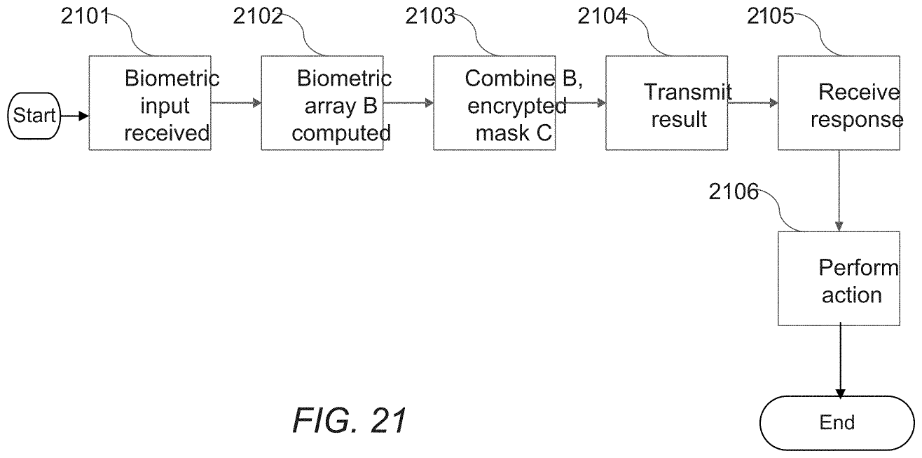

A process for encrypting biometric data in accordance with an embodiment of the invention is illustrated in FIG. 21. The process receives 2101 biometric data (e.g., from one or more sensors). The process can compute 2102 an array B of values, each value can be a function of the biometric input. Some of the values may be robust, e.g., unlikely to depend on environmental conditions, whereas others may not be robust, e.g., have no signal and/or depend to a large extent on environmental conditions. A mask can be used to select robust values. Instead of disclosing a mask, an encrypted mask can be used. The encrypted mask C can be combined 2103 with the array B, and without the need or capability to decrypt C. The result can be an encrypted function of the biometric input, which may depend on thresholds associated with a biometric token that can be used to store the encrypted mask C. The encrypted result can be transmitted 2104 (e.g., to a distributed party, a trusted party, and/or a distributed trusted party that processes the encrypted result and returns a response). The process can receive 2105 a response. Based on the received response, the process performs 2106 an action. Example actions can include, among other actions: generate a key from the received response, perform a login based on the generated key or the received response, decrypt a ciphertext stored in or with the biometric token, among others. In many embodiments, an action may not be available if a wrong biometric input is received 2105. Although FIG. 21 illustrates specific processes for processing biometric data, any of a variety of processes may be utilized for processing biometric data as appropriate to the requirements of specific applications in accordance with embodiments of the invention.

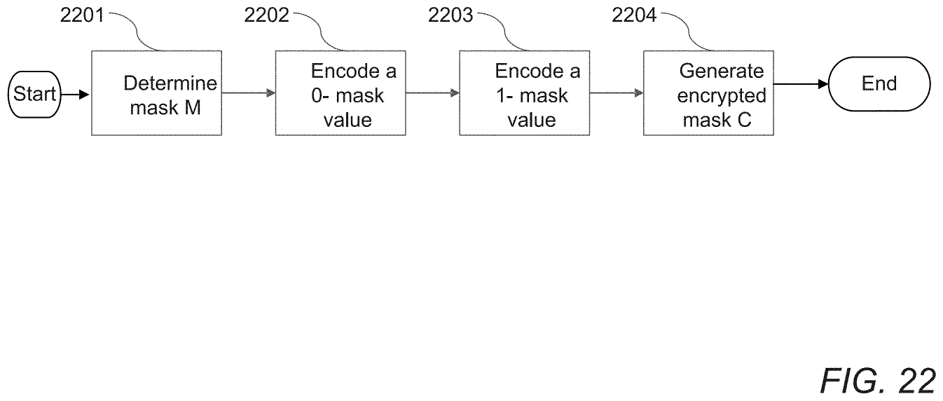

Processes for generation of encrypted mask arrays in accordance with an embodiment of the invention is illustrated in FIG. 22. In particular, FIG. 22 illustrates a process for the generation of an encrypted mask array C. Based on at least one biometric input, the process can determine 2201 a mask M. The mask can be determined to select robust entries of the array B by selecting a 1-mask value, and to suppress the non-robust entries of the array B by selecting a 0-mask value. The process can encode 2202 a 0-mask value as a ciphertext of the value 1. The process can encode 2203, a 1-mask value as a ciphertext of a generator, such as hi, which can be a generator of a Zq* used for the entry number i of the encrypted mask array C. hi may be publicly known. The process can generate 2204 an encrypted mask C by using (preferably distinct) representations of the encoded 0-mask and 1-mask values, corresponding to different such ciphertexts. In many embodiments, ElGamal encryption can be used, which may be performed using traditional integer groups or elliptic curves. Although FIG. 22 illustrates specific processes for generating encrypted masks, any of a variety of processes may be utilized for generating encrypted masks as appropriate to the requirements of specific applications in accordance with embodiments of the invention.

NFT security platforms in accordance with many embodiments of the invention can generate cryptographic key material in distributed settings based on biometric verification of encoded biometric templates, where an encoding can include encryption. Many embodiments can provide security features including access control based on biometric verification in token-based distributed settings.

NFT security platforms in accordance with many embodiments of the invention can store verification data in publicly available and/or private “biometric” tokens, where the verification data stored in a biometric token can facilitate verification of biometric inputs and which may not expose private and/or sensitive biometric data to unauthorized users (e.g., a bad actor) in possession of the biometric token. In many embodiments, verification data used to verify biometric inputs can include biometric templates and/or masks that provide indications on how to process biometric inputs.

NFT security platforms in accordance with many embodiments of the invention can protect biometric data in distributed settings which can be important to help prevent disclosure and/or leaks of personally identifiable information (PII), (e.g., data that can facilitate the impersonation of a user). Accordingly, NFT security platforms in accordance with many embodiments of the invention can provide security and protection of biometric data against leakage, impersonation and other abuses, which is important for user privacy.

NFT security platforms in accordance with many embodiments of the invention can include robust processes that can compute a validator value based on a biometric token and/or a biometric input (e.g., a fingerprint, an iris scan, a face scan, among various other types of biometric input data) where the validator value can secure the biometric data to avoid exposure to a bad actor that comes in possession of the validator. In several embodiments of the NFT security platforms, it may not be feasible for a bad actor to determine, based on a biometric token, a prospective biometric input, and a validator value computed from these, whether there is a match between the biometric token and the biometric input. Being unable to determine whether or not there is a match between biometric tokens and biometric inputs can be beneficial to prevent security attacks (e.g., brute-force attacks, among others) on tokens.

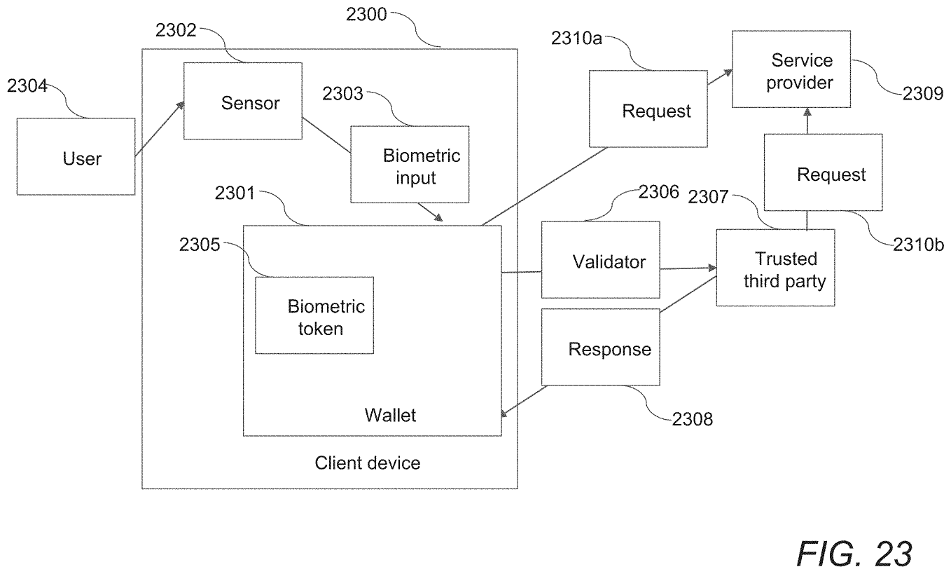

An architecture of a client device in accordance with an embodiment of the invention is illustrated in FIG. 23. In particular, FIG. 23 illustrates an architecture involving a client device 2300, a trusted third party 2307 and an optional service provider 2309. A user 2304 can interact with sensor 2302 to generate a biometric input 2303 that is provided to wallet 2301, which may be run in a DRM or TEE (not shown). The wallet 2301 of client device 2300 can generate a validator 2306 message based on biometric input 2303 and data associated with biometric token 2305. Validator can be transmitted to trusted third party 2307, which may be a distributed entity. Third party 2307 can process validator 2306, e.g., decrypts at least a portion of it, and can transmit a response 2308 to wallet 2301 of client device 2300, said response 2308 can include the decrypted portion of validator 2306. Wallet 2301 can perform an action, which may include generating a key (not shown) and/or sending a request 2310a to service provider 2309. In certain embodiments, trusted third party 2307 may transmit a request 2310b to service provider 2309. In certain embodiments, this can be in addition to sending response 2308 to wallet 2301. In several embodiments, this can be instead of doing so. Service provider 2309 can include: a social media website, an online banking site, a cloud wallet manager, and/or a subscription-based service such as an online newspaper among other service providers. Trusted third party 2307 may not need to know the mask used, nor need it have access to any PII of the user. It may store a portion of a secret key used for quorum-based decryption. As such, it may not decrypt anything on its own. The functionality of trusted third party 2307 can be to perform decryption. This can also be performed by a trusted device in the possession of the user, e.g., a phone, a secure server, or a wearable computing device. Thus, a trusted third party may not need to be distributed, although it is still possible for it to be. In many embodiments, standard threshold sharing can be used for the distribution, among various other techniques that can be used as appropriate to the requirements of specific applications. A wallet may be hosted on a secure hardware device and include a decryption oracle that can performs the tasks of a trusted third party 2307. Thus, if the secure hardware device becomes corrupted with malware, an oracle can be reached using a secure API, and cannot be infected by the malware. Although FIG. 23 illustrates a particular hardware architecture of a client device, any architectures can be utilized as appropriate to the requirements of specific applications in accordance with embodiments of the invention.

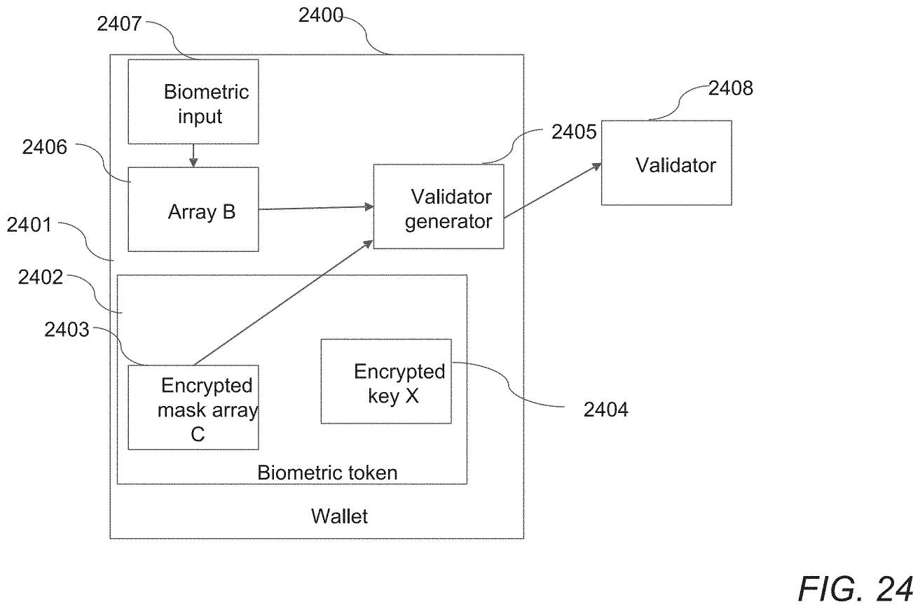

A process of generating an array using biometric input in accordance with an embodiment of the invention is illustrated in FIG. 24. In particular, FIG. 24 illustrates a detail of the operation wherein a biometric input 2407 can be used to derive array B 2401 using one or more extractions. A validator generator 2405 can combine Array B 2406 with encrypted mask array C 2403, stored in biometric token 2402, to generate validator 2408. In many embodiments, the combination may be performed by an item-wise modification of the elements of encrypted mask array C 2403 using the items of Array B 2406, resulting in an encryption of a masked version of array B from which validator 2408 can be derived. As response can be received, it can be used to decrypt encrypted key X 2404, resulting in a key X. Key X may be used to generate request, and/or may be used to decrypt other elements contained in or associated with biometric token. Although FIG. 24 illustrates a process of generating an array using biometric input, any of a variety of processes can be utilized as appropriate to the requirements of specific applications in accordance with embodiments of the invention.

NFT security platforms in accordance with many embodiments of the invention can provide secure pipelines to process validator values, using at least one verifier, to determine whether a biometric input from which a validator value is computed corresponds to an identity of a user associated with a biometric token. In many embodiments, a verifier may be a set of distributed entities, e.g., include several collaborating entities. A verifier may perform processing and make a determination based on a consensus mechanism. A verifier can perform processing, from which a prospective unlock value can be generated, but the verifier may be unable to determine whether this prospective unlock value is a valid unlock value. If there is a match between a biometric token and a biometric input, then a prospective unlock value can be useful to perform an unlock action by the holder of the biometric token, but if there is not a match, then the unlock action can fail. Because a verifier may not be able to determine whether an unlock action will succeed or fail, a verifier may not be corrupted and used to successfully perform brute-force attacks on tokens that are not in the possession of the attacker.

NFT security platforms in accordance with many embodiments of the invention can use a validator value to determine an identity of a user in the context of a given computation, which may be distributed and lacking access to a locally-stored biometric template, where performance of the computation can require an access right and/or an unlock value be satisfied, and where the access right and/or unlock value may be provided by a verifier in response to a successful verification.

NFT security platforms in accordance with many embodiments of the invention can receive and process biometric data that can generate an array of N different aspects of a biometric data input. Different aspects of the array of N aspects can include voice based biometrics that can include quantifiers that can correspond to an amount of signal in an input in a particular frequency range (e.g., between 25 Hz and 50 Hz) whether for a known spoken word and/or based on a provided voice input signal, among various other biometric properties for the particular types of biometric inputs.

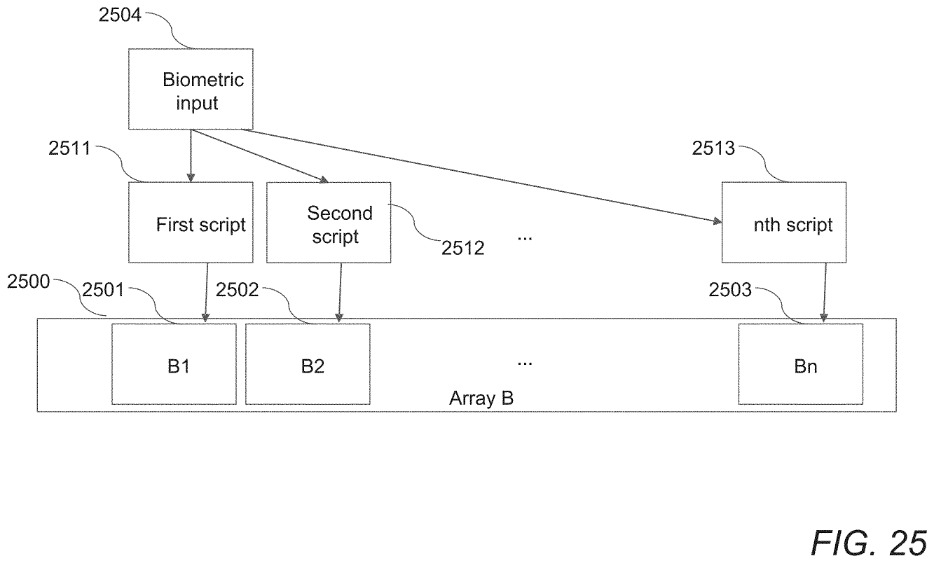

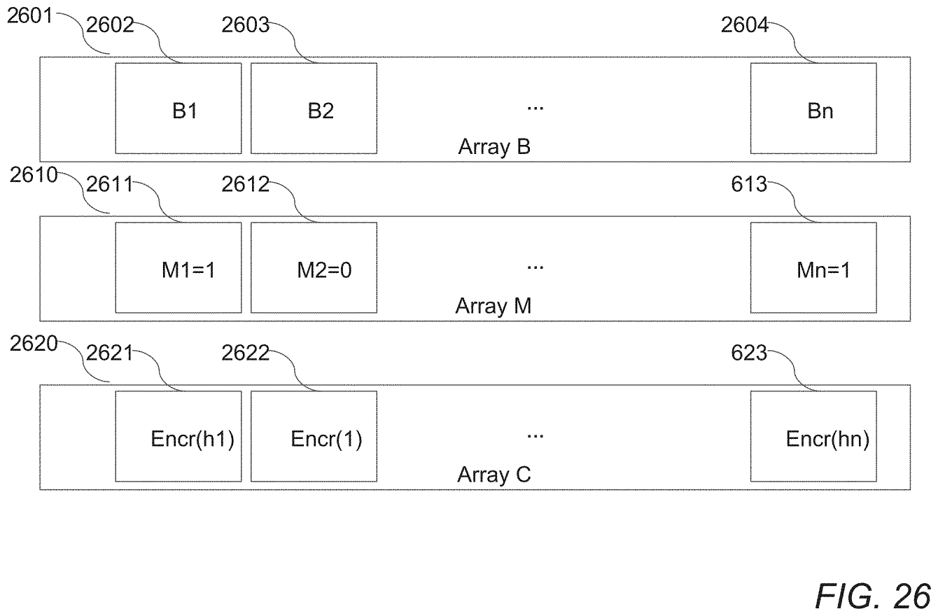

Generation of an array from a biometric input in accordance with an embodiment of the invention is illustrated in FIG. 25. In particular, FIG. 25 illustrates a generation of Array B 2501 from biometric input 2504, as performed on client device and/or associated computational entities. Biometric input 2504 can be provided to first script 2511, second script 2512, up to nth script 2513. Here, n may be values such as 50 or 200, for example. First script 2511 can perform a first determination related to biometric input 2504, e.g., determines whether one aspect is present or not. First script can output a value B1 2501 that represents the result of the computation performed by first script 2511. For example, it may compare the computed result to one or more thresholds and determine, based on these comparisons, a cluster to which biometric input 303 belongs to. This can represented by B1 2501, which can be a first element of Array B 2500. Similarly, second script 2512 can perform a different computation from first script 2511 and outputs a second classification B2 2502 of biometric input 2504, e.g., based on the comparison with one or more thresholds. An nth script, likewise, computes an output Bn based on biometric input 2504. Some of the elements of array B 2500, such as for example B1 2501 may be robust such that they are at a low risk of being corrupted in the presence of a typical amount of sensory noise and/or environmental background disturbance. This makes B1 2501 valuable to use for purposes of authentication. In certain embodiments, other elements of array B, such as for example B2 2502 may not be robust, (e.g., at a high risk of being corrupted in the presence of a typical amount of sensory noise or environmental background disturbance). In certain embodiments, B2 2502 may be a measurement of a feature that the user does not express. This can make B2 2502 not valuable to use for purposes of authentication. Although FIG. 25 illustrates a process for generation of an array from a biometric input, any of a variety of processes can be utilized to generate an array from a biometric input as appropriate to the requirements of specific applications in accordance with embodiments of the invention.

Masking of an array in accordance with an embodiment of the invention is illustrated in FIG. 26. In particular, FIG. 26 illustrates the masking of an array B 2601, B1 2602 can valuable for authentication, as is Bn 2604, but B2 2603 may not be valuable for authentication. This can be reflected by the mask expressed by Array M 2610, where element M1 2611 can be set to 1 to indicate an inclusion of B1 2602, element M2 2612 can be set to 0 to indicate an exclusion of B2 2603, and element Mn 2613 can be set to 1 to indicate an inclusion of Bn 2604. The array M 2610 can be represented by the Array C 2620. Element 2621 can be an encryption of the generator h1, e.g., of h1\hat{ }M1. Element 2622 can be an encryption of 1, e.g., of h2\hat{ }M2. Element 2623 can be an encryption of the generator hn, e.g., of hn\hat{ }Mn. The array C 2620 can correspond to an encrypted mask array C. Although FIG. 25 illustrates a process for masking an array, any of a variety of processes can be utilized to mask an array as appropriate to the requirements of specific applications in accordance with embodiments of the invention.

Different aspects can include different properties for different types of biometric inputs. For example, an aspect in an array of N aspects can include a quantifier corresponding to an amount of signal in a different frequency range (e.g., between 50 Hz and 100 Hz). For example, an aspect in an array of N aspects of a fingerprint-based biometric technique may be a presence of a particular type of fingerprint feature, (e.g., a whirl), and if present, a quantification of its radius (e.g., in millimeters). An aspect may be a presence of another type of fingerprint feature (e.g., a crossover). An aspect may be a closest distance between a center of a detected whirl and a detected crossover, if applicable.

NFT security platforms in accordance with many embodiments of the invention can include a biometric processes that can generate an array of N aspects for users, where different aspects in the array of N aspects can be computed using different techniques as appropriate for the particular type of biometric input data, including for example, using a rule-based system, a system based on quantification of amounts and/or distances, a machine learning system, artificial intelligence system that can generate a collection of functions based on a biometric input, among other processes as appropriate to the requirements of specific applications in accordance with embodiments of the invention. Aspects can be specific to a type of biometric input being processed, e.g., describing different features present in a voice-based sample and/or a fingerprint-based sample, among other types of inputs (e.g., facial, iris scan, among others). Different types of biometrics, e.g., iris-based and/or face image based among others, can be used as appropriate to the requirements of specific applications in accordance with various embodiments of the invention.

NFT security platforms in accordance with many embodiments of the invention can generate arrays for biometric inputs for different users, where some users may not have entries in certain positions of an array, as some of the entries can correspond to features and/or combinations of features that a given user fingerprint does not have. Similarly, some users may have some features that are weak and/or located in the perimeter of the fingerprint, and therefore occasionally registering as present and other times not registering as present. The generated aspects can be represented as identifiers associated with one or more classes associated with a given aspect. For example, an aspect that corresponds to a distance may be represented as an identifier corresponding to a range from a collection of relevant ranges, such as (range1, range2, range3, range4, range5)=(less than 1 mm, between 1 mm and 1.8 mm, between 1.8 mm and 2.4 mm, between 2.4 mm and 3.8 mm, more than 3.8 mm). Thus, if the detected distance is 1.4 mm, the range2 would be selected, as this indicates a distance between 1 mm and 1.8 mm. A collection of relevant ranges can be universal, whereby they can apply to a given aspect of the users. In certain embodiments, a collection can be specific to a given user.

NFT security platforms in accordance with many embodiments of the invention can generate and use masks that can be used to identify entries in an array that are relevant for a particular user. Many embodiments can obtain a biometric input for a user, apply a mask to determine the relevant entries, and for the relevant entries, perform a quantification of the input in which for each mask-selected value can select a category.

NFT security platforms in accordance with many embodiments of the invention can use a masked and quantized array to determine access and/or to generate a key. For example, one way to generate a key is to let each non-selected entry, using the mask, be set to 0 using a set number of binary bits, such as 10, and to represent each mask-selected entry as a 10-bit non-zero value representing the selected range. The resulting bit value can be hashed using a cryptographic hash function (e.g., SHA256, among others), and used as a cryptographic key. In many embodiments, a cryptographic key can be used as a symmetric key that may be stored on a third party server (e.g., a service provider server). In several embodiments of the NFT security platforms, a cryptographic key can be used as a symmetric key to decrypt a private key stored in a biometric token. A private key may correspond to a traditional public key, e.g., of the user. A private key may correspond to a public key that is not made public in order to prevent brute-force attacks on a platform. To keep a key private, many embodiments of the NFT platforms can distribute a public key and store pieces of it with different servers.

NFT security platforms in accordance with many embodiments of the invention can process a biometric input by mapping it to a set of selections, corresponding to ranges, and store the resulting arrays of values. For example, an i^{th} position of an array can be a value Bi and the j^{th} position of the array a value Bj. The array B=(B1, B2, Bn) can be an array to which a mask has not yet been applied. A mask may be represented as an array M=(M1, M2, Mn) where Mi is 0 or 1, can also be represented by another array, each element of which is a ciphertext of the associated mask value. Elements of the mask array can be C=(C1, C2, . . . Cn) where Ci is an ElGamal ciphertext of hi\hat{ }Mi mod p, where hi is a generator used in position i of the array, and \hat{ }represents exponentiation modulo p. Here, a ciphertext Ci of a plaintext value mi=hi\hat{ }Mi can be represented as a pair, (Di,Ei) where Di=y\hat{ }r mod p and E=mi g\hat{ }r mod p, and y=g\hat{ }x mod p is a public key and x is a secret key. Here, r can be a random number in Zq, for p=2\hat{ }k*q+1, and both p and q prime numbers, and k a positive non-zero integer such as k=2. A mask, while in its encrypted state, e.g., in a format of the array C, can be applied to a biometric input vector B. This can be done by computing Fi=(Di′,Ei′) for each value 1<=j<=n, where Di′=Di\hat{ }Bi mod p, and Ei′=Ei\hat{ }Bi mod p. This can correspond to Fi=(y\hat{ }(r*Bi) mod p, mi\hat{ }Bi*g\hat{ }(r*Bi) mod p)=(y\hat{ }(r*Bi) mod p, hi\hat{ }(Mi*Bi)*g\hat{ }(r*Bi) mod p). When a mask is Mi=0, then this corresponds to Fi=(y\hat{ }(r*Bi) mod p, g\hat{ }(r*Bi) mod p), which can be an encryption of 1, using the public key y; when the mask is Mi=1, this corresponds to Fi=(y\hat{ }(r*Bi) mod p, hi\hat{ }Bi*g\hat{ }(r*Bi) mod p), or an encryption of hi\hat{ }Bi using the public key y. Multiplying all the elements of the array F together, the result can be an encryption of a product of the hi\hat{ }Bi values for which the mask is set to 1. Each value hi may be set to the same generator, referred to as h. In certain embodiments, the values hi, 1<=i<=n can be distinct generators. A generator can refer to a value that generates Zq*. Thus, C can be a representation of a mask that may not disclose the mask to the party with access to C, since C can include ciphertexts. A party performing processing of a biometric input (e.g., generating an array B from at least one biometric sensor outputs), can perform computations on the encrypted mask C and the array B, without having to access the plaintext mask values. This can protect the mask from discovery by an attacker with access to the biometric token. Since a mask can include data about the particular array elements of B that can be relevant for generation of a key X, keeping the mask secret can protect key X from being brute-forced, in part because keeping the mask secret can significantly increase a search space for an attacker.

NFT security platforms in accordance with many embodiments of the invention can include a client-side device that can store a token that includes an encrypted mask array C. A bad actor with access to mask array C may not be able to determine the mask as it does not have a decryption key X. A client device may be able to receive and/or generate a biometric array B and combine this with C to form F, where F is an array that describes a biometric array, with the encrypted mask applied. This party can send F to a third party and/or can compute a value that is the pairwise product of all elements Fi, which can be an encryption of the product of all values hi\hat{ }(Bi*Mi) mod p, e.g., all the values hi\hat{ }Bi that the mask M array selected. A mask array can be different for different users, which may be undetectable since users may only have access to their encrypted mask. An encrypted product value, ProdF, may be transmitted to a third party entity. Client-side processing can include an evaluation of a biometric token, a processing of a biometric input, and a generation of at least one validator. NFT security platforms in accordance with many embodiments of the invention can include processing that may be performed by a digital rights management (DRM) module to limit risks associated with malware and/or undesirable code on a client device. NFT security platforms in accordance with many embodiments of the invention can perform processing in a trusted execution environment (TEE). However, even if processing is performed in a standard computational environment, such as by an application running on a phone or a laptop, NFT security platforms in accordance with many embodiments of the invention can limit risks for abuse. In particular, an abuse may have to take place, e.g., by malware, on a device associated with a person performing a biometric authentication attempt, and the risks may be limited to the leakage of sensitive data related to this person's PII. This can align incentives in a way that avoids risks of the type that typically are associated with brute-force attacks on other user's sensitive data, e.g., following a breach.

NFT security platforms in accordance with many embodiments of the invention can use third parties, where a third party may be a distributed party, e.g., a collection of devices trusted by an owner of a biometric token. Each such third party entity may have received a share of a secret key. A biometric token may include several shares, where the j^{th} share of a secret key X can be denoted by xⱼ. NFT security platforms in accordance with many embodiments of the invention can share using different threshold schemes (e.g., a (6,9) threshold scheme), where it can be sufficient to have M (e.g., 6) out of the N (e.g. 9) shares reconstruct x and/or perform decryption. A share xⱼ may correspond to a public version yj=g\hat{ }xj mod p. Third party entities may receive F and/or ProdF and generate a partially decrypted value, e.g., for ProdF=(ProdF1,ProdF2) this would be ProdF1 \hat{ }xj/ProdF2 mod p. This partially decrypted value can be sent to a client holding the biometric token, e.g., over a secure channel. The communication may also include a proof of correct exponentiation with respect to yj, e.g., a zero-knowledge proof of exponentiation of ProdF to xj, followed by the division of ProdF2. A Schnorr signature and/or a DSA signature can be used to create a non-interactive proof of correct exponentiation. A validator can be ProdF, F, and/or can include signatures and/or zero-knowledge proofs related to the processing of arrays C and B.

NFT security platforms in accordance with many embodiments of the invention can include a client device that can receive B and compute F and can transmit a blinded array F and/or a blinded encrypted value ProdF; which can be computed by raising each element to a random power R, where the corresponding value 1/R can be applied by exponentiation as the responses may be received from third parties. In many embodiments of the NFT security platforms, a secure channel can be utilized. A client device can, upon receiving responses from third party entities, generate a product of all values hi\hat{ }(Bi*Mi) mod p, denoted as X. X may be mapped to a symmetric key by applying a cryptographic hash function H (e.g., cryptographic hash function SHA512, among many others), resulting in a bit key X (e.g., 512 bit key X) that can be stable, as insatiable elements from the biometric vector B may have been masked out and only the stable elements may be kept. A stable element can be robustly generated time after time. A key X can be used to decrypt and/or offset a stored value of the biometric key, resulting in an asymmetric private key, e.g., associated with a public key used to generate digital signatures. X and x as described can be different parameters with different uses.

In many embodiments of the NFT security platforms, individual elements Fi can be used to interpolate a key. This can be combined with the techniques described to generate a key from a biometric input where some biometric input aspects can be absent and/or otherwise fail.

NFT security platforms in accordance with many embodiments of the invention can use a client device to send an array F to a distributed trusted party which, after verifying optional proofs transmitted by the client device, can perform decryption for each element of the array F, and can send back a corresponding decrypted array. In many embodiments of the NFT security platforms, a client device can communicate over a secure channel set up by the client device prior to the transmission of F. A client device may receive multiple arrays, including different arrays from different entities, including at least one array from each of the distributed entities that include trusted third party. A client device can generate a decrypted array from individual arrays and, based on resulting values, perform an interpolation. NFT security platforms in accordance with many embodiments of the invention can execute different subsets of shares and determine whether two subsets result in a same outcome, in which case this can be accepted as a result of an interpolation.

NFT security platforms in accordance with many embodiments of the invention can be used with various different applications, including: password authentication; 2FA; verification that a request is associated with a real human user, as opposed to a computerized bot; unlocking secret keys used to generate digital signatures; accessing a device and/or a wallet, among numerous other applications.

NFT security platforms in accordance with many embodiments of the invention can generate a key X with a device different than a client device, including at least one entity associated with a third-party service provider. A service provider can receive, in lieu of a key X, proof that demonstrates that a client and/or distributed third parties collectively have access to values from which key X can be generated (e.g., a product of all values hi\hat{ }(Bi*Mi) mod P. Accordingly, rather than a single user device being used to determine a key X, a distributed set of devices can collectively verify having access to key X providing proof to a service provider. NFT security platforms in accordance with many embodiments of the invention can provide client devices with the ability to provide data that can prove knowledge of a valid key, including providing data based on exponents Bi*Mi with respect to generators hi, and the distributed parties may not need data regarding Bi and/or Mi, where this can correspond to a public representation of a same key, the public representation can be of a format X\hat{ }d, where d can be a secret value stored in a biometric token. Biometric tokens in accordance with many embodiments of the NFT security platforms can store a key X in a location different than within a particular token, and can generate key X as needed, providing enhanced security, since key X may not be stored in the token, and can be generated on an as needed basis.

NFT security platforms in accordance with many embodiments of the invention can provide security against attacks in which a bad actor of a token holder transmits a ciphertext to a distributed third party with the aim of using this distributed third party as a decryption oracle, the bad actor may need to provide data that satisfies a criteria that establishes knowledge of exponents Bi associated with a vector F and/or the associated product ProdF. Many embodiments can use different types of signatures, including a Schnorr signature, Digital Signature Standard (DSS) signature, among others. A timer may be used to throttle a number of requests and to minimize excessive requests. For example, a distributed third party may only be willing to perform a decryption action after having verified a signature (e.g., Schnorr and/or DSS signature), and only a certain number of times per time period, (e.g., once an hour).

NFT security platforms in accordance with many embodiments of the invention can use several encrypted masks to provide robustness, where a first encrypted mask can correspond to a first mask, and a second encrypted mask can correspond to a second mask. A first mask can result in a higher-entropy measurement and carry a higher risk of failure (e.g., due to poor environmental conditions when a biometric input is received).

Poor environmental conditions can include as examples: a bright setting in which a face-biometric is collected using a camera; a very noisy background in which a voice-based biometric measurement is taken using a microphone; among various others. Accordingly, a second mask may discard a larger number of entries of the biometric array B than a first mask may. A selection of the elements to discard may be based on problems associated with common poor environmental conditions (e.g., noise in a common spectrum, such as from a barking dog and/or engine sounds, among many other examples). A selection may depend on the set of biometric features of associated users that are most robust, e.g., the least likely to be “blurred” by poor environmental conditions. The several encrypted masks may be processed using similar techniques that can be utilized for a single mask. The several encrypted masks may result in a same key X if computed correctly and/or may result, under ideal conditions, in different keys, including a key X1 for the first mask and a key X2 for the second mask.

NFT security platforms in accordance with many embodiments of the invention can provide different keys with different security levels, and different services can require keys with particular security levels. For example, a high-security service may only allow access using a key X1, whose mask can be more restrictive than a mask associated with a key X2; whereas a lower-security service may provide access based on either key X1 and/or key X2, and may log which key is used that can be used for auditing and to accurately compute risks associated with requests from users. Thus, for a particular service provider requiring a particular level of security, if key X1 providing higher security is used as a key, a request may be accepted, whereas if a key X2 with a lower security level is used, then the request may be accepted after additional verification is performed, including, for example determining whether the requested transaction is between entities that have previously been involved in transactions with the user whose biometrics was verified. Accordingly, NFT security platforms in accordance with many embodiments of the invention can implement policy-based decisions that can use a strictness of a mask as an indicator of security associated with a biometric verification. The more or less stringent match associated with different masks may coincide with a level of risk of a given transaction. Different types of transactions can require different security levels, where a more stringent match mask may be required for high-cost transactions and a less stringent match mask for everyday low-risk and/or low-cost transactions.

NFT security platforms in accordance with many embodiments of the invention can generate and store a mask array M which can be encrypted using a symmetric key X, referred to as EncM. The mask array M can be stored in a token and/or with a trusted entity. An EncM can be in addition to an array C which can be encrypted using a public key Y as described. EncM can be accessed by a client device once the client device has successfully generated a key X. EncM may include an asymmetric secret key Z that can be used to decrypt log entries of log L, where log entries of L can be computed using a public key Z corresponding to a secret key Z. The log L may be stored in a same wallet in which a biometric wallet is stored. Encrypted entries of L may include previously received biometric inputs, a classification of whether a login and/or key derivation is successful. A client device can, having generated key X, access M and Z. Using Z, a client device can decrypt L and determine whether the biometrics of a user appear to be changing over time. This can be used to trigger a generation of a new mask M2, that can be used instead of M. A new encrypted mask may be generated from new mask M2. A switching of the mask may require the replacement of the key X with another key X2, which may be generated and used to encrypt the mask array M and the value Z. Whether a key X or a key X2 is used may not need to affect other parties to whom the client device authenticated after a successful generation of X (or X2). This can be achieved by using a third key, referred to as KEY, where an encrypted version, EKEY, of KEY can be stored in the token. At first EKEY can be generated using X, and later EKEY can be replaced by a new instance in which KEY is encrypted using key X2. Accordingly, KEY may be a symmetric key and/or a secret key of an asymmetric keypair.

NFT security platforms in accordance with many embodiments of the invention can be used to protect laptops, desktops, phones, tablets, wearable devices among many other types of device. Locking can provide a mechanism to protect a device, which can include disabling access to resources until a biometric authentication is performed and found valid. It also includes being able to decrypt state information about a device, where the state information may include software, software parameters, and/or data generated by users.

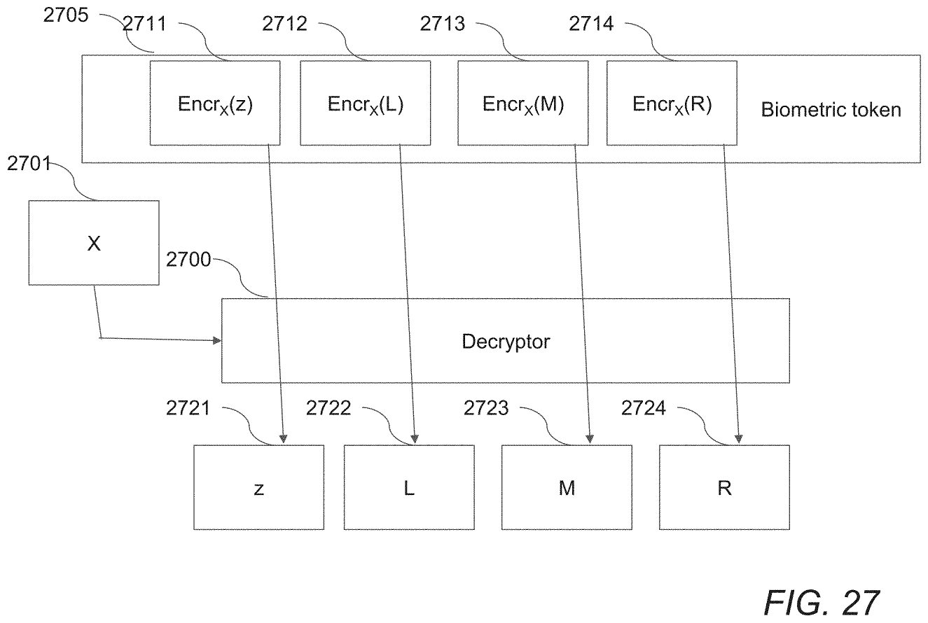

A process for authentication using biometric tokens in accordance with an embodiment of the invention is illustrated in FIG. 27. In particular, FIG. 27 illustrates actions that can be performed by wallet 2705 after receiving a response corresponding to a valid authentication using biometric input. Biometric token may include ciphertexts of sensitive data, such as EncrX(z) 2711, which can be an encryption of key z using symmetric key X 2701, EncrX(L) 2712, which can be an encryption of log L using symmetric key X 2701, EncrX(M) 2713, which can be an encryption of a mask array M using symmetric key X 2701, and EncrX(R) 2714, which can be an encryption of resource R using symmetric key X 2701. These quantities, as well as other such quantities not shown, can be decrypted using decryptor 2700, whether all of them and/or selectively, which can result in plaintext values for private asymmetric key z 2721, log L 2722, mask array M 2723 corresponding to an array M, and resource R 2724. In many embodiments, Resource R 2724 may be software and/or data that the user associated with a given biometric token has the right to use. Elements 2711, 2712, 2713 and 2714 may be part of other tokens and/or a biometric token, and/or be part of both biometric token and one or more other tokens. Although FIG. 27 illustrates a process authentication using biometric tokens, any of a variety of processes can be utilized to authenticate tokens as appropriate to the requirements of specific applications in accordance with embodiments of the invention.

NFT security platforms in accordance with many embodiments of the invention can be used to prove access rights to external resources (e.g., service providers), which can be beneficial. NFT security platforms can be used to protect wallet contents (e.g., crypto currencies, NFTs, among others) against bad actors and action (e.g., against theft), by storing contents of a wallet in an in an encrypted form that can be decrypted based on a user performing a successful biometric authentication.

NFT security platforms in accordance with many embodiments of the invention can be used to decrypt content which can be stored in an encrypted format.

NFT security platforms in accordance with many embodiments of the invention can include at least one validator that can include an identifier of a user and/or a biometric token, where an identifier can be used to determine, by an outside entity such as a trusted third party entity, a claimed identity of a user whose biometric verification is performed. An identifier can be part of requests being sent to an outside third party entity and/or to service providers. A type of service provider can be one where a user needs to login and/or otherwise authenticate in order to gain access to a resource.

NFT security platforms in accordance with many embodiments of the invention can provide functionality of a trusted outside third party that can be part of an external service provider. An external service provider can receive a validator and apply decryption among various other transformations to the validator in order to determine validity of a biometric input and to perform a security action based on this determination. Security actions can include permitting access to resources, blocking access to resources, allowing access to a set of resources while blocking access to a different set of resources, requesting additional authentication, submitting a request that a user retries an authentication process, logging access attempts, and/or performing time-based lockouts for users associated with biometric tokens, among various other security actions.

### Ownership-Based Limitations of Content Access

Today's marketplaces for NFTs can be used to transfer ownership rights of content (e.g., art, music, among others) of various kinds. NFT marketplaces can be used in various transactions (e.g., sell, license, among others) for various types of artifacts, such as digital assets. Digital assets, including digital assets that correspond to art pieces, are available for Internet users to access, render, and/or replicate, thereby calling into question the meaning of “ownership”. To address this, some sellers of content are starting to provide encrypted digital assets in NFTs, where these assets have not previously been published in an unencrypted form. However, this can be done to assets that have not yet been published, and thus can exclude legacy content. There can be a risk of breaches. For example an NFT owner, with non-commercial use rights to access content, can make a digital copy, sell the NFT, and then leak the copied content. Accordingly, this can suppress potential asking prices for artifacts as buyers may be making investment decisions in the blind.

NFT security platforms in accordance with many embodiments of the invention can generate filters that perform digital rights management of content, including legacy content and new content, based on detection of known protected assets. Many embodiments can generate filters that may be part of client-side applications (e.g., web browser), and/or be part of server-side infrastructure (e.g., as part of code in a search engine, social network, among other applications). Several embodiments of the platform can work with compliant applications to limit access to proprietary content (e.g., content that has not been listed as being public). Certain embodiments can generate filters that limit content that does not match filtering terms, which can identify content that is not acceptable to be rendered for various reasons, including private, illegal, immoral, out of compliance, unsafe, among various other categories of unacceptable content.

NFT security platforms in accordance with many embodiments of the invention can provide entities and/or users with the ability to set filtering terms for filters. Entities can include for example, a jurisdiction, a company, a family, a resolution made by a user, among others. Many embodiments can utilize a combination of different processes, including using filters along with whitelist/blacklist databases, among other processes to determine a status of content (e.g., content is public vs. private and/or including whether content is acceptable, among other determinations).

NFT security platforms in accordance with many embodiments of the invention can include security features that can suppress the use of screen shots and/or recording of digital information using compliant processes. In particular, a bad actor wishing to circumvent protections (e.g., by filming a screen, taking a screenshot etc.), may have content having a degradation of quality.

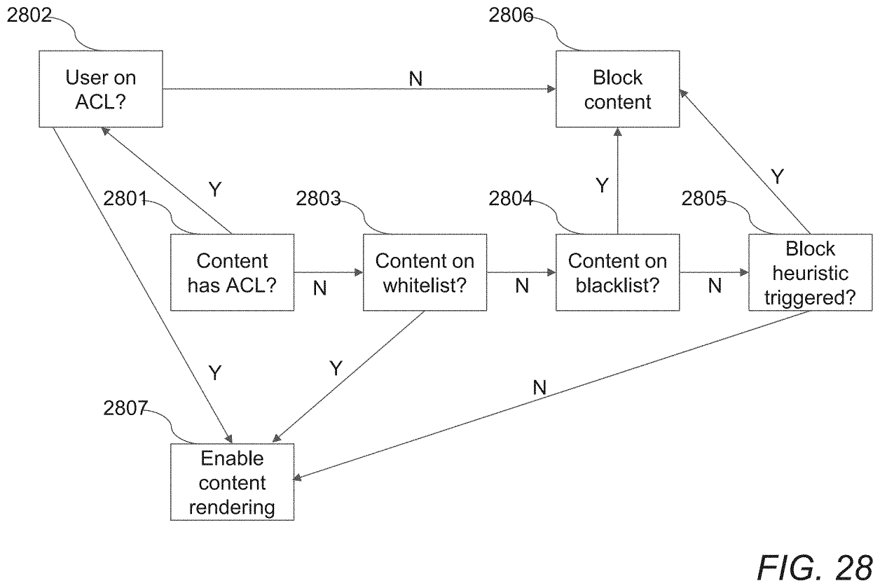

A process for determining whether to enable or block content rendering in accordance with an embodiment of the invention is illustrated in FIG. 28. In step 101, The process determines 2801 whether content is associated with an access control list (ACL). An ACL can be a list of owners and renters of a token associated with the content. An ACL can be an access control field of a token being set to “public”, indicating that the content associated with the token can be viewed by anybody. If the token has an ACL, the processing proceeds to determine 2802 whether user is on ACL 2802, otherwise the process determines whether contents on whitelist 2803. The process determines 2802 whether the requesting user matches the ACL. If the ACL verification indicates that the content is allowed to be rendered by the party making the request, then the process continues to 2807 to enable content rendering. The process denies 2806 access. If the content is not associated with an ACL, the process determines 2803 whether the content is on a whitelist, e.g., based on a match with a characterization of the content and a whitelist hash table that may be implemented using a Bloom filter. If it is on the whitelist, then the process enables 2807 content rendering. If it is not on the whitelist, the process determines 2804 whether the content matches a blacklist, e.g., whether one of potentially many characterizations of the content matches a blacklist that may be created using a hash table, e.g., using a Bloom filter. The process blocks 2806 content rendering, if there is a match. The process determines 2805 whether the content matches a heuristic indicating that it should be blocked; if so, the process blocks 2806 the content rendering, otherwise, the process enables 2807 the content rendering. Although FIG. 28 illustrates a process for a process for determining whether to enable/block content rendering, any of a variety of processes can be utilized to enable/block content rendering as appropriate to the requirements of specific applications in accordance with embodiments of the invention.

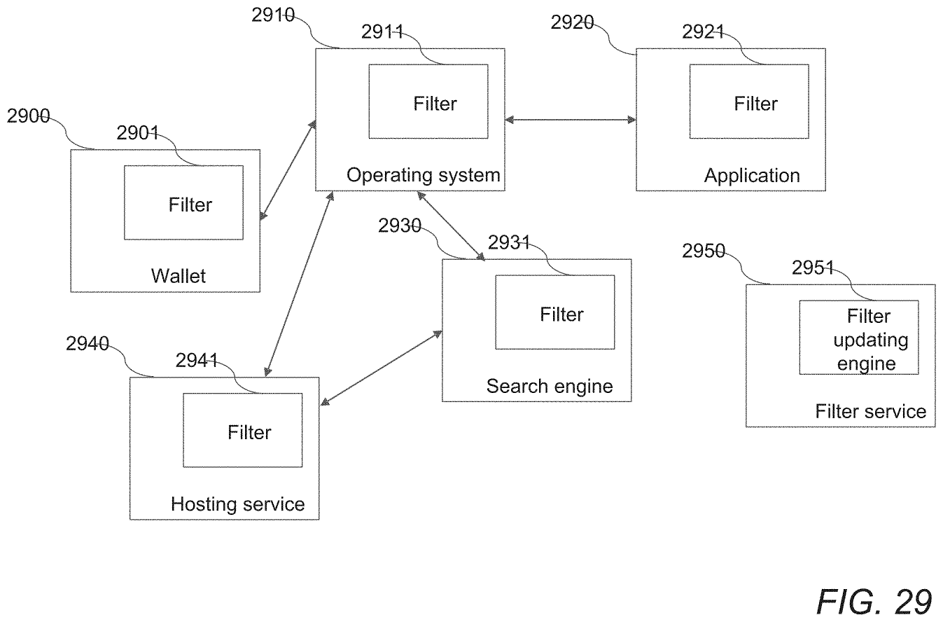

An architecture of an NFT security platform in accordance with an embodiment of the invention is illustrated in FIG. 29. User wallet 2900 can be connected via operating system 2910 to application 2920, to search engine 2930 and to hosting service 2940. A user may display content kept in or by wallet 2900 on application 2920 by selecting it using a user interface, causing a request to be sent via operating system 2910 to display unit application 2920. Filter 2901 of wallet 2900 may determine whether content can be displayed before making the request to have it displayed. Operating system 2910 can determine whether the requested content can be displayed using filter 2911, unless the request between the wallet 2900 and the application 2920 is encrypted. Application 2920 can determine whether content requested to be displayed is allowed to be displayed using filter 2921. An example application is a browser, a video player, or a rendering process running on a screen. A user can also make a request, e.g., using application 2920, to access data hosted by hosting service 2940. Hosting service may determine that the data corresponds to content that should not be rendered by the user, e.g., based on the user's jurisdiction, using filter 2941. A user can also make a request, e.g., using application 2920, for data using search engine 2930. Search engine 2930 can locate the requested data, which may be hosted on hosting service 2940, and can determine that the data should not be displayed, where this determination is made using filter 2931, e.g., based on a profile associated with the user, the user's jurisdiction, and/or the content of the requested data. Before content is accessed by application 2920, it may also be processed by hosting service 2940 and its filter 2941, and operating system 2910, using its filter 2911. Filters 2901, 2911, 2921, 2931 and 2941 can operate, e.g., as is described in FIG. 28. The different filters may employ different strategies for filtering, e.g., filter 2941 of hosting service 2940 may perform different certain steps. Different filters may apply rules in different orders, and may apply different aspects of filtering. This can be in part because they may have different timing constraints, and different access to data useful to make determinations. Filter service 2950, which can be connected to filters 2901, 2911, 2921, 2931 and 2941, can update filter rules using filter updating engine 2951. Filter rules can include whitelists, blacklists and/or heuristic rules among others. Access Control Lists (ACLs) can be updated by content creators and/or services operating on their behalf. Filter service 2950 may receive notifications from filters 2901, 2911, 2921, 2931 and 2941. For example, if content received from hosting service 2940 is detected by filter 2911 of operating system 2910, as not being suitable, then this is at least in part due to a failure of filter 2941 of hosting service 2940 to detect that the content was not suitable for being displayed. This may cause an update of filtering rules by filter update engine 2951, where, for example, rules to be distributed to filter 2941 of hosting service 2940 may be modified. A consistent failure of one filter, e.g., filter 2941 of hosting service 2940, may result in the blacklisting of hosting service 2940 by search engine 2930, and/or an addition of filter rules to be applied in filter 2911 of operating system 2910 and filter 2931 of search engine 2930. The reporting, therefore, can serve to rate the performance of various building blocks (such as filters 2901, 2911, 2921, 2931 and 2941) and to create and update rules distributed to these. A filter that reports content that it should not have reported, and/or performs an incorrect filtering action can have its filter rules or reputation modified by the filter update service or associated parties. Although FIG. 29 illustrates a particular NFT platform architecture, any of a variety of architectures can be utilized as appropriate to the requirements of specific applications in accordance with embodiments of the invention.

NFT security platforms in accordance with many embodiments of the invention can protect degraded content (e.g., lower-quality versions of content) using a detection of known content from content-signatures, where the content-signatures can be resistant to removal by partial obfuscation, modification, and/or content degradation. Accordingly, NFT security platforms in accordance with many embodiments of the invention can generate filters that can detect and limit degraded and/or reduced-quality illegal copies of content.

NFT security platforms in accordance with many embodiments of the invention can provide filters with different levels of protection, where higher security levels can be obtained with more stringent rules and lesser levels of security can be provided for content that can be less strictly protected. Filter rules can be set based on various different characteristics, including time periods, jurisdictions to be monitored, types of content to monitor, among various other filtering configurations as appropriate to the requirements of specific applications in accordance with embodiments of the invention.

For example, NFT security platforms can provide a movie producer with the ability to protect a recently released movie during a first few weeks after a release e.g., by paying for extra rules to be propagated to filter entities, and where such extra rules can create additional protection against degraded copies. After a critical time period after an initial movie release (e.g., few weeks), when a content to be protected is less valuable, a number of filtering rules applied by a filtering entity can be reduced to control a cost of protection. A party wishing to protect against distribution of its content may therefore invest extra in having better protection provided for select periods of time. Such protection can also be propagated in a manner that depends on a location of a filter, e.g., protecting high-value markets better, and protecting content desirable for a specific jurisdiction (e.g., Indian market) from access from that particular jurisdiction to a greater extent than if it is protected from being accessed by users in a different jurisdiction (e.g., Japan).

NFT security platforms in accordance with many embodiments of the invention can include security features that limit user attempts to avoid limitations. For example, a user may attempt to avoid limitations associated with a client-side filter by installing a non-compliant application (e.g., non-compliant web browser), and/or by shielding an application (e.g., web-browser) from a provider of rules, policies and blacklists, and/or by modifying an operating system to suppress actions initiated by a filter running on their system. Accordingly, many embodiments can include functional detectors units on client devices that can mitigate different types of abuse by including behavior to verify manipulation attempts in detector units residing on typical client devices, and having such detector units report and/or block undesirable behavior and attempts. Many embodiments can incorporate detector units in various different software and/or hardware environments, including wallet applications, anti-virus applications, browser plugins, among various applications as appropriate to the requirements of specific applications in accordance with embodiments of the invention. NFT security platforms in accordance with many embodiments of the invention can include client-side detector units that can detect and report abuse to central authorities (e.g., such as rights owner organizations), and/or to NFT owners associated with the detected content being illegally rendered.

NFT security platforms in accordance with many embodiments of the invention can include client-side filters and/or server-side filters and detection units which can monitor for searches for, downloads of, and/or storage of content that may be considered proprietary. Many embodiments of the platform can include filters that can filter for content publishing platforms, which can include filters and detector security processes to block publishing of material known to be proprietary.

NFT security platforms in accordance with many embodiments of the invention can generate and use whitelists to determine whether to publish content that may be proprietary. In particular, content that is proprietary can be published with the express permission of the content owner, such as an NFT owner, by the inclusion of the content and/or a content descriptor in a whitelist that can be used by an NFT security platform in accordance with several embodiments of the invention.

NFT security platforms in accordance with many embodiments of the invention can determine proprietary content using generated whitelists, where an inclusion on a whitelist may be time-based, e.g., allowing the rendering (e.g., display) of specified content for a specified duration of time, among various other settings that can be user specified. NFTs can also be associated with a usage policy, e.g., specifying rules and policies that have to be satisfied for content to be rendered. For example, a rule may specify that a given content element may only be rendered at a specified resolution in a digital rights management (DRM) platform of a pre-approved type, and/or in a trusted execution environment (TEE) running a pre-specified display program. A “display” may correspond to the rendering of images and/or video, playing of audio and/or execution of scripts and other code, as well as combinations of such activities.

NFT security platforms in accordance with many embodiments of the invention can generate and include filters that can block specified content by a user (e.g., owner, rights owner, among others). In particular, a user (e.g., an owner) associated with an NFT may have agreed to a sharing policy at a time of acquisition of an NFT, where this policy may be set a different user (e.g., seller and/or user with rights) associated with the NFT.

Many embodiments of the NFT security platforms can generate NFTs that include encoded policies. In particular, policies associated with an NFT, which may be encoded in the NFT and/or in documents (e.g., smart contract) that can be referred to by the NFT, may govern how content may be shared, including content is sharable, sharable in particular forms (e.g., particular resolution), sharable in particular circumstances (e.g., jurisdictions, hardware/software environments among others) specified in the policies; among others. Policies can be applied to a blacklist and/or a whitelist, as described.

NFT security platforms in accordance with many embodiments of the invention can provide interfaces that allow a user with rights to an NFT, to specify policies under which content can be displayed by various other users (e.g., by group membership, by access rights credentials, within boundaries whitelist and/or blacklist policies associated with content permit), among other terms that can be set by a user.

NFT security platforms in accordance with many embodiments of the invention can provide a visual user interface that can allow users to specify policies for NFTs, as disclosed in U.S. patent application Ser. No. 17/821,444 entitled “Systems and Methods for Management of Token Interactions” filed Aug. 22, 2022, by Jakobsson et al., which is herein incorporated by reference in its entirety. Policies can have different partitions which can be associated with different capabilities and access rights.

NFT security platforms in accordance with many embodiments of the invention can include NFTs that can be associated with policies with different partitions, where a partition may have multiple aspects, including: group members associated with the NFT; the rights and/or capabilities associated with an NFT; and elements governed by these rights and capabilities for group members. Different aspects may be viewed and/or modified by selecting a tab and/or other indicator of the partition, where example tabs may be labelled “users” (e.g., describing the group members), “content” (e.g., describing the elements) and “rules” (e.g., describing the capabilities). A user may select one of these tabs and then inspect and/or modify the associated contents of the partition. For example, by dragging and dropping an icon representing an NFT into a partition can automatically place an NFT in the “content” tab of the partition, and render the content of this tab. Dragging and dropping an avatar representing a person or a group of people into a partition may add this user or users to the membership for whom the rules tab describe the access to the content. The selection of the rules may be modified by opening a tab and making selections, and/or by dragging and dropping visual representations of pre-made rules into the rules tab of the partition.

For example, an icon representing medical information of a user may be dragged into a partition where the users tab contains doctors the user is interacting with, and for which the rules tab state that the doctor may read and write contents of the partition, as applicable to the doctor's need to know. The actions of the doctor may be logged to enable detection of abuse. The configuration using the user interface can be used to select parameter choices that are associated with content of various types, whether for enabling or suppressing access to such content by a given group of users. For medical data, for example, the access to this may be suppressed by users who are not on a whitelist of users to whom access is granted, thereby reducing the potential impact of a data breach in which content is leaked from the computer of a party with access rights to the content. A doctor or other medical staff may prove the access rights to a given content element by demonstrating ownership of an NFT associated with their role or identity.

NFT security platforms in accordance with many embodiments of the invention can govern access to NFT content by ownership. In many embodiments, access to NFT content may be governed by permissions granted to other parties by an owner of the NFT.

NFT security platforms in accordance with many embodiments of the invention can generate access right tokens that provide users with access to NFTs. In particular, a first user (e.g., user with ownership rights) associated with a particular NFT can indicate that a second user should be given access rights to the particular NFT, and an NFT security platform can generate an access rights token and convey the access right token to the second user. The access right token may be a derived token that references the particular NFT and which associates the second user with an access right to the particular NFT.

NFT security platforms in accordance with many embodiments of the invention can generate access rights tokens which can express an access right to an NFT using a policy that sets out various terms of use for the NFT including, e.g., indicating a type of access that is being granted among other terms. Different types of access rights can be granted, including read access, the right to render content associated with a NFT, the right to borrow an NFT, the right to generate a derivative token from an NFT, among various other types of rights that can be specified by users as appropriate to the requirements of specific applications in accordance with embodiments of the invention.

NFT security platforms in accordance with many embodiments of the invention can generate access right tokens, where an access right token can provide a user with access rights to a particular NFT. In many embodiments, access right tokens can be generated and provided to users based on transactions between users. In particular, a first user (e.g., owner) of an NFT may enter into a transaction (e.g., sell, license, among others) with a second user, and thus the NFT security platform can generate and provide the second user with an access right token that can provide the second user with access to the particular NFT.

In many embodiments of the NFT security platforms, an access right token may specify an extent to which a new second user (e.g., second user) being granted an access right from a first user (e.g., owner of an NFT) may delegate rights, and what rights, and to what types of entities. The new second user can be provided with the NFT and/or a derived NFT. Many embodiments can determine, using processing on the new second user's device, that the new second user has access rights to the NFT, and thus may no longer block the second user's access to the NFT. NFT security platforms in accordance with many embodiments of the invention can determine that a different user (e.g., third user) does not have access rights to the NFT, and thus may block the third user from being able to render the NFT (e.g., using a controlling process on the third user's device may determine that the NFT is owned, and is not set to be publicly accessible).

NFT security platforms in accordance with many embodiments of the invention can determine access rights and/or access control to NFTs using various processes, including determining whether an NFT token is publicly accessible, analyzing access records associated with an NFT stored on a blockchain, and/or analyzing a policy associated with an NFT.

In many embodiments of the NFT security platforms, NFTs can be generated that include a policy as part of the NFT. In certain embodiments, NFTs can be generated that include a policy as part of a derived token. A derived token can be digitally signed by an owner of the NFT, and/or by an entity with a sufficient level of access rights to the NFT. Such a sufficient level may be that the entity has the right to set the access rights to the NFT, e.g., as delegated by the NFT owner to the entity by a second derived token that references the NFT. Derived tokens are disclosed and illustrated in U.S. patent application Ser. No. 17/808,264 entitled “Systems and Methods for Token Creation and Management” by Jakobsson et al., and U.S. Provisional Patent Application Ser. No. 63/281,721 entitled “Royalty Sharing Method” by Markus Jakobsson, which are herein incorporated by reference in their entireties.

NFT security platforms in accordance with many embodiments of the invention can include security features that include controlling a display of content in a particular manner. In particular, several embodiments can determine access rights to an NFT for a user and/or group of users and display content in a pre-specified manner (e.g., at a particular maximum resolution) for these users. Access rights may be controlled, e.g., as described in U.S. Provisional Patent Application Ser. No. 63/277,472 entitled “Green Proof of Stake” by Markus Jakobsson, which is incorporated by reference herein in its entirety. Different types of constraints can be associated regarding how content is displayed (e.g., visualized for video/images, played back for audio/sound) and/or audio settings for content. For example, an audio file may be constrained in that it can only be played on headphones with a specified certification, and not on other audio output devices, thereby preventing that it is played on loudspeakers in a mall. An audio file may have a constraint that, if displayed (e.g., playing back the audio file), the audio file may need to be displayed in a particular manner, such as right after an advertisement specified by a content owner, and only by output devices with a particular DRM certification level.

NFT security platforms in accordance with many embodiments of the invention can detect and block many different types of undesirable content, including illegal material, immoral content and/or dangerous content. An example of illegal material may be black market content. Illegality can depend on jurisdiction, and may be set by an authority such as a government, and may be tied to a location of a user accessing content. An example of immoral content may include adult content, and may be determined by a church for members choosing to opt in, by parents configuring the access for their children, and/or by an employer for its employees. A determination of what is immoral may be governed by membership in a group or an end-user opt-in, for example. An example of dangerous content may include self-harm videos, and may be determined by a social network, a child welfare organization or an NGO. It may also be set, using simple configurations, by a user and/or a caretaker of a user. The application of rules related to dangerous content may be applied based on access to a resource, such as a social network, the membership of a group, or user-set configurations, for example. Rules and policies, which may also include scripts or use of scripts, identifying undesirable content may be embodied in tokens published by authorities of types given examples of above, and/or as rules that are referenced by tokens, wallets, browsers, or other filters and detectors. The application of rules and policies may depend on end-user configurations, requirements by authorities, location, and/or context of access. Some users may be provided with certificates related to access rights that provide selective exceptions to rules and policies.

NFT security platforms in accordance with many embodiments of the invention can associate a client device and/or an application associated with a client device to at least one policy. Policies may be stored on the client device and/or referenced by the client device. Policies may be stored with a service provider external to the client device, and be accessible by third parties. Policies associated with a client device can indicate what content is undesirable, and be applied by at least one filter, which may be located on and/or with the client-side device and/or with service providers, such as search engines, social networks, and content providers. Additional policies may be applied to content requests, where these additional policies may be non-configurable by the end user and parties associated with them; for example, these policies may be based on jurisdiction, embody restrictions related to terms of service, and/or be used to limit access to owned content.

NFT security platforms in accordance with many embodiments of the invention can generate a hash table (e.g., a Bloom filter, among others) and store the hash table on a blockchain, where entries on the hash table can be used to determine access to an NFT. Entries on a hash table can be use to determine whether a given content element has been listed as forbidden to render by a party that does not have explicit rights to render it. For example, a user may provide evidence that they own content associated with a given URL, and then provide this content to a registration service. The registration service can generate hash table entries to describe the content. Different collections of hash table entries may correspond to slight variations of the content and/or to different characterizations of the content. Thus, if a user obtains copy of a forbidden content and makes a modification to it for it not to be detected, NFT security platforms in accordance with many embodiments of the invention can detect variations which may cause at least one of the collections of hash tables to still match the modified content. As a user attempts to render content, characterizations of the content to be rendered can be made, e.g., by the user's browser, each such characterization compared to the contents of the hash table to determine whether there is a match. If there is a match, the content may not be allowed to be rendered, except if the user requesting the rendering has additional information that proves that they have access rights to the content of a type that matches the manner in which they attempt to render the content. NFT security platforms in accordance with many embodiments of the invention can generate and use hash tables for whitelists, among various other applications.

NFT security platforms in accordance with many embodiments of the invention can use an application associated with a user (e.g., a web-browser, a video player, among others), to determine that content can be characterized in a manner that matches a rule. For example, the content may be determined, using one or more heuristic filters, to be adult content. An application can include a rule identifying a set of users that are allowed to view adult content. If a user that is not allowed to watch adult content attempts to render the content, this attempt will be declined, unless an exception is made. An exception may be that the content is classified as educational by a teacher of the user, and the user is granted an access right to the content that overrides the rule that the content. Similarly, content that is accidentally misclassified may be combined with access rights that enable users without rights to view adult content to render the content. For content that is misclassified by heuristic classification techniques, an identifier associated with a characterization may be entered in a whitelist.

NFT security platforms in accordance with many embodiments of the invention can use several filters at different points in a process of content delivery to determine content display permissions and can use feedback related to inconsistencies between filtering actions collected for purposes of improving filtering rules and perform blacklisting of and/or legal actions against non-compliant entities who are obligated to perform filtering. Management of filter rules can be performed by at least one entity and/or by several competing entities. Entities may be centralized and/or distributed. Techniques for using distributed entities, and using consensus mechanisms to control actions and distributed management of artificial intelligence techniques, are disclosed in U.S. Patent Application 17/806,728 entitled “Systems and Methods for Encrypting and Controlling Access to Encrypted Data Based Upon Immutable Ledgers” by Markus Jakobsson, Stephen C. Gerber, and Ajay Kapur, which is herein incorporated by reference in its entirety.

NFT security platforms in accordance with many embodiments of the invention can include automated processes that can update reputation techniques related to filters and/or of filtering rules using feedback received from a filter (e.g., a filter located in a browser), identifying that content that is received from storage in an unencrypted manner matches rules that caused content to be blocked. Rules may be identified, as may be at least part of the blocked content. Feedback can be received by a filter service, which may be distributed, and of which there may be multiple competing instances with different methods of developing filter rules.

A browser can identify other contextual information, such as an operating system that it is running on, what version of filter this operating system has, if known, among other types of information. To the extent that it is known from context in the browser, feedback can identify a source of content, whether an associated search for the content was made using the browser, and if so, what search engine was used, and where the content was hosted, e.g., its URL. Feedback can be used by a filter service to determine blind spots in the filters used by entities that should have identified the content as not suitable for rendering, but did not, based on the content being blocked by the browser.

For example, an operating system should have blocked content based on the content not being encrypted in an end-to-end manner to hide it from the operating system. One determination by a filter service may be that the filter of the operating system was not updated, and therefore includes old rules. This may be conveyed back to the browser, which may initiate a request to a user to have the operating system filter updated, and optionally to cause automated updates to be made onwards. A filter service may also cause a browser not to have its full functionality until the operating system filter has been updated, e.g., by adding a rule to the browser that causes a reduction in functionality of the browser, e.g., only displaying content that is matching a whitelist and/or for which there is an ACL match, and in the absence of such matches, block content. If a filter of an operating system is up to date, a filter service may determine, based on feedback from the browser and based on other feedback from other applications and filter entities, that the filter of the operating system of that type needs to be updated with a new rule and/or an old rule modified. This can cause a new version of the rules associated with at least some of the filters, where such new rules may be propagated either by push and/or pull methods, and/or caused to be downloaded, e.g., by blocking functionality as described. Similarly, filters associated with other entities, such as search engines and hosting services, may also be updated. Moreover, reputation scores may be updated. For example, an entity that does not update the filters, does not deploy recommended filters, and/or does not respond properly to filter actions may be given a poor reputation. Other filters may be instructed to filter content from such units more stringently, including to automatically block such content. User configurations associated with wallets, browsers and/or other applications may be used to select the actions performed in response to the reputation of entities they interact with.

NFT security platforms in accordance with many embodiments of the invention can generate and use filter rules based on various matching techniques, including heuristics, access control lists, probabilistic storage structures, conditional statements, scripts evaluating inputs, machine learning (ML) components, and/or different combinations of techniques among others as appropriate to the requirements of specific applications in accordance with many embodiments of the invention.

In several embodiments of the NFT security platforms, different actions can be taken based on filtering including generating feedback to update a filter service, allowing content to be rendered, blocking content from being rendered, associating content with a notification, such as a warning, requesting from a user whether to add a party associated with the content to a blocklist, and/or requesting from a user whether to add a party associated with the content to a whitelist, among other types of actions.

NFT security platforms in accordance with many embodiments of the invention can set filter rules based on take-down requests received from content owners, and/or on DMCA notices. Requests and/or notices may be automatically processed by filter update services, which can generate rules accordingly, such as blocking rules implemented by inclusion of a content description or a website hosting content in a blocklist.

NFT security platforms in accordance with many embodiments of the invention can include content that a content creator incorporates human-detectable degradations of content into the content (e.g., in the form of visible watermarks that specify allowed use for content, warnings, among others). For example, a degradation can be a watermark. NFT security platforms in accordance with many embodiments of the invention can distribute a token with information that can be used by a rendering device and/or associated processing entities to remove such degradations to make them not visible to the human eye. Device-detectable watermark elements can be left in the rendered content (e.g., in the form of a steganographic message that is not detectable by a human viewer but which can be extracted and compared to content signatures by filters to determine whether rendering is permissible).

### Policy-Based Time Capsule Technologies

Many people and organizations document their beliefs and activities but may be reluctant to disclose these to others. Some beliefs and activities may be desirable to disclose, whether selectively to given recipients or to the public, based on triggering events. For example, a consumer user may wish to document a typical day of theirs in a time-capsule that can only be accessed by their children and grandchildren after they have passed away, and which then may become publicly accessible after a time period (e.g., another ten years). An organization may document their activities, whether because it is their desire to do so or because they are required by regulation, and only enable access to such information after triggering events have occurred; such events may include the cessation of the organization as an independent legal entity, a government requirement to disclose information, or a change in policies of the organization indicating a wish to immediately but maybe selectively disclose documents to the public. An individual or organization may wish to disclose pseudo-anonymized information after such a period, such as after a political election or after the purchase of an appliance. NFT security platforms in accordance with many embodiments of the invention can provide mechanisms for generating, managing and verifying policies governing access to content.

NFT security platforms in accordance with many embodiments of the invention can generate records, including non-fungible tokens (NFTs) that can correspond to a user, that include and/or can be associated with references to records (e.g., NFTs) associated with other users, where a reference can be associated with a relationship characterization that may be directional and/or non-directional. Examples of such characterizations can include “child of”, “mother of”, “friend of”, “student of”, “owner of content produced by”, “President of”, among many others. Some of these may be relationship characterizations that cannot be changed, e.g., “mother of”, whereas others may be limited in time, such as “friend of” or “owner of content produced by” as may be appropriate for the specific application in accordance with many embodiments of the invention.

NFT security platforms in accordance with many embodiments of the invention can automatically generate relationship descriptions without user action. For example, as user Alice purchases an NFT made by content creator Bob, Alice's record may be automatically augmented to recognize the purchase, e.g., by including a reference to Bob with an associated tag associated with the tag type “owner of content produced by”, and with a timestamp that correspond to the date of acquisition. If multiple content elements are acquired, each one of these may cause the addition of a new reference of this type, and/or of an additional timestamp indicating the purchase time of the second or third element. NFT security platforms in accordance with many embodiments of the invention can include at least one reference to content, including content being acquired, as provided in this example.

In many embodiments of the NFT security platforms, at least some relationship descriptions may need a user action to be added, where a user action may be an addition of a reference using a user interface, a qualification of a relationship, such as a selection of a relationship type, and/or free-form text and/or audio-visual content that describe and/or relate to the relationship. For example, this may be a photo of a first date, a love poem, the scan of a birthday card received or sent, among many other types of content. NFT security platforms in accordance with many embodiments of the invention can automatically determine a relationship using a process but a reference may not be included without approval by an associated user to whose profile record the reference is being added.

NFT security platforms in accordance with many embodiments of the invention can generate NFTs with dynamic privacy settings (e.g., public vs. private) that can change based upon triggering events and/or policies set for the NFTs. In particular, NFT security platforms in accordance with many embodiments of the invention can generate NFTs that can remain private until a triggering event and/or after a specified time period. For example, a user may upload a video of themself explaining how they feel, but make this video not available until a time period and a triggering event (e.g., five years after passing away and/or only after also a spouse passes away), where the observation of the event (e.g., passing away) may be triggered using different types of analytical processes as appropriate to the particular type of trigger, including for example for determining a person passing away, by one or more users; by an absence of a feed from a health tracker for a time period (e.g., at least one month); and/or by a death certificate, included on a ledger by a third party entity such as an oracle, among other mechanisms.

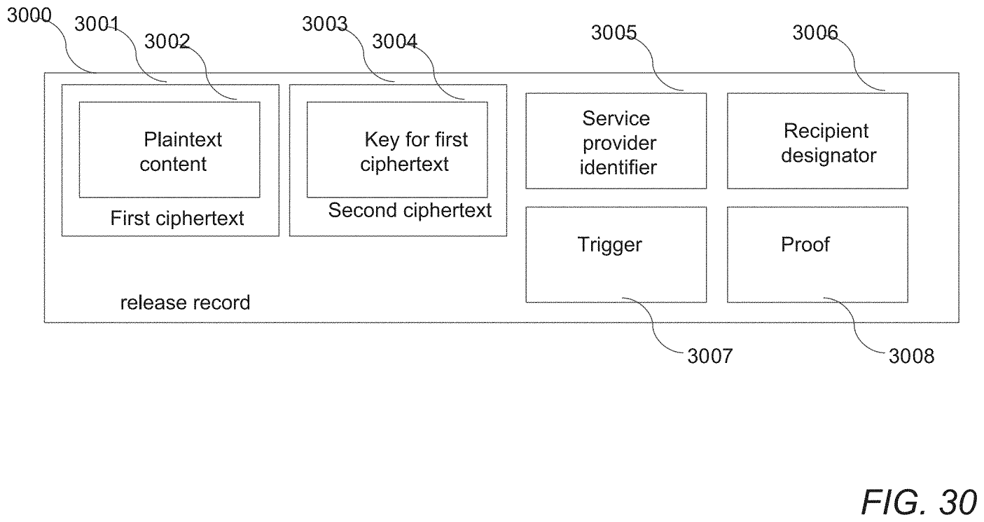

A release record in accordance with an embodiment of the invention is illustrated in FIG. 30. In particular, FIG. 30 illustrates a release record 3000 that can include a first ciphertext 3001, a second ciphertext 3003, a service provider identifier 3005, a recipient designator 3006, a trigger 3007 and a proof 3008. The first ciphertext 3001 can be generated from, and include in obfuscated format, plaintext content 3002. Plaintext content 3002 can be generated from first ciphertext 3001 using key for first ciphertext 3004. The second ciphertext 3003 can be generated from, and include in obfuscated format, the key for first ciphertext 3004. The key for first ciphertext 3004 can be generated from the second ciphertext 3003 using a private key associated with the service provider indicated by service provider identifier 3005. A ciphertext can be generated from second ciphertext 3003, so that this other ciphertext is a ciphertext of the key for first ciphertext 3004, decryptable using the private key associated with recipient designator 3006. The release record 3000 can include a trigger 3007, which may be a policy describing when the service provider indicated by the service provider identifier 3005 should process the second ciphertext 3003 to facilitate access to the key for first ciphertext 3003 by at least one party associated with recipient designator 3006. The proof 3008 can be a proof of knowledge related to the second ciphertext 3003, and can be publicly verifiable. Proof 3008 may be generated using a digital signature generation process, such as the Digital Signature Algorithm (DSA) signature generation process, and/or using a Schnorr signature. Proof 3008 may be verified using a verification process associated with the generation process used to generate proof 3008. Although FIG. 30 illustrates a particular release record that includes several ciphertexts, any of a variety of release records can be utilized as appropriate to the requirements of specific applications in accordance with embodiments of the invention.

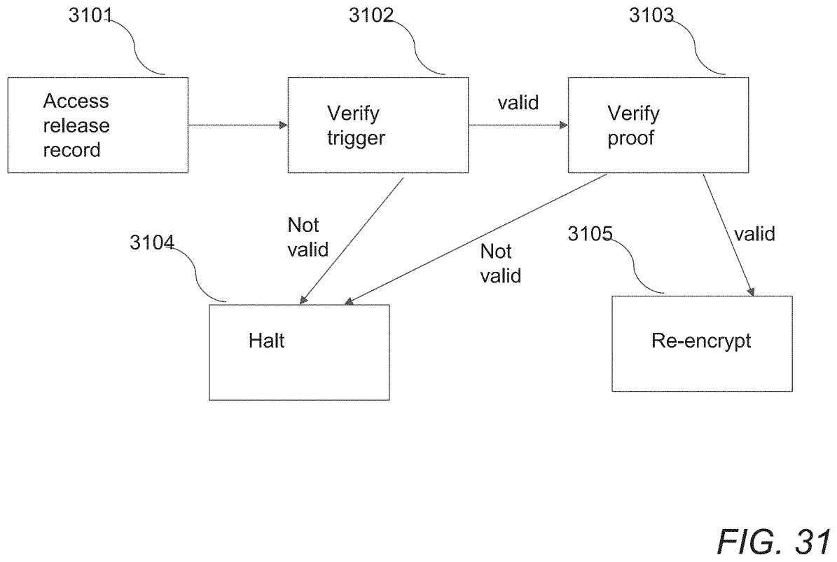

A process for encryption using ciphertexts by a service provider in accordance with an embodiment of the invention is illustrated in FIG. 31. In particular, FIG. 31 illustrates action of a service provider designated using a service provider identifier. The service provider can, using the process, access 3101 release record. In certain embodiments, the process can load a copy from a database such as a blockchain. The process can determine 3102 whether a trigger corresponds to an event and/or condition that has taken place and/or has been met. If it does not match, then the process halts 3014 the processing of release record. In certain embodiments, the processing can be temporarily halted.

If there is a match, the process verifies 3103 whether proof is valid. If it is not valid, the process halts 3014 the processing of release record. If it is valid, the process performs 3105 a re-encryption action that can use second ciphertext and a private key associated with the service provider identifier, and which generates another ciphertext, where this other ciphertext is an encryption of the key for the first ciphertext using a public key associated with the recipient designator 106. Although FIG. 31 illustrates a particular process for re-encryption using ciphertexts, any of a variety of processes can be utilized as appropriate to the requirements of specific applications in accordance with embodiments of the invention.

NFT security platforms in accordance with many embodiments of the invention can generate NFTs that include references that can be private and/or only visible to a user associated with the NFT. For example, Alice may include a reference to Cindy as “friend” where this reference is private, whereas Cindy may set a reference for Alice as “friend” to public. Markups associated with references may be private, e.g., an added free-form text and/or a scanned postcard may be encrypted and/or made private (e.g., not visible but for to users with access control permissions). For example, Alice may configure a social network account to determine relationships, and quantify their type, e.g., using automated analysis of interactions between Alice and another user.

NFT security platforms in accordance with many embodiments of the invention can generate NFTs that include relationships that can be expressed between individuals, but also between individuals and organizations (e.g., “works-at” being used to describe that Alice works at Acme Corporation.) Relationships may also be expressed between organizations, where the type may be “contractor-of”, “seller-of-software-to”, among various others.

NFT security platforms in accordance with many embodiments of the invention can allow an author of content to generate trigger policies associated with NFTs. Examples trigger policies can include: “when the user with public key P says this event has completed, then . . . ”; another is “when the owner on NFT X has performed task Y, then . . . ”; another example is “when oracle O posts data Z such that when the function F is applied to Z, and F(Z)=1, then . . . ”, among many other trigger policies that can be specified as appropriate to the requirements of specific applications in accordance with embodiments of the invention. NFT security platforms in accordance with many embodiments of the invention can include trigger policies that are associated with events. Example events include but are not limited to “allow user Alice read-only access to content C1”, “provide decryption key K1 to user Bob”, “make information I publicly available”, and “transfer ownership of element E to user U”, among many others.

NFT security platforms in accordance with many embodiments of the invention can allow a user to generate an NFT that includes at least one content element and/or which can enable and/or disable access to at least one content element stored outside an NFT. For example, an NFT may indicate a public key associated with at least one content items stored in a database, whether a proprietary database and/or a public database such as a blockchain. These items may be encrypted and associated with a decryption key made available, whether to the public and/or a select set of users indicated in a record associated with the decryption key. A decryption key may be stored by a distributed party, e.g., using (k,n) secret sharing, along with a policy indicating the recipients of the decryption key (and/or its shares) and a description of a trigger event that can cause the share and/or key to be transmitted to the intended recipient. A transmission may be secured, e.g., encrypted using a public key of the intended recipient and digitally signed by a party storing the share of the key and/or the key. These parties holding portions of decryption keys and policies governing their release may be paid a small fee for the safekeeping of the share and the action of transmitting the share if a triggering event occurs. The parties may also have staked some funds that they lose if it is found, e.g., by the other parties holding key shares, that they do not properly follow the terms associated with the decryption key, e.g., release a key share to a party that does not have rights to it or do not release a key share when the terms state it should be released. These types of parties may be referred to as information escrow entities, as the keys they hold govern access to data and functionality. In addition to safekeeping key shares and associated terms, the information escrow entities may also store and convey references to what data is associated with the decryption keys. That information, such as a link to a record in a database and/or on a blockchain, and/or an identifier associated with all relevant records, may also be stored in a distributed manner, meaning that the information escrow entity may not know what record and/or records are affected. Thus, an amount of trust required in these parties can be limited.

NFT security platforms in accordance with many embodiments of the invention can associate a time capsule with several recipients. For example, a content creator may wish for an attorney to have immediate access to information, should the content creator pass away, while the same content may be provided to the content creator's children when they reach adulthood, and to the public at a time no less than 25 years after the content creator's death, and as determined by the content creator's attorney upon receipt of the content. Thus, one or more content elements may be associated with multiple policies for the release of the content, where such a policy may identify a trigger, a recipient, and potentially, a condition. A condition may, for example, be that the recipient has not been convicted of a crime at the time of the tentative release of the content. As described herein, content may be text, movie, audio, but can also include digital resources, such as ownership determining records, e.g., of cryptofunds, NFTs, and data providing access rights to resources, e.g., by permitting a recipient to locate and decrypt such items.

NFT security platforms in accordance with many embodiments of the invention can include content that may be associated with policies indicating that under certain triggering conditions, the content is no longer public (e.g., to be made available to others). This may apply retroactively to already-made disclosures, as content may be protected by digital rights management (DRM) techniques, e.g., requiring the playing of content only in trusted environments, and the use of copy-protection techniques to make copying by typical users not possible. It can also be applied to content that used to be public. For example, content of an NFT may be blacklisted so that other players refuse to play the content. Processes of limiting access to content based on externally applied rules are disclosed in U.S. patent application Ser. No. 17/806,728 entitled “Systems and Methods for Encrypting and Controlling Access to Encrypted Data Based Upon Immutable Ledgers”, by Markus Jakobsson and Stephen Gerber, filed Jun. 13, 2022, which is herein incorporated by reference in its entirety. Externally applied rule may be related to the security action. For example, a security action may cause content to not be rendered in a compatible browser, and/or be blocked from being delivered to this.

NFT security platforms in accordance with many embodiments of the invention can limit write-access to content. Content can be associated with a particular digital wallet, can be of a certain type, can be associated to a particular user. A user can be associated with a particular biometric token. This can be required independently of the access to the wallet, e.g., by means of knowledge of its private key, by knowledge of access credentials, and/or by ability to create a clone on the wallet and/or link two wallets. For example, a particular type of content may be inherently limited in terms of who can create content to a user that matches a particular biometric token. For example, if both Alice and Bob have write access to a wallet, then only Alice may generate tokens, and/or content for tokens, that are associated with an Alice authorship, and only Bob can generate tokens and/or content for tokens that are associated with a Bob authorship. The authorship, thus, can be a predicate of a token, and can be verified relative to a token such as a biometric token and an associated authentication. This means that Alice, and only Alice, can generate tokens that include her autobiography, for example. Alice can generate time capsule tokens associated with her authorship. Similarly, Bob can generate tokens associated with his authorship. An authorship, therefore, can be expressed in form of a reference to a biometric token, in addition to also being associated with a public key (and private key) of the party that generated the token. For a shared wallet, that party may be expressed as the wallet itself, with a label that may indicate who has access to the wallet. Authorship can be more limiting, as it is not only requiring access to the wallet, but also a verification of the identity of the party who accesses the wallet. In some instances, Alice may generate an NFT with her authorship using a wallet that is not hers, in which case the creator identity (e.g., the wallet ownership) is not related to the authorship. In some instances, a token such as an NFT can be created with an authorship that is not corresponding to one person, but a collection. For example, Alice and Bob may generate content together, or even on behalf of each other, with an Alice-or-Bob authorship. That corresponds to an NFT that is created by either Alice, or Bob, or a combination of thereof. This is expressed in the NFT by the authorship indicating both the biometric token of Alice and the biometric token of Bob, and an “or” statement. Similarly, content can be generated that requires the authorship of both Alice and Bob, e.g., corresponding to a reference to both the biometric token of Alice and the biometric token of Bob, and an “and” statement. That corresponds to a requirement that the token, or the associated content as it is created, involves an authentication of both Alice and Bob, e.g., using authentication relative to their indicated biometric tokens. Different types of logical structure of one or more users can be expressed in this way, and associated authorship statements associated with NFTs and other tokens. These statements can be used to determine whether the disclosure of a token has been triggered, e.g., as will be understood in the context where the policy may state that all authors must have been dead for five years before the content is released.

NFT security platforms in accordance with many embodiments of the invention can create a clone of a wallet by generating a software instance and/or configuring a hardware instance of a wallet with identical address to an original wallet. NFT security platforms in accordance with many embodiments of the invention can pair several wallets, including a first wallet and a second wallet, and grant, potentially limited, access to contents of the first wallet to the second wallet, and/or the other direction, and/or a combination of the two directions.

Cloning of a wallet can be detected externally by requiring that a wallet is associated with a set of hardware-specific parameters that may not be easily controlled and/or copied by a user. A physically unclonable function (PUF) associated with the underlying hardware may be used, for example. One example of a PUF that can be used is if a wallet determines the locations on memory, such as RAM or EEPROM, that are damaged. This can be used to compute an identifier of the hardware that is bound to its physical implementation. In many embodiments of the NFT security platforms, a given functionality may only be allowed to be associated with one physical implementation of a wallet at a time. A functionality and/or resource associated with a given wallet address may be moved to another wallet with the same wallet address but not enjoyed from both wallets at the same time. Thus, a user may designate one wallet as having specific rights, causing other related wallets not to have the same right.

NFT security platforms in accordance with many embodiments of the invention can include a requirement that may be based on the existence of a flag and/or policy in an NFT. A flag may be related to a type of the NFT.

NFT security platforms in accordance with many embodiments of the invention can create a time capsule NFT from other input NFTs, e.g., by applying an access control layer to the input NFTs and associating the granting of access rights of the input NFTs with a triggering event.

NFT security platforms in accordance with many embodiments of the invention can allow a user to acquire a collection of NFTs and then “wrap” them using encryption, where an associated decryption key is provided to at least one party indicated by a policy, after one or more conditions have been fulfilled. Encrypted NFTs may be associated with a reference to the service that stores decryption keys, potentially in a distributed manner, and also associated with the policy or policies governing the release of the decryption keys. These policies may be stored alongside the encrypted NFTs, with the decryption key providing service, or both.

For example, assume the content data to be encrypted is denoted M. This may be a collection of NFTs, for example, and/or a plaintext message. Here, M can be encrypted using a symmetric key K, resulting in E(K,M), and K encrypted using a public key of a decryption service, where C is the resulting ciphertext of K encrypted using the public key y of the decryption service. A policy P associated with E(K,M) may state that a user with public key y2 will get access to the content M under a condition associated with a triggering event T. In this example, P=y2. The data (E(K,M), C, y, P, T) may be digitally signed by the creator of the packet, using a private key corresponding to a public key y3. A digital signature can include and/or be associated with a proof of knowledge of the random inputs used in the encryption of C. If C uses ElGamal encryption, for example, this would be a proof of knowledge that can be combined with the digital signature on (E(K,M), C, y, P, T). That means that a party accessing (E(K,M), C, y, P, T) cannot create a new combination (E(K,M), C, y, P′, T′), where P′ is different from P or T′ is different from T. The success of such an attack would be undesirable as it would allow a modification, by the attacker, of the decryption policy. The decryption service designated to decrypt the data can be identified by a value y. It can determine that T has taken place, and verify that the digital signature, entwined with the proof of knowledge related to C, is valid, and then generate a value C′ that is a re-encryption of C′ that replaces the use of the public key y with the public key P; accordingly, the owner of the private key associated with P may be able to derive K from C′. This is a symmetric key that can enable this party to decrypt E(K,M) and obtain M. Services controlling decryption key services may take a ciphertext corresponding to C and generate a ciphertext C′ without ever exposing the plaintext value K (including to itself), as described in the 1999 publication titled “On Quorum Controlled Asymmetric Proxy Re-encryption” by Markus Jakobsson, which is herein incorporated by reference in its entirety. This is an example of a service that can be distributed. A party generating such time capsules may designate multiple services, e.g., by including multiple values such as C, each such value being an encryption of K using the public key of a given service, along with an identification of this service, e.g., by inclusion of the value y as disclosed above. As a concrete example of the generation of C, this may be determined as (a,b)=(y\hat{ }r*K,g\hat{ }r) where a arithmetic is modulo a prime p, and where y is the public key of the designated service, g a generator, and r is a random value. The proof of knowledge can be a proof related to r, which can be known by the party generating C=(a,b) but not by others. Since the digital signature standard (DSS) can be essentially a proof of knowledge of a private key corresponding to a public key relative to an input message, and DSS can also use prime fields, the two proofs can be interleaved. In certain embodiments of the NFT security platforms, a proof of knowledge of r (e.g., which can be seen as a private key whose corresponding public key is the value g\hat{ }r) can be done using DSS, and/or a similar signature scheme, using the digital signature on (E(K,M), C, y, P, T) as a message. In certain embodiments of the NFT security platforms, the proof of knowledge of r, using DSS for example, can be used without any other digital signature required, e.g., by taking (E(K,M), C, y, P, T), and/or a hash thereof, as an input to the proof of knowledge of r relative to its public counterpart b=g\hat{ }r mod p.

In the example above, the trigger T can be publicly readable, and anybody can determine the triggering event. The owner of the public key corresponding to P may, for example, observe events and notify the service corresponding to public key y when this occurs, for this service to verify the claim and then generate C′ from C, wherein C′ is an encryption of K using the public key y2 included in P. In another example use case, T may be secret and only knowable (e.g., decryptable) to some entities, such as the service provider performing the decryption service. In the example above, this service re-encrypts C to make it accessible to the owner of the private key associated with P. In another example use, where the value K should be revealed to the public, the decryption service would instead decrypt C to render K, as would be achieved by replacing P by the value 1 in the above example, and then performing the re-encryption as described in the 1999 reference disclosed above.

NFT security platforms in accordance with many embodiments of the invention can include a data component (E(K,M), C, y, P, T) that can be referred to as a a “release record”, as it may include a data to be released, namely M, and until the release takes place, M is private, and encrypted using K. A policy P and trigger T can indicate to whom and under what condition M is to be released, by way of providing such parties with a value that enables them to determine K. A release record can be (E(K,M), C, y, P1, T1, P2, T2) where P1 indicates one public key and T1 the associated trigger for release to the party who holds the private key associated with P1. At a same time, P2, T2 can be another pair of public key and trigger condition values. Here, P1 could be the same and/or different as P2; and T1 may be the same as T2, but they could also be different from each other. A policy, such as P, P1, P2 . . . Pn, can include a designation of a recipient, e.g., in the form of a public key and/or an identification that the recipient is the public, in which case a designation may be represented by the value 1, which may be implicit.

NFT security platforms in accordance with many embodiments of the invention can include release records, such as (E(K,M), C, y, P, T), that include references to components, which may be stored on a blockchain and/or other types of database. For example, a value E(K,M) may be stored in a blockchain, and reference in the release record by a reference to the record and location of the blockchain in which it is stored; a value y can represent a public key of a service provider performing decryption and/or re-encryption, may be indicated by a number, where one service provider may be represented by a number (e.g., “5”) and another by a number (e.g., “9”). An identifier such as an email address and/or other unique identifier can be used; A public key can be determined from this by a lookup in a database, including a blockchain-based database. A trigger T may be implicit and/or may be represented by at least one common triggering conditions, where a number (e.g., “652”) may mean a particular condition (e.g., “when the designated recipient is no longer an employee”). A value C may be stored in an external database and a hash of C provided as a reference. A person of skill in the art will realize that these are simply illustrative examples, and that many variations are possible.

NFT security platforms in accordance with many embodiments of the invention can be iterated, wherein a plaintext content M is a decryption key K2 for the decryption of another ciphertext, and/or where a plaintext content M includes and/or references another release record with a similar format as a particular release record 100, and/or where this plaintext content M is a ciphertext of such another release record with a similar format as release record 100. NFT security platforms in accordance with many embodiments of the invention can structure release records that can be used to encode a series of puzzles, and where the opening of a last such puzzle corresponds to the solving of the series of puzzles. This may be used for example, to encode a game such as an escape room. A triggering condition may correspond to answers to questions that express the steps of the escape from the escape room. A recursive application of the processes can be used to convey new data to be released under other circumstances. A plaintext content element M may include both a user-accessible content element (e.g., a text, audio data, video data, executable code, among others) and at least one release record.

### Content Lock Mechanisms

Today, content creators are at the mercy of marketplaces in terms of obtaining royalties for sales of non-fungible tokens (NFTs). Whereas current marketplaces comply with royalty payments, users wishing to avoid the payment of royalties can circumvent these restrictions by performing “private sales”. Moreover, non-compliant marketplaces (e.g., black markets among others) may be utilized, where these marketplaces provide discounted rates and/or other incentives for buyers and sellers while hurting content creators by not enforcing the payment of royalties. Along similar lines, content creators may not be currently protected against abuse in which terms of service (ToS) provisions are violated. For example, a buyer of an NFT may share content associated with the NFT in a manner that is in breach with ToS policies without having to face any consequences of doing so.

NFT security platforms in accordance with many embodiments of the invention can generate compliance statements that can take the form of certificates, where a party with access to a private key associated with a compliance statement can be able to perform a particular action associated with the private key, and where a party without access to such a private key is unable to perform the particular action. Parties with access to private key can be referred to as parties in compliance.

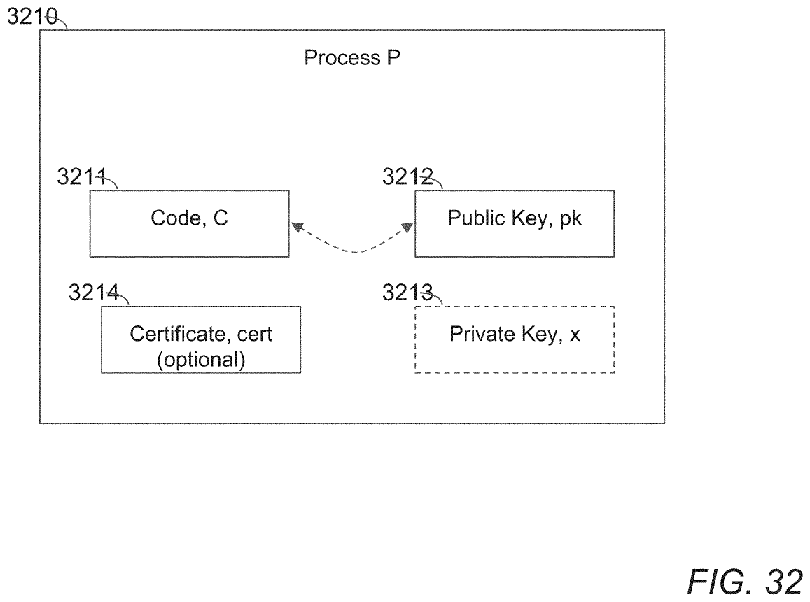

A process for authenticating a transaction in accordance with an embodiment of the invention is illustrated in FIG. 32. In particular, FIG. 32 illustrates a process P (3210) can be made unique by associating a code component C (3211) of P(3210) with a public key component pk (3212) of P (3210), and using pk (3212) to represent the identity of the instance of C (3211) that is represented by P (3210). Certain embodiments can include a certificate cert (3214) on code component C (3211) and public key component pk (3212) to establish the association, where certificate cert (3214) may be part of process P (3210), referenced by it, and/or otherwise associated with it. In certain embodiments certificate (3214) may be part of process P (3210) by being stored together in a database.

In certain embodiments, P (3210) may be associated with a private key x (3213) that may not be accessible to a party with knowledge of pk (3212), the latter which may be required to assign ownership of a token T to P. The private key x (3213) can be used to transfer ownership of T from P to another entity, where this other entity may be a wallet, a token, and/or another process P2. Although FIG. 32 illustrates a particular process for transferring tokens, any of a variety of processes can be utilized as appropriate to the requirements of specific applications in accordance with embodiments of the invention.

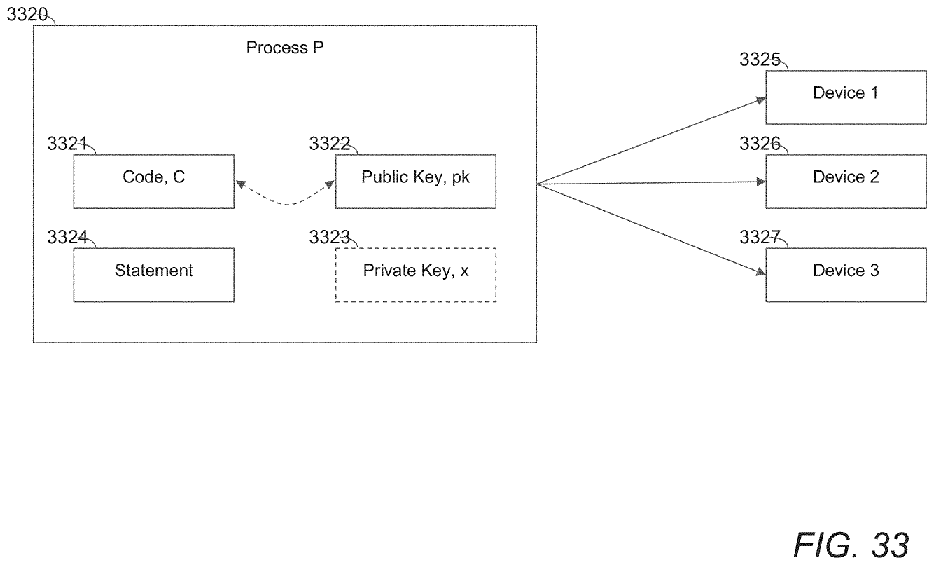

A process for using a public key executing on multiple devices in accordance with an embodiment of the invention is illustrated in FIG. 33. In particular, FIG. 33 illustrates of a process P (3320) that can include a specific public key pk (3322) that may be executing on multiple devices (3325, 3326, 3327). P (3320) may be certified (e.g., include a digital signature) on C (3321) and pk (3322) and a potential statement (3324), by a trusted party (e.g., a certificate authority, an employer of a user to whom P (3320) can be assigned to operate on the user's wallet, and/or by a national authority operating process P, among others). The potential statement (3324) may indicate a duration of validity of the digital signature, the location of an authority operating a certificate revocation list (CRL) of relevance, a description of assurance related to the certification, a specification of under what circumstances P (3320) needs to be operated, e.g., within what geographical boundaries, and indications of any potential requirements of trusted execution environments (TEE) required to operate P. Although FIG. 33 illustrates a particular process for using a public key executing on multiple devices, any of a variety of processes can be utilized as appropriate to the requirements of specific applications in accordance with embodiments of the invention.

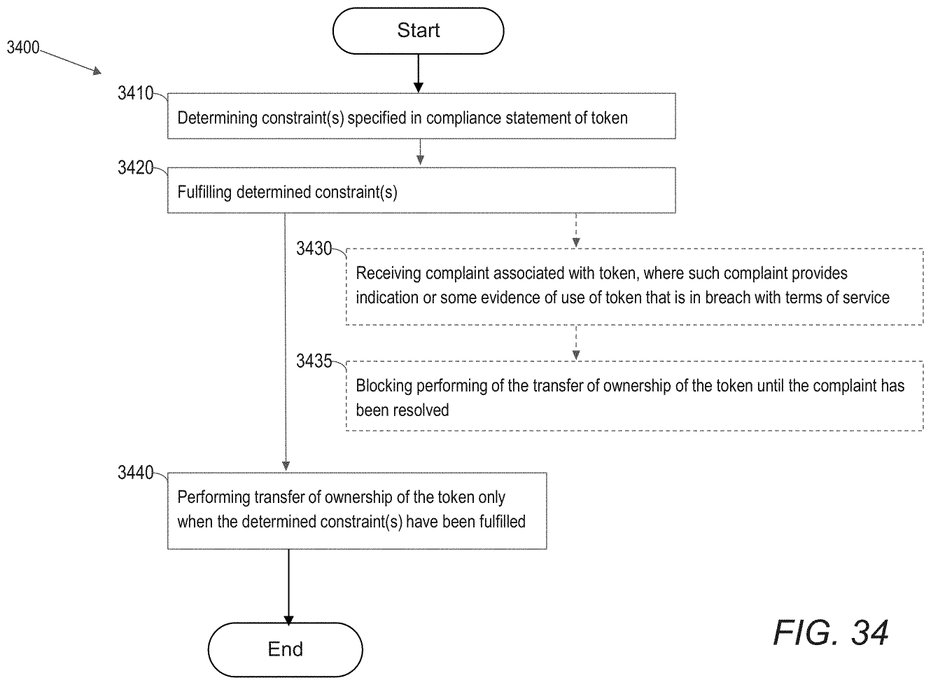

A process for transferring ownership of a token associated with a compliance state in accordance with an embodiment of the invention is illustrated in FIG. 34. FIG. 34 illustrates transferring ownership of a token, the token being associated with a compliance statement, the compliance statement of the token specifying constraints on a platform involved in the transfer of ownership of the token. The process can determine 3410 at least one constraint specified in a compliance statement of a token. In certain embodiments, a token may be associated with a compliance statement, thereby associating a requirement and/or constraint, with the token. A requirement may be identified in a policy that may be referenced by the token. In certain embodiments, a policy may be included in the token. In several embodiments, requirements can be encoded in contract data of the token and/or encoded in meta-data associated with the token. A requirement can be a royalty requirement that indicates that only marketplaces that are in compliance and/or fulfill the constraints, may transfer ownership of the token. The process fulfills 3420 the determined constraints. Many different constraints can be specified and corresponding ways such constraints may be fulfilled. For example, paying a required royalty, paying any previously omitted fees and/or royalties, ascertaining that the ToS is agreed upon by the parties involved, obtaining a verification from a seller of the token that the prior use of the token has respected the ToS, collecting taxes due to the transfer of the ownership of the token and/or due to previous action(s) wherein due taxes were not paid, among many other constraints that can be specified by users as appropriate to the requirements of particular applications. The process can transfer 3440 ownership of the token when the determined constraint(s) have been fulfilled. In this manner, the constraints may need to be fulfilled before the transfer of ownership is performed. The process can receive 3430 a complaint associated with a token, where such a complaint provides an indication and/or evidence of use of the token that is in breach with terms of service, and the process can block 3435 the transfer of ownership of the token until the complaint has been resolved. Although FIG. 34 illustrates a particular process for transferring ownership of a token associated with a compliance policy, any of a variety of processes can be utilized to transfer ownership of tokens associated with policies as appropriate to the requirements of specific applications in accordance with embodiments of the invention.

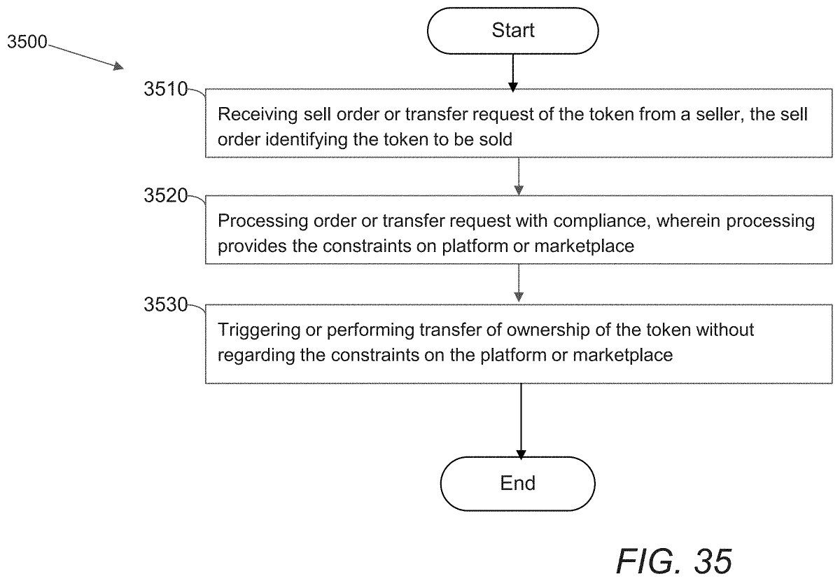

A process for processing a transaction that is transferring ownership of a token associated with a compliance statement where the compliance statement of the token includes constraints on a platform involved in the transfer of ownership of the token in accordance with an embodiment of the invention is illustrated in FIG. 35. FIG. 35 illustrates the process receives 3510 a sell order and/or transfer request of the token from a seller, the sell order identifying the token to be sold. The process analyzes 3520 the transfer request with compliance, wherein the processing provides the constraints on the marketplace. The process can trigger or performs 3530 the transfer of ownership of the token without regarding the constraints on the marketplace. Although FIG. 35 illustrates a particular process for transferring ownership of a token associated with a compliance policy with constraints on a platform, any of a variety of processes can be utilized to transfer ownership of tokens associated with policies as appropriate to the requirements of specific applications in accordance with embodiments of the invention.

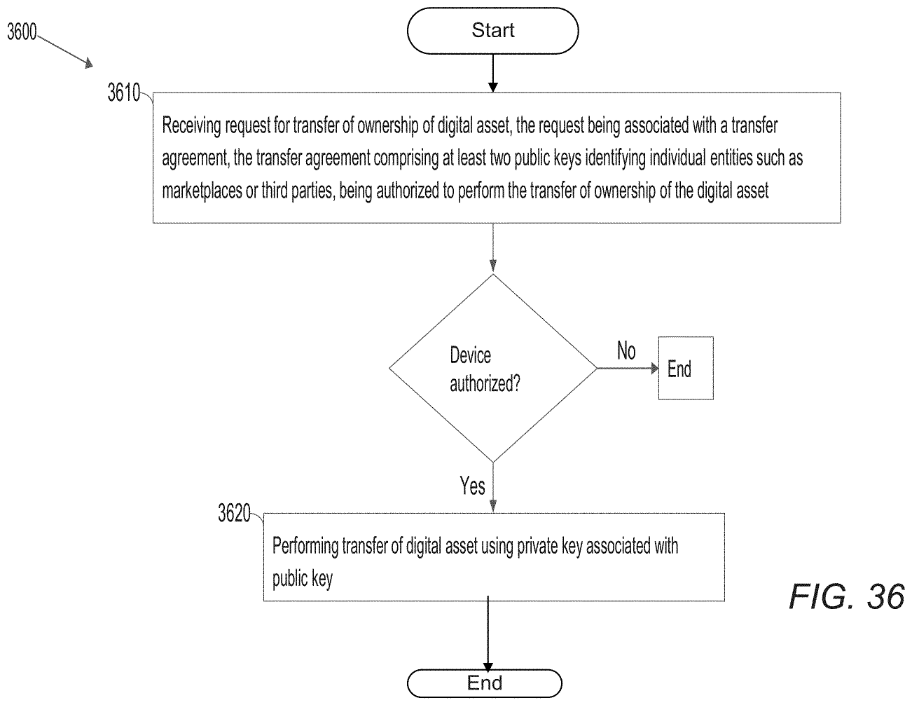

A process for transferring a digital asset in accordance with an embodiment of the invention is illustrated in FIG. 36. FIG. 36 illustrates a process of transferring ownership of a digital asset. The process receives 3610 a request for the transfer of ownership of the digital asset, the request can be associated with a transfer agreement, the transfer agreement can include at least two public keys identifying individual entities such as marketplaces and/or third parties, being authorized to perform the transfer of ownership of the digital asset. A seller may select at least two acceptable proxies (e.g., marketplaces or third parties as described), each of which can be associated with a distinct public key and a private key, thereby enabling both of these proxies to act as a marketplace and initiate a transfer of ownership on behalf of the seller, to a buyer. When a device is an entity being authorized to perform the transfer, the process performs 3620 the transfer of the digital asset using a private key associated with the public key. Although FIG. 36 illustrates a particular process for transferring ownership of a digital asset, any of a variety of processes can be utilized to transfer digital assets as appropriate to the requirements of specific applications in accordance with embodiments of the invention.

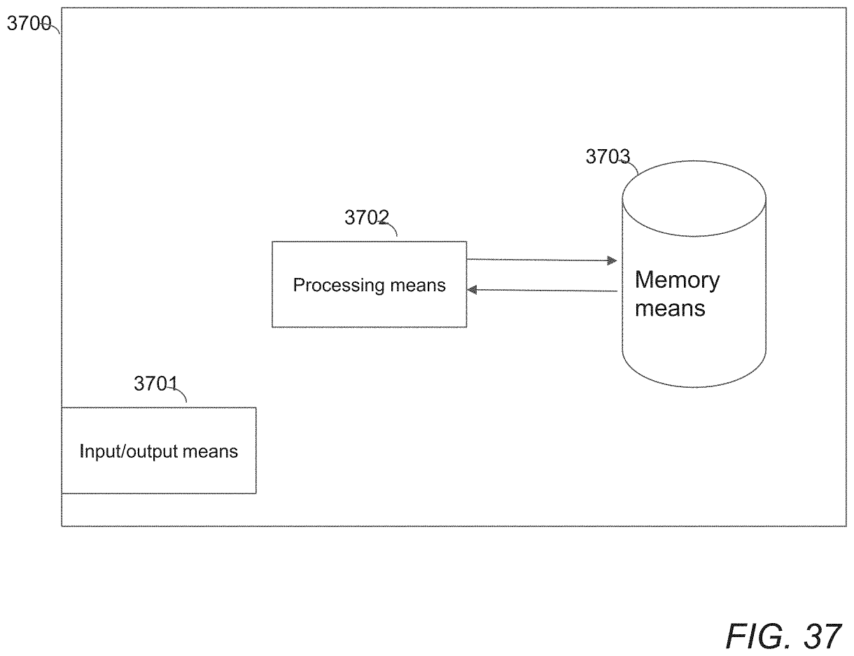

A system architecture of a device for performing transactions for tokens associated with compliance statements in accordance with an embodiment of the invention is illustrated in FIG. 37. FIG. 37 illustrates a device for transferring ownership of a token, the token being associated with a compliance statement, the compliance statement of the token specifying constraints on a platform involved in the transfer of ownership of the token. The device 3700 can include input/output means 3701 by means of which the device 3700 may receive information and transmit information to other units, devices and/or entities. The device 3700 can include processing means 3702 and memory means 3703, the memory means 3703 including instructions, which when executed by the processing means 3702 causes the device 3700 to perform the processes described herein.

NFT security platforms in accordance with many embodiments of the invention can associate tokens with compliance statement which can thereby associate a requirement and/or constraint with the token. In many embodiments of the NFT security platforms, tokens can be generated and utilized that can reference a policy and requirements can be identified within the policy. A token can include a policy and/or may reference a policy external to the token. Requirements can be expressed by encoding the requirement in contract data of a token. In certain embodiments of the NFT security platforms, requirements can be encoded in meta-data associated with a token. Requirements can include various different types of rules that can be specified by users. For example, requirements can include royalty requirements that indicate that marketplaces that are in compliance and/or fulfill various constraints may transfer ownership of a token. NFT security platforms in accordance with many embodiments of the invention can generate tokens that set out requirements that can include a terms of service (ToS) requirement that indicates that only marketplaces that are in compliance may transfer ownership of a token. Requirements can specify that transactions may be performed after parties have verified that the prior use of a token has respected the terms of service. Requirements can include tax collecting requirements that indicates that only marketplaces that collect and/or report appropriate taxes, such as sales taxes, may transfer the ownership of a token after collecting any current and prior taxes due. An example of prior taxes due can be taxes, and associated penalties, that were not paid in previous transfers, and/or for which an incorrect amount was paid. NFT security platforms in accordance with many embodiments of the invention can issue certificates in conjunction with an industry standard, a standards body, and/or via smart contract. Assertion of a compliance policy may depend upon a jurisdiction of the buyer, seller, and/or marketplace.

NFT security platforms in accordance with many embodiments of the invention can allow users (e.g., content creators) to associate requirements with tokens e.g., in order to encourage and/or enforce the proper payment of royalties.

NFT security platforms in accordance with many embodiments of the invention can include at least one authorization entity that may provide a user (e.g., content creator) with an ability to associate requirements with a token, including providing security features that can provide blocking access to tokens, and/or transfer of tokens that are not associated with legally necessary requirements. Legally established requirements may be specified to a jurisdiction.

NFT security platforms in accordance with many embodiments of the invention can generate tokens that may be associated with several legally necessary requirements, e.g., for a particular jurisdiction and/or for different jurisdictions, and/or a combination of jurisdictions. NFT security platforms in accordance with many embodiments of the invention can generate tokens that can be associated with requirements selected by a user (e.g., content creator). Requirements may be associated with a token by being referenced by the token and/or by being expressed in a smart contract and/or other data associated with the token. An association between a token and at least one requirement can be referred to as a locking of the token and/or the associated content. NFT security platforms in accordance with many embodiments of the invention can enforce locking using various techniques, including cryptographic means, through multi-signature means, by financial means, and/or by a combination of techniques as described.

NFT security platforms in accordance with many embodiments of the invention can, for a transaction related to a particular token, allow a marketplace that is in compliance with a set of requirements to perform actions that are aligned with the requirements of the token being transacted. In many embodiments, the NFT platform can use marketplace data to determine that there is such alignment by evaluating transactional data, e.g., data detailing past transfers of tokens, past usage of tokens, past complaints associated with tokens, and/or combinations of such data. For example, a bounty hunter may file complaints associated with a token, where such a complaint may provide an indication and/or some evidence of use of the token that is in breach with terms of service. For example, a token owner may provide public access to content associated with the token in spite of a requirement that the token remain private; evidence of such abuse may be reported by a bounty hunter, e.g., to one or more marketplaces in compliance and/or to complaint aggregators collaborating with marketplaces in compliance and providing such with information related to complaints. A bounty hunter submitting a complaint found to be valid may be provided a reward. This reward may be taken out of funds staked by a seller of the token, where the staking is performed as the token is listed for sale in the marketplace in compliance.

NFT security platforms in accordance with many embodiments of the invention can provide a user with rights to an NFT (e.g., token owner) with an ability to elect to transact a token using a marketplace that is not in compliance, in spite of an associated requirement, with the token not to do so. This may later cause a fee to be due, if the token is transacted in a marketplace in compliance. The fee may depend on the number of transactions that are in breach of the requirement and/or performed by the marketplace that is not in compliance.

NFT security platforms in accordance with many embodiments of the invention can include endorsement mechanisms, including allowing a marketplace in compliance to endorse a transaction that is determined to satisfy requirements. NFT security platforms in accordance with many embodiments of the invention can generate a digital signature using a private key associated with a compliance statement, and associate the generated digital signature with a recording of a transaction (e.g., transfer of ownership). NFT security platforms in accordance with many embodiments of the invention can provide fee collection tools, whereby a marketplace in compliance may determine that a transaction is not satisfying a set of requirements, which can then collect required fees to rectify the mis-alignment with the set of requirements, and generate a digital signature attesting to the collection of said fees. A digital signature may be associated with the recording of the transaction (e.g., transfer of ownership).

NFT security platforms in accordance with many embodiments of the invention can accommodate a marketplace in compliance to also facilitate a transaction by accessing content associated with a token being transacted, where the accessed content is at least in part encrypted using a public key associated with a compliance certificate, and where the encrypted content can be decrypted using a private key associated with a compliance certificate. Different marketplaces in compliance may have different such private keys. In certain embodiments of the NFT security platforms, different marketplaces may all have access to a same private key. In certain embodiments of the NFT security platforms, marketplaces can use cryptographic secret sharing techniques to store a portion of a private key associated with a compliance certificate, where a quorum of shareholders can perform cryptographic operations associated with the private key. A private key can be used to decrypt encrypted content associated with a token, and provide this to a new content owner (e.g., in plaintext and/or as a value encrypted with a new content owner's public key). Techniques for encrypting a value with a new content owner's public key is disclosed in the 1999 publication titled “On Quorum Controlled Asymmetric Proxy Re-encryption” by Markus Jakobsson, which is herein incorporated by reference in its entirety.

NFT security platforms in accordance with many embodiments of the invention can provide different types of requirements that can be associated with tokens. Requirements may be performed by different users, including content creator, by a party minting a token, and/or by a party bound by laws and/or regulations to associate requirements with content being accessed within a given boundary, such as a jurisdiction, an enterprise, a family, among others. An example of such a party is a marketplace that is licensed to operate within a given boundary. A boundary may be physical, financial, logical and/or political, and/or associated with access rights, among other types of boundaries.

For example, a requirement that could be associated with a token by a party other than the content creator can be a requirement that all ownership transfers be performed using an escrow service that determines that a transfer is desirable and not the result of abuse (such as phishing or malware) prior to completing the transfer. This may be a requirement that a given wallet owner applies to all transactions involving the wallet(s) of said wallet owner. A content creator may also associate such requirements with content, e.g., to protect future owners of the associated token from abuse in which the token is stolen, the content accessed in a manner that is not aligned with ToS, among others. One example requirement is the determination that the content may only be played (e.g., rendered) using a digital rights management (DRM) module that matches a specification indicated in the requirements associated with the token that includes and/or references the content.

Requirements can be associated with a wallet, e.g., a vulnerable wallet, as described in U.S. Provisional Patent App. Ser. No. 63/322,051 entitled “Vulnerable Wallet Resource Control” filed Mar. 21, 2022 by Markus Jakobsson, which is herein incorporated by reference in its entirety.

For example, a wallet owner may associate one or more wallets with a resource, such as one or more tokens, and enable these wallets to perform specified actions, including ownership transfers. This may apply not only to non-fungible tokens, but also to fungible tokens. The wallets that are granted limited access rights to some resource may be protected using the association of one or more requirements with any transfers initiated by or facilitated by said wallets. This control, which may be administered using a master wallet and controlled by an admin of this master wallet, may limit the transfer of tokens, e.g., to a certain pre-specified number and/or certain pre-specified value per day, and may impose restrictions in terms of the types of ownership changes that are allowed, e.g., only to pre-approved parties, and/or only pending approval in real-time by the admin. NFT security platforms in accordance with many embodiments of the invention can be used to control actions such as those described in U.S. Provisional Patent App. Ser. No. 63/314,424 entitled “Crypto Wallet Improvement Technology” filed Feb. 27, 2022, by Markus Jakobsson and Keir Finlow-Bates, and to require the use of specified DRM modules such as those described in U.S. Provisional Patent App. Ser. No. 63/315,143 entitled “Wallet with Modular Rights Management” by Markus Jakobsson and Keir Finlow-Bates, which are herein incorporated by reference in their entireties. A user (e.g., administrator) may use interfaces for purposes of performing configurations such as described in U.S. Provisional App. Ser. No. 63/311,283 entitled “Wallet User Privacy and Permissions Interface” filed Feb. 17, 2022, by Perry R. Cook and Markus Jakobsson, and which is herein incorporated by reference in its entirety.

NFT security platforms in accordance with many embodiments of the invention can include a content server that can modify a provision of content to different content (e.g., from a first content to a second content) based on an evaluation whether a token referencing the content has been transferred in a manner that is not in compliance with a set of requirements, and/or by a marketplace that is not in compliance with requirements. The change may cause different content to be provided that can be degraded and/or encrypted. In particular, a second content can be provided instead of an original first content, where the second content may be a degraded and/or encrypted version of the first content. Examples of degraded content include content with lower resolution; with added advertisements, warning or alerts; content images replaced with blank content; audio files that are truncated after a few seconds; and/or combinations of such degradations, among various other types of modifications. A content service may be informed of a situation to which it responds by performing a degradation by scanning blockchains for transactions, by obtaining complaints from bounty hunters, and/or by detecting inconsistencies, such as an offer of a token for sale by a first party different from a second party that the content service understands to be the proper owner. A degradation of content may also be performed by an entity performing and/or facilitating routing of requests, e.g., by means of a change of the provision of service to such requests after a marketplace, a content server and/or another third party performing policing detects a risk, a breach of ToS, a violation of a requirement, and/or an anomaly associated with a problem (e.g., a malware attack), among various other conditions.

NFT security platforms in accordance with many embodiments of the invention can include an entity facilitating requests for content, such as a DNS server and/or a content server, which may conditionally perform tracking and filtering of requests, e.g., based on assessments related to risks, breaches of terms of service, indications of violations of requirements, complaints filed by bounty hunters in good standing, among others. Such tracking may facilitate the detection of abuse, clustering of attacks for purposes of abuse attribution, reporting to law enforcement, among many other security actions. Different security actions, may also be performed conditional on a verification of a state associated with a token, where the state may be associated with a risk, a breach, and/or a violation. Examples of such a security action include the notification of a content creator and/or a designated party associated with the content creator; law enforcement; and actions performed by bounty hunters.

In many embodiments of the NFT security platforms, a state may not have to be associated with risk and/or abuse, but may be associated with the absence of risk and/or abuse. A first type of state can be referred to as a negative state, and the latter can be referred to as a positive state. NFT security platforms in accordance with many embodiments of the invention can include neutral states. States may be described using an integer classification and/or a risk score that may be a scalar. A positive state may induce a desirable change, such as the evolution of content associated with a token. A positive state may be detected based on the satisfaction of a requirement associated with the token, where an example of such a requirement is that a given token has been sold for a value that exceeds a pre-set threshold value, (e.g., $1000 or its equivalent in crypto currency) at the time of the transaction. Thus, content lock mechanisms can be used to implement a variety of policies expressed, e.g., using requirements and optionally associated with compliance statements.

NFT security platforms in accordance with many embodiments of the invention can provide mechanisms to detect a negative state (e.g., a wallet address being used to collect proceeds of a phishing attack); a complementing mechanism that detects attempts to transfer ownership from a wallet used to collect proceeds of a phishing attack; and a mechanism to block and/or discourage such transfers. This can result in difficulties for criminals to sell stolen NFTs and/or to use stolen crypto funds for purchases. A criminal may still transfer tokens using private sales to a collaborator, but this collaborator would not be able to transfer the tokens to non-collaborators, e.g., involving the facilitation by marketplaces in compliance.

One or more parties may determine whether one or more requirements associated with a token are satisfied, and perform actions in response to the determinations. Different parties may perform different actions, and may verify different requirements based on different processes, some of which may be proprietary, based on secret machine learning (ML) structures, or based on different proprietary data inputs, among others.

NFT security platforms in accordance with many embodiments of the invention can generate tokens that can include and/or associate an assurance with a token, e.g., at the time of minting the token. An assurance may have an underwriter, an assertion and a condition. The underwriter may be an insurance company. An assertion may be a statement attesting to the validity of a content element associated with the token, where validity may correspond to the origin of the content. A condition of an assurance may be that a token is never transacted in a non-compliant manner, e.g., using a marketplace that is not in compliance. Thus, if an owner of the token decides to sell a token on a non-compliant marketplace, any prospective buyer would know that buying the token on the non-compliant marketplace would cause the assurance to expire, which could lower a resale value of the token and render the assurance null. As long as an assurance is valid, an owner of a token may make a claim against the associated policy, e.g., if it is determined that the content associated with the token was a forgery; did not originate with the claimed content creator; was sold in quantities larger than the specified series; and/or otherwise had a problem covered by the assurance of the underwriter. An assurance would not be valid anymore if a token is sold in a non-compliant manner. If this were to happen, the insurer may pay an amount to the content creator, or contribute an amount to a fund used to fight piracy, including to prosecute the party that sold the token in a non-compliant manner, where legally possible, and/or otherwise be used to file legal actions against the non-compliant marketplace.

NFT security platforms in accordance with many embodiments of the invention can generate tokens with requirements that a token is co-owned, meaning that in addition to its buyer, the token would also be owned by a process P, which acts on behalf of the other owner and agrees to ownerships transactions, but only as long as these are performed in compliance with requirements, where one such requirement is a royalty payment requirement. Thus, as the token T is minted by a minting service for a content creator C, both C and P could be listed as conjunctive owners of T. When C initiates a sale to first buyer B1, P would need to approve the transaction for it to be completed. If the first buyer B1 later wishes to sell T to a second buyer, it may need the approval of P, since B1 and P are now listed as conjunctive owners. P may approve any transaction that matches a policy associated with the token, e.g., that the token transfer results in a royalty payment and/or that the transfer is taking place between two wallets owned by one and the same user, as verified by P.

Methods for conjunctive ownership and processes P that may also implement security mechanisms against abuse such as malicious contracts are disclosed in U.S. Provisional Patent App. Ser. No. 63/365,269 entitled “Directed Acyclic Token Structure” filed May 24, 2022 by Markus Jakobsson, which is herein incorporated by reference in its entirety. Different policies can be implemented in this way, where the control of policy compliance is performed by a trusted third-party running process P. A process may be executed in a distributed manner, using a consensus mechanism, for example, as disclosed in U.S. patent application Ser. No. 17/810,085 entitled “Distributed Ledgers with Ledger Entries Containing Redactable Payloads” by Jakobsson et al., which is herein incorporated by reference in its entirety.

NFT security platforms in accordance with many embodiments of the invention can make a process P unique by associating a code component C of P with a public key component pk of P, and use pk to represent the identity of the instance of C that is represented by P. P may be associated with a private key x that may not be accessible to a party with knowledge of pk, the former which can be required to assign ownership of a token T to P. The private key x can be used to transfer ownership of T from P to another entity, where this other entity may be a wallet, a token, and/or another process P2.

NFT security platforms in accordance with many embodiments of the invention can include a process P that includes a specific public key pk that may be executing on multiple devices and/or virtual machines such as the Ethereum virtual machine. P may be certified, e.g., include a digital signature on C and pk and a potential statement, by a trusted party such as a certificate authority, an employer of a user to whom P is assigned to operate on the user's wallet, and/or by a national authority operating process P among various other entities. A potential statement may indicate a duration of validity of the digital signature, a location of an authority operating a certificate revocation list (CRL) of relevance, a description of assurance related to the certification, a specification of under what circumstances P needs to be operated, e.g., within what geographical boundaries, and indications of any potential requirements of trusted execution environments (TEE) required to operate P.

NFT security platforms in accordance with many embodiments of the invention can include an indication and/or evidence of use of a token that is in breach with terms of service that is detected. Detection of a breach can be obtained using various processes, including, for example, by receiving a complaint from a bounty hunter, being informed that a bounty hunter has filed such a complaint, having been detected by a smart contract process, among various other techniques. NFT security platforms in accordance with many embodiments of the invention can, upon detecting a breach, block a transaction (e.g., transfer of ownership of a token). A blocking may stay in effect until the complaint has been resolved.

In many embodiments, different blocking mechanisms can be utilized. In many embodiments of the NFT security platforms, metadata, including a URL and/or URI in a token may be ignored and/or replaced with a URI and/or URL associated with abuse. In particular, a token may include a URI and/or URL to locate a server on which a digital asset associated with the token is stored. Entities such as e.g., marketplaces, governmental departments, among others, may be provided exclusive authorization to access a URI and/or URL field and as such, an owner of a token may not be able to restore a URI and/or URL field of a token on their own volition.

NFT security platforms in accordance with many embodiments of the invention can block transactions associated with NFTs using registries and/or databases to determine permissions associated with NFTs. An example of blocking a transfer of ownership of a token is to record the token in a database of blocked tokens, which database can only be edited by certified entities and where the database may be accessible to everyone. If subsequently, a marketplace and/or a buyer of the token accesses the database to ascertain that the token is not associated with any previous abuse, the token will be found in the database. The marketplace may refuse to transfer ownership of a token if found in the database.

NFT security platforms in accordance with many embodiments of the invention can generate tokens that have dedicated data-fields that identify whether a token can be traded. For example, blocking a transfer of ownership of a token can be done by updating a dedicated field associated with the token identifying the token as not being eligible for trading.

NFT security platforms in accordance with many embodiments of the invention can generate tokens, where a token may include several different data-fields and/or parts associated with different information. For example, a token may include and/or can be associated with a specific data-field identifying an eligibility of the token for trading. Such a data-field may only be edited by certain entities, e.g., marketplaces, governmental institutions, dedicated offices, among others. This specific field may be included in a database identifying valid tokens, and/or in a database identifying invalid tokens, and/or a database identifying the validity status of tokens. Such databases may be managed by third-party services, which may be governed by consensus mechanisms and/or by processes that can be private or public. A database may be controlled, at least in part, by a content creator associated with a token being identified in the database; by law enforcement; by a trusted party identified in the token, and/or a combination of such entities.

NFT security platforms in accordance with many embodiments of the invention can block a transfer of ownership of a token by informing a user (e.g., a creator) of the token enabling the user to block access to a website to which the token gives access. The user associated with the token may be responsible for granting access to a digital asset associated with the token. In case the user is informed that there is evidence of abuse in relation to the token, the user may then block access to the website by means of which the user of the token accesses the digital asset.

NFT security platforms in accordance with many embodiments of the invention can block a transfer of ownership of a token, whereby an appropriate authority may be informed of evidence of use of the token that is in breach with terms of service. Merely as an illustrative and non-limiting example, the abuse can be failure to pay taxes due because of a previous transfer of ownership or because the use of the token renders taxes to be due. Then, the appropriate authority may be a tax office or department. The tax office or department may then pursue the owner in order to collect taxes due. NFT security platforms in accordance with many embodiments of the invention can combine different blocking mechanisms in order to make a blocking more or less severe.

NFT security platforms in accordance with many embodiments of the invention can block a transaction of a token (e.g., transfer of ownership of the token) using a list accessible to marketplaces with an entry that the token is blocked may be updated, thereby enabling a marketplace to check the list before engaging in any trading of the token, the entry only being editable by the marketplace that created the entry. A marketplace may then subsequently check the list for a commission to transfer ownership of the token and if the token is on the list, the marketplace may simply refuse to continue further and hence the transfer of ownership of the token becomes blocked.

NFT security platforms in accordance with many embodiments of the invention can block transactions associated with a token (e.g., blocking a transfer of ownership of the token) by transferring ownership of the token to an entity, such as a creator of the NFT, the entity may be obliged to return the ownership of the token once a remedy and/or penalty for the use of the token that is in breach with terms of service have been settled. The entity may for example be a governmental institution, a court institution, an office and/or instance dedicated for the purpose of safeguarding against abuse of digital assets. Thus, a transaction (e.g., the transfer of ownership) can be blocked by the ownership being transferred to the entity. Once any remedy and/or penalty for the use of the token that is in breach with terms of service have been settled, the entity can be obliged to reinstate the previous owner as the rightful owner of the token, whereby the owner may subsequently sell the token.

NFT security platforms in accordance with many embodiments of the invention can trigger an action, such as the initiation of an ownership transfer among others, by a user process. A user process can communicate a request to a marketplace and/or other third party associated with the capability of effectuating the transfer. The receipt of this request, at the marketplace and/or third party, may cause the marketplace and/or third party to trigger the performance of the ownership transfer. A third party can be a party to whom conditional and/or temporal ownership rights are transferred, potentially with a condition to act as a fiduciary on behalf of the entity with prior ownership rights. The third party, thus, can be designated as an entity that performs the transfer, making it not necessary for the “actual” owner to be involved in the transfer in real-time. Instead, the third party acts on behalf of the “actual” owner. This third party may be a trusted party. It may include multiple participant units that operate using a consensus mechanism. It may also be a single party selected by the actual owner as a trusted intermediary. An actual owner may identify a collection of acceptable third parties that can be used, and the buyer of the token may similarly identify such a collection, and a third party may be automatically selected from the intersection of these two collections, such a third party used to transfer ownership rights. This can be done in an asynchronous manner by the owner of the asset (such as a token) to assign the ownership rights, e.g., conditionally and/or temporally as outlined by an agreement, to any one of the third parties on its list of acceptable third parties. This can be done using an ownership assignment that enables such a party, identified by one or more public keys, to initiate a transfer of the asset to another party (e.g., the buyer) using a private key associated with the public key. A transfer agreement, thus, can name multiple public keys, each one of which may correspond to a different approved third party. It may also specify a condition, such as “the sale cannot be completed for a purchase value below 4 ETH” or “the ownership transfer must not be performed to a party that does not have a specified accreditation, geographic location or access right”, etc. The third parties may be competing marketplaces, each one of which may be able to sell a listed token, but only if the sale satisfies the conditions (if such are stated), and only until a qualifying transfer has been performed.

While specific systems and components for a device for enabling providing security features including locking content associated with an NFT are described above, any of a variety of systems and components can be utilized for a device for enabling security features including locking content associated with an NFT as appropriate to the requirements of specific applications. In certain embodiments components can be arranged in any order or sequence not limited to the order and sequence shown and described. In a number of embodiments, some of the above components may execute or perform processes substantially simultaneously where appropriate or in parallel to reduce latency and processing times. In some embodiments, one or more of the above components may be omitted. Although the above embodiments of the invention are described in reference to a device for enabling security features associated with an NFT the techniques disclosed herein may be used in any of the rich media systems, permissioned blockchains, cryptographic systems, methods for conditional transaction tokens, methods for secure sharing of token assets, methods of wallet spam detection and protection, methods for user interfaces for conveyance of terms and other systems and processes discussed herein.

While specific systems, components, and/or processes are described with respect to NFTs or to tokens, it is understood that where specific systems, components, and/or processes apply to NFTs, they could also apply to tokens, and vice versa.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

### EXEMPLARY EMBODIMENTS

While many embodiments are described above, a number of significant exemplary embodiments of the various inventions described herein are provided below by way of example.

A first embodiment includes a method of processing non-fungible tokens (NFTs) in an NFT platform, comprising: receiving, at a server system, a notification request associated with at least one NFT from a user device, the notification request comprising a label data-field and an address data field; determining an occurrence of at least one event associated with the NFT that is recorded on a blockchain; obtaining a record associated with the notification request based on the label data-field, the record stored in a repository and comprising data to unlock at least one content portion of a plurality of content portions of the NFT; generating a notification using the address data field comprised in the notification request, the notification comprising the data to unlock the at least one content portion of the NFT; and transmitting, based on the address data field, the notification to at least one device.

A 2^{nd} embodiment includes the features of the 1^{st} embodiment and further comprising the data is at least one data selected from the group consisting of: a symmetric key, a private key, and a decryption key associated with an encryption key.

A 3^{rd} embodiment includes the features of the 1^{st} through 2^{nd} embodiment and further comprising the data is at least one data selected from the group consisting of: a symmetric key, a private key, and a decryption key associated with an encryption key.

A 4^{th} embodiment includes the features of the 1^{st} through 3^{rd} embodiment and further comprising the data to unlock the at least one content portion comprises an access token for verification.

A 5^{th} embodiment includes the features of the 1^{st} through 4^{th} embodiment and further comprising the access token comprises a digital signature.

A 6^{th} embodiment includes the features of the 1^{st} through 5^{th} embodiment and further comprising receiving an automated payment based on a smart contract associated with the NFT.

A 7^{th} embodiment includes the features of the 1^{st} through 6^{th} embodiment and further comprising the repository uses blockchain to store notification requests.

A 8^{th} embodiment includes the features of the 1^{st} through 7^{th} embodiment and further comprising notification request comprises a conditional payment.

A 9^{th} embodiment includes the features of the 1^{st} through 8^{th} embodiment and further comprising the notification request comprises a smart contract.

A 10^{th} embodiment includes the features of the 1^{st} through 9^{th} embodiment and further comprising the NFT comprises a plurality of content portions, each content portion having an access setting from a plurality of accessing settings, wherein the plurality of access settings include a locked content portion and an unlocked content portion.

A 11^{th} embodiment includes the features of the 1^{st} through 10^{th} embodiment and further comprising the access settings are determined based on a user specified policy associated with the NFT.

A 12^{th} embodiment includes the features of the 1^{st} through 11^{th} embodiment and further comprising the label data field is at least one data selected from the group consisting of a public key, a hash image of a private value, and a unique identifier.

A 13^{th} embodiment includes an event notification service where a first party requests a notification related to a token, comprising a second party that performs the actions of: determining at least one event that is recorded on a blockchain; accessing a repository comprising a multiplicity of notification requests using the at least one event as a search term; receiving a record corresponding to the notification request in response to the access; and generating a notification to an address comprised in the notification request, the notification comprising data associated with the at least one event, said data being usable to unlock content associated with the token.

A 14^{th} embodiment includes a non-fungible token (NFT) platform for processing biometric inputs in a distributed computing environment, comprising: a network interface; memory; and at least one processor executing on at least one computing unit from a plurality of computing units in a distributed computing environment, wherein a processor is configured to: receive a biometric input with a plurality of aspects; generate an array B with the plurality of aspects; obtain an encrypted mask array C from a biometric token; combine the encrypted mask array C with the array B to generate an encrypted result that is an encrypted function of the biometric input and is an encryption of a masked version of array B; transmit the encrypted result to at least one computing entity that decrypts the encrypted result and generates a response; receive the response from the at least one computing entity; and perform an action based on the response.

A 15^{th} embodiment includes the features of the 14^{th} embodiment and further comprising an action comprises at least one action selected from the group consisting of: generate a key from the response and decrypt the biometric token, unlock a device, decrypt an encrypted log file, perform a login based on the response, decrypt a ciphertext associated with the biometric token, use the response to decrypt an encrypted key X to generate the key X, and determine a mask value.

A 16^{th} embodiment includes the features of the 14^{th} through 15th embodiment and further comprising generating the encrypted mask C comprises determining a mask M that selects robust entries of the array B by selecting a first mask value with a first ciphertext and suppress non-robust entries of the array B by selecting a second mask value with a second ciphertext.

A 17^{th} embodiment includes the features of the 14^{th} through 16th embodiment and further comprising the first ciphertext is an ElGamal encryption of a representation of the first mask value.

A 18^{th} embodiment includes the features of the 14^{th} through 17th embodiment and further comprising the first ciphertext and the second ciphertext are stored in a non-fungible token (NFT).

A 19^{th} embodiment includes the features of the 14^{th} through 18th embodiment and further comprising the combining comprises performing item-wise modifications of elements of the encrypted mask array C using items of array B resulting in the encryption of the masked version of array B.

A 20^{th} embodiment includes A system for processing biometric inputs, comprising: receiving a first biometric input; determining, based on the first biometric input, at least a first mask value and a second mask value; representing the first mask value with a first ciphertext; representing the second mask value with a second ciphertext; causing the first ciphertext and the second ciphertext to be stored; receiving a second biometric input; generating a validator based on the first ciphertext, the second ciphertext and the second biometric input; and conditional on validator, perform an action.

A 21^{th} embodiment includes the features 20^{th} embodiment and further comprising the first ciphertext is an ElGamal encryption of a representation of the first mask value.

A 22^{th} embodiment includes the features of the 20^{th} through 21^{st} embodiment and further comprising the ElGamal encryption uses modular arithmetic.

A 23^{th} embodiment includes the features of the 20^{th} through 22^{nd} embodiment and further comprising the ElGamal encryption uses elliptic curve cryptography.

A 24^{th} embodiment includes the features of the 20^{th} through 23^{rd} embodiment and further comprising the first ciphertext and the second ciphertext are stored in a token.

A 25^{th} embodiment includes the features of the 20^{th} through 24^{th} embodiment and further comprising the token is a non-fungible token (NFT).

A 26^{th} embodiment includes the features of the 20^{th} through 25^{th} embodiment and further comprising the second biometric input is received by a wallet executing on a client device.

A 27^{th} embodiment includes the features of the 20^{th} through 26^{th} embodiment and further comprising the validator comprises the first ciphertext modified by a first biometric value and the second ciphertext modified by a second biometric value.

A 28^{th} embodiment includes the features of the 20^{th} through 27^{th} embodiment and further comprising the first biometric value represents a classification generated based on comparing a function of the second biometric input with at least a first threshold value.

A 29^{th} embodiment includes the features of the 20^{th} through 28^{th} embodiment and further comprising the second biometric value represents a classification generated based on comparing a function of the second biometric input with at least a second threshold value.

A 30^{th} embodiment includes the features of the 20^{th} through 29^{th} embodiment and further comprising the modification of the first ciphertext corresponds to exponentiating the first ciphertext with the first biometric value.

A 31^{st} embodiment includes the features of the 20^{th} through 30^{th} embodiment and further comprising the validator is decrypted.

A 32^{nd} embodiment includes the features of the 20^{th} through 31^{st} embodiment and further comprising the decrypted validator is used to determine a cryptographic key.

A 33^{rd} embodiment includes the features of the 20^{th} through 32^{nd} embodiment and further comprising the cryptographic key is a symmetric key.

A 34^{th} embodiment includes the features of the 20^{th} through 33^{rd} embodiment and further comprising the cryptographic key is an asymmetric key.

A 35^{th} embodiment includes the features of the 20^{th} through 34^{th} embodiment and further comprising the cryptographic key is used to perform the action.

A 36^{th} embodiment includes the features of the 20^{th} through 35^{th} embodiment and further comprising the action is the decryption of encrypted data stored in a token.

A 37^{th} embodiment includes the features of the 20^{th} through 36^{th} embodiment and further comprising the token is a non-fungible token (NFT).

A 38^{th} embodiment includes the features of the 20^{th} through 37^{th} embodiment and further comprising the action is a login.

A 39^{th} embodiment includes the features of the 20^{th} through 38^{th} embodiment and further comprising the action is the determination of at least one of the first mask value and the second mask value.

A 40^{th} embodiment includes the features of the 20^{th} through 39^{th} embodiment and further comprising the action is the decryption of an encrypted log file.

A 41^{st} embodiment includes the features of the 20^{th} through 40^{th} embodiment and further comprising the action comprises the unlocking of a device.

A 42^{nd} embodiment includes the features of the 20^{th} through 41^{st} embodiment and further comprising the device is at least one of a laptop, a desktop, a phone, a tablet and a wearable device.

A 43^{rd} embodiment includes A non-fungible token (NFT) platform providing digital rights management for content associated with tokens in a distributed computing environment, comprising: a network interface; memory; and at least one processor executing on at least one computing unit from a plurality of computing units in a distributed computing environment, wherein at least one processor is configured to: receive a request for content associated with at least one policy set for at least one NFT; filter the request based on the at least one policy; and determine an action from a plurality of actions based on the filtering, wherein a first action from the plurality of actions comprises blocking the request for content and a second action from the plurality of actions comprises allowing access to the content.

A 44^{th} embodiment includes the features of the 43^{rd} further comprising a third action from the plurality of actions comprises updating the policy associated with the at least one NFT.

A 45^{th} embodiment includes the features of the 43^{rd} through 44^{th} embodiment and further comprising the policy comprises a plurality of rules, wherein at least one rule from the plurality of rules is selected from the group consisting of a heuristic rule, a reference to a whitelist specifying unblocked elements, a reference to a blocklist specifying blocked elements, a reference to an access control list (ACL), and a reference to a token.

A 46^{th} embodiment includes the features of the 43^{rd} through 45^{th} embodiment and further comprising the at least one computing unit is a computing unit selected from the group consisting of a digital wallet on a user device, a component of an operating system, a component of a web-browser, a web-browser plugin, a search engine, a hosting service, and an application.

A 47^{th} embodiment includes the features of the 43^{rd} through 46th embodiment and further comprising a third action from the plurality of actions comprises transmitting feedback to at least one computational unit that updates settings associated with the filter and the at least one policy.

A 48^{th} embodiment includes the features of the 43^{rd} through 47th embodiment and further comprising a fourth action from the plurality of actions comprises associated the content with a notification.

A 49^{th} embodiment includes A non-fungible token (NFT) platform providing digital rights management for content associated with tokens in a distributed computing environment, comprising: a network interface; memory; and at least one processor executing on at least one computing unit from a plurality of computing units in a distributed computing environment and configured to: receive a request for content associated with at least one non-fungible token (NFT); access a release record associated with the at least one NFT, the release record comprising a plurality of data-fields with data including a first data-field comprising a first ciphertext associated with a decryption key and a plaintext content element, a second data-field comprising a second ciphertext that comprises in obfuscated format the decryption key for the first ciphertext, a third data-field comprising data regarding a recipient designator, a fourth data-field comprising data providing a service provider identifier and a fifth data-field comprising data regarding at least one trigger condition associated with a policy for the NFT; detect occurrence of the at least one trigger condition associated with the at least one NFT based on data from the fifth data-field regarding the at least one triggering condition; and generate an output based on data from the second data-field indicating the decryption key and data in the third data field indicating designation of the recipient.

A 50^{th} embodiment includes the features of the 49^{th} embodiment and further comprising the first ciphertext is generated from, and comprises in obfuscated format, the content element.

A 51^{st} embodiment includes the features of the 49^{th} through 50^{th} embodiment and further comprising the plaintext content element is generated from the first ciphertext using the decryption key.

A 52^{nd} embodiment includes the features of the 49^{th} through 51^{st} embodiment and further comprising the second ciphertext is generated from and comprises in obfuscated format, the decryption key for the first ciphertext.

A 53^{rd} embodiment includes the features of the 49^{th} through 52^{nd} embodiment and further comprising the decryption key for the first ciphertext is generated from the second ciphertext using a private key associated with the service provider indicated by the fourth data-field data.

A 54^{th} embodiment includes the features of the 49^{th} through 53^{rd} embodiment and further comprising the policy sets conditions on when the service provider indicated by the service provider identifier in the fourth data-field is to process the second ciphertext to facilitate access to the decryption key for the first ciphertext to at least one user associated with the data from the fourth data-field regarding the recipient designator.

A 55^{th} embodiment includes the features of the 49^{th} through 54^{th} embodiment and further comprising wherein the release record comprises a sixth data-field comprising proof data providing proof of knowledge of the second ciphertext that is publicly verifiable.

A 56^{th} embodiment includes the features of the 49^{th} through 55^{th} embodiment and further comprising the proof data is generated using a digital signature process.

A 57^{th} embodiment includes the features of the 49^{th} through 56^{th} embodiment and further comprising wherein the output is decrypted using a private key corresponding to the recipient to yield the decryption key.

A 58^{th} embodiment includes the features of the 49^{th} through 57^{th} embodiment and further comprising the output comprises the decryption key.

A 59^{th} embodiment includes the features of the 49^{th} through 58^{th} embodiment and further comprising the output comprises the decryption key encrypted using the second data-field.

A 60^{th} embodiment includes the features of the 49^{th} through 59^{th} embodiment and further comprising the decryption key is a symmetric key.

A 61^{st} embodiment includes the features of the 49^{th} through 60^{th} embodiment and further comprising the decryption key is an asymmetric key.

A 62^{nd} embodiment includes the features of the 49^{th} through 61^{st} embodiment and further comprising wherein the service provider is a distributed party.

A 63^{rd} embodiment includes the features of the 49^{th} through 62^{nd} embodiment and further comprising the service provider uses (k,n) secret sharing to determine shares of the private key corresponding to the fourth data-field.

A 64^{th} embodiment includes the features of the 49^{th} through 63^{rd} embodiment and further comprising the plaintext data content is content selected from the group consisting of: text, an audio element, a video element, a token, and a script.

A 65^{th} embodiment includes the features of the 49^{th} through 64^{th} embodiment and further comprising the token represents the ability to transfer funds.

A 66^{th} embodiment includes the features of the 49^{th} through 65^{th} embodiment and further comprising the plaintext content element is associated with an indication of origination that references a biometric element comprising a token associated with a physical person.

A 67^{th} embodiment includes a method for processing a release record, comprising: receiving a release record, the release record comprising first data indicating a ciphertext associated with a decryption key and a plaintext content element, second data indicating designation of a recipient, third data indicating the decryption key and the designation of the recipient, fourth data indicating a service provider, fifth data indicating a triggering condition, accessing the fifth data; determining a triggering condition being satisfied based on the fifth data; and generating an output that is based on the second data and the third data.

A 68^{th} embodiment includes a method (300) for transferring ownership of a token, the token being associated with a compliance statement, the compliance statement of the token specifying constraint(s) on a platform or marketplace involved in the transfer of ownership of the token, the method comprising: determining (310) the constraint(s) specified in the compliance statement of the token, fulfilling (320) the determined constraint(s), and performing (340) the transfer of ownership of the token only when the determined constraint(s) have been fulfilled.

A 69^{th} embodiment includes the features of the 68^{th} embodiment and further comprising the determining (310) of the constraint(s) comprises one or more of identifying the constraint(s) in a policy that is referenced by the token, or which may be comprised in the token, accessing code in contract data of the token, or in meta-data associated with the token.

A 70^{th} embodiment includes the features of the 68^{th} through 69^{th} embodiment and further comprising the constraints are one or more of: a royalty requirement that indicates that only marketplaces that are in compliance, or fulfill the constraints may transfer ownership of the token by collecting and/or paying the due royalty, a Terms of Service (ToS) requirement that indicates that only marketplaces that are in compliance may transfer ownership of the token by fulfilling the ToS, a tax collecting requirement that indicates that only marketplaces that collect and/or report appropriate taxes, such as sales taxes may transfer the ownership of the token after collecting any current and prior taxes due.

A 71^{st} embodiment includes the features of the 68^{th} through 70^{th} embodiment and further comprising fulfilling (320) the determined constraint(s) comprises one or more of paying a required royalty, paying any previously omitted fees and/or royalties, ascertaining that the ToS is agreed upon by the parties involved, obtaining an verification from a seller of the token that the prior use of the token has respected the ToS, collecting taxes due to the transfer of the ownership of the token and/or due to previous action(s) wherein due taxes were not paid.

A 72^{nd} embodiment includes the features of the 68^{th} through 71^{st} embodiment and further comprising receiving (330) a complaint associated with a token, where such a complaint provides an indication or some evidence of use of the token that is in breach with terms of service, and blocking (335) the performing of the transfer of ownership of the token until the complaint has been resolved.

A 73^{rd} embodiment includes the features of the 68^{th} through 72^{nd} embodiment and further comprising the blocking (335) of the performing of the transfer of ownership of the token comprises one or more of: (a) overwriting a URL in the token to a dummy value, (b) recording the token in a database of blocked tokens, which database can only be edited by certified entities, the database being accessible to everyone, (c) updating a dedicated field in the token identifying the token as not eligible for trading, (d) informing a creator of the token enabling the creator to block access to a website to which the token gives access, (e) informing an appropriate authority of the evidence of use of the token that is in breach with terms of service, (f) updating a list accessible to marketplaces with an entry that the token is blocked, thereby enabling any platform or marketplace to check the list before engaging in any trading of the token, the entry only being editable by the platform or marketplace that created the entry, (g) transferring ownership of the token to an entity, the entity being obliged to return the ownership of the token once any remedy or penalty for the use of the token that is in breach with terms of service have been settled.

A 74^{th} embodiment includes a method (400) for transferring ownership of a token, the token being associated with a compliance statement, the compliance statement of the token specifying constraints on a platform or marketplace involved in the transfer of ownership of the token, the method comprising: receiving (410) a sell order or transfer request of the token from a seller, the sell order identifying the token to be sold; processing (420) the order or transfer request with compliance, wherein the processing provides the constraints on the platform or marketplace; and triggering or performing (430) the transfer of ownership of the token without regarding the constraints on the platform or marketplace.

A 75^{th} embodiment includes a method (500) performed by a device for transferring ownership of a digital asset, the method comprising: receiving (510) a request for the transfer of ownership of the digital asset, the request being associated with a transfer agreement, the transfer agreement comprising at least two public keys identifying individual entities such as marketplaces or third parties, being authorized to perform the transfer of ownership of the digital asset, and when the device is an authorized entity to perform the transfer: performing (520) the transfer of the digital asset using a private key associated with the public key.

A 76^{th} embodiment includes the features of the 75^{th} embodiment and further comprising the entities being authorized are previously selected by (a) a seller of the digital asset, (b) a buyer of the digital asset, or (c) both a seller and a buyer of the digital asset.

What is claimed is:

1. A method of processing non-fungible tokens (NFTs) in an NFT platform, comprising:
receiving, at a server system, a notification request associated with at least one NFT from a user device, the notification request comprising a label data-field and an address data field;
determining an occurrence of at least one event associated with the NFT that is recorded on a blockchain;
obtaining a record associated with the notification request based on the label data-field, the record stored in a repository and comprising data to unlock at least one content portion of a plurality of content portions of the NFT;
generating a notification using the address data field comprised in the notification request, the notification comprising the data to unlock the at least one content portion of the NFT; and
transmitting, based on the address data field, the notification to at least one device.

2. The method of claim 1, wherein the data is at least one data selected from the group consisting of: a symmetric key, a private key, and a decryption key associated with an encryption key.

3. The method of claim 1, where the data to unlock the at least one content portion comprises data used to decrypt the at least one content portion.

4. The method of claim 1, wherein the data to unlock the at least one content portion comprises an access token for verification.

5. The method of claim 4, wherein the access token comprises a digital signature.

6. The method of claim 1, further comprising receiving an automated payment based on a smart contract associated with the NFT.

7. The method of claim 1, wherein the repository uses blockchain to store notification requests.

8. The method of claim 1, wherein the notification request comprises a conditional payment.

9. The method of claim 1, wherein the notification request comprises a smart contract.

10. The method of claim 1, wherein the NFT comprises a plurality of content portions, each content portion having an access setting from a plurality of accessing settings, wherein the plurality of access settings include a locked content portion and an unlocked content portion.

11. The method of claim 10, wherein the access settings are determined based on a user specified policy associated with the NFT.

12. The method of claim 1, wherein the label data field is at least one data selected from the group consisting of a public key, a hash image of a private value, and a unique identifier.

13. An event notification service where a first party requests a notification related to a token, comprising a second party that performs the actions of:
determining at least one event that is recorded on a blockchain;
accessing a repository comprising a multiplicity of notification requests using the at least one event as a search term;
receiving a record corresponding to the notification request in response to the access; and
generating a notification to an address comprised in the notification request, the notification comprising data associated with the at least one event, said data being usable to unlock content associated with the token.

14. A non-fungible token (NFT) platform for processing biometric inputs in a distributed computing environment, comprising:
a network interface;
memory; and
at least one processor executing on at least one computing unit from a plurality of computing units in a distributed computing environment, wherein a processor is configured to:
receive, at a server system, a notification request associated with at least one NFT from a user device, the notification request comprising a label data-field and an address data field;
determine an occurrence of at least one event associated with the NFT that is recorded on a blockchain;
obtain a record associated with the notification request based on the label data-field, the record stored in a repository and comprising data to unlock at least one content portion of a plurality of content portions of the NFT;
generate a notification using the address data field comprised in the notification request, the notification comprising the data to unlock the at least one content portion of the NFT; and
transmit, based on the address data field, the notification to at least one device.

15. The NFT platform of claim 14, wherein the data is at least one data selected from the group consisting of: a symmetric key, a private key, and a decryption key associated with an encryption key.

16. The NFT platform of claim 14, where the data to unlock the at least one content portion comprises data used to decrypt the at least one content portion.

17. The NFT platform of claim 14, wherein the data to unlock the at least one content portion comprises an access token for verification.

18. The NFT platform of claim 17, wherein the access token comprises a digital signature.

19. The NFT platform of claim 14, wherein the processor is further configured to receive an automated payment based on a smart contract associated with the NFT.

20. The NFT platform of claim 14, wherein the repository uses blockchain to store notification requests.
